(19) United States
(12) Patent Application Publication
(10) Pub. No.: US 2022/0308562 A1
(43) Pub. Date: Sep. 29, 2022

(54) DIGITAL MES FOR PRODUCTION SCHEDULING & NESTING FOR ADDITIVE MANUFACTURING

(71) Applicant: Bryan C. Norman, Houston, TX (US)

(72) Inventor: Bryan C. Norman, Houston, TX (US)

(73) Assignee: KRAFTWURX, INC, Houston, TX (US)

(21) Appl. No.: 17/214,844

(22) Filed: Mar. 27, 2021

(51) Int. Cl. G05B 19/418; B29C 64/393; G05B 19/4097

(52) U.S. Cl. CPC G05B 19/41865; B29C 64/393; G05B 19/4097; G05B 19/41835; G05B 19/4183; B33Y 10/00

(57) ABSTRACT

Methods and systems enabling commercial opportunities for additive manufacturing workflow management including computerized processing of a plurality of three-dimensional CAD files received and aggregated by the system and organizing the plurality of three-dimensional CAD model files received and aggregated by the system and where the data corresponding to the three-dimensional CAD model(s) geometry contained within the 3D CAD Model files received by the system are analyzed by the system for production criteria. The analyzed 3D CAD Model files and their geometry are then organized by production criteria. Batches of the geometry contained within the analyzed and organized 3D CAD Model files are then analyzed for arrangement, by nesting and stacking system controllers to determine a solution for optimizing production resource utilization and packed, by the system as nested arrangements of CAD Model geometry and compiled as computer files called tray files, representing packed arrangements of 3D CAD Model geometry according to production criteria and a production capacity plan determined by the system. The tray files represent production jobs for production by additive manufacturing. The tray files are then scheduled and assigned, by the system to the production queue of indexed production resources defined in the system by the commercial user, according to the production criteria for each tray file. The tray files are then made available and or transmitted or routed to an additive manufacturing device for production of the geometry described within each tray file and where the Additive manufacturing device produces the geometry described within the tray file using the data in the tray file, at least in part to do so, such that the objects produced corresponds directly to the three-dimensional models received and processed by the system.

### CROSS REFERENCE TO RELATED APPLICATIONS

The present application is a continuation in part application of U.S. Ser. No. 16/134,717 Filed Sep. 18, 2018 and Ser. No. 15/893,179, filed Feb. 9, 2018, which is a continuation application of U.S. Ser. No. 13/374,062, filed Dec. 9, 2011, which claims priority to U.S. Pat. No. 8,515,826, filed Jun. 10, 2011, which claims priority to U.S. Ser. No. 11/750,499, filed May 18, 2007.

### FIELD OF THE INVENTION

The present invention relates generally to software systems utilized by manufacturers for Operations Planning and Management including but not limited to Enterprise Resource Planning, Product Data Management, Product Lifecycle Management, electronic Production Planning and scheduling also known as MRP II, Manufacturing Execution Systems, Computer Aided Design, Computing, Computer Servers, networking, the internet, websites, 3D CAD Kernels and what has been termed “Industry 4.0”, “The next Industrial Revolution”, also known as 3D Printing, Additive Manufacturing, Additive Freeform Fabrication or Direct Digital Manufacturing. The field of the invention therefore covers a broad range of technologies and their novel combination and adaptation to enable commercial opportunities in Additive Manufacturing. Fir additive Manufacturing, the operations may also be performing “pre-Flight” activities in a vernacular borrowed from commercial offset printing.

### BACKGROUND OF THE INVENTION

A computerized workflow management solution for Additive Manufacturing fulfills the function of a critical enabling technology for widespread adoption of AM. To provide utility for Additive Manufacturing, the computerized workflow management system must be arranged for performing several steps including receiving, aggregating, analyzing, organizing, sorting, batching, re-orienting, arranging and scheduling activities. These operations must be performed in a manner that treats the 3D CAD model files and the 3D CAD Model geometry within the files as the object being processed by the system. This substantially complex activity must be automated or semi-automated as much as possible to process large numbers of 3D CAD Model files and the 3D CAD Model geometry within them. In such a system, each representing orders for products can only be accomplished digitally. Accordingly, a Digital Manufacturing Enterprise workflow management system hereafter referred to as a Digital MES is both necessary and desirable, solving many technical and practical issues for widespread adoption of Additive Manufacturing. In prior disclosures related to this invention, a Made-To-Order Digital Manufacturing Enterprise software system was disclosed and providing several useful solutions for the widespread adoption of Additive Manufacturing including Co-Design and workflow management methods. In the prior disclosure, the 3D CAD models were generated and compiled by the Co-Design portion of the method and system and transferred to the Digital MES portion of the system for further processing. The prior disclosure provided this workflow by means of a software controller system comprised of modular subsystems each comprised of computer software programming code that are each responsible for various processing subroutines in the overall performance of the invention. As such, utility can be found in the various subsystems previously disclosed and providing commercial utility as stand-alone-inventions but also combined to perform the overall Made-To-Order Digital MES methods taught by the prior disclosures. These methods, systems and subsystems may be combined and or utilized by one or more commercial users in their deployment and carrying out the spirit of the total invention or in the case of the present disclosure, dividing the system into separate subsystems each having commercial utility for Additive Manufacturing.

### BRIEF SUMMARY OF THE INVENTION

This patent application, its specifications and claims separate and describe the Digital MES portion of the Made-To-Order Digital Manufacturing Enterprise invention as a stand-alone Workflow Management system for Enterprise or industrial-scale additive manufacturing (AM), hereafter referred to as a Digital MES and describes how the modular nature of the Made-To-Order Digital Manufacturing Enterprise invention previously disclosed can be split to provide the utility described herein.

The invention is comprised of modular software controllers demonstrated in the figures and specifications of prior disclosures. The modular controllers are comprised of computer programming code that is arranged to control general computing hardware in the performance of the computerized operations of the invention.

In the prior disclosure, the invention was responsible for and provided adapting of an e-commerce system to store, recall and make available 3D CAD Models as the basis for a product, producible by Additive Manufacturing. Additionally, the invention provided a means for enabling co-design and visualization of the 3D CAD Models during the co-design session. The co-design portion of the invention is arranged to utilize base 3D CAD Models input to the system as the base for a configurable 3D CAD Model for co-design between a first user and a 2^{nd} user where the first user is typically a commercial user and the 2^{nd} user is usually a consumer or customer of the 1st commercial user. The co-design method was arranged to also be embedded within the e-commerce environment such that the e-commerce portion and the co-design portion enabled commercial opportunities for mass customization of parts and products. The 3D CAD Models were uploaded to the invention and stored with product data and configured to have co-design constraints associated with and also stored within the system in a manner for recall during a co-design session in a browser or ecommerce environment. Of course, a commercial user may also choose not to configure the co-design features for base 3D CAD Models uploaded to the system. Likewise, a 2^{nd} party user may choose not to configure any available co-design constraints and merely request to receive the design as is.

The invention adapts the e-commerce system to compile and transfer finalized 3D CAD Model files and production criteria, as selected and requested by a user, from the e-commerce system, to a Digital MES system arranged to receive such data. The compiled 3D CAD Model either having co-design features configured and or merely copies of the base 3D CAD Model requested as is, are prepared for transfer to the Digital MES portion of the invention which is arranged for dynamically receiving and processing a plurality of 3D CAD Models and associated production criteria received by the Digital MES portion of the system.

The receipt of the 3D CAD Model files by the Digital MES generally results in a process for manufacturing subroutine to initiate processing activities performed by the system that results in organizing the 3D CAD Models according to their respective production criteria. Of course, no workflow management system for additive manufacturing would be truly functional in only sorting 3D CAD Model files according to production criteria, therefore additional processing must be performed. In the case of the Digital MES, sorted 3D CAD Model files must then be analyzed in order to determine to and match 3D Printer devices meeting the production criteria for the 3D CAD Model within the 3D CAD Model file based on location, process, material, delivery time/date or other parameters customary for manufacturing.

The invention is also arranged to cause a batch operation for the 3D CAD Model geometry itself. The batching operation is performed to generate nested tray files containing batches of the geometry described in the 3D CAD Model files fitting with the bounding box or printable area of a 3D Printer device defined in the system and meeting the production criteria specified for the 3D CAD Models in the batch. This operation is referred to as packing or nesting. The operation is performed by a computerized method to optimize utilization of a 3D Printer device by packing as many 3D CAD Models as possible within the print volume of the device and then compiling the single computer file called a tray file with the combined geometry from the batch.

The tray files are considered the output of the workflow of the invention. The invention having performed the computerized workflow resulting in a plurality of tray files which are used to instruct, at least in part, AM devices to generate physical copies of the geometry derived from the 3D CAD Model geometry prepared into tray files and output by the system workflow. Such activities and operations are highly dynamic and challenging to accomplish and therefore

Another major additional consideration of a Digital MES must include an adaptation of production scheduling methodologies for the processing and preparation for print production of 3D CAD Models by Additive Manufacturing. The production scheduling activities of the invention are therefore responsible for determining a capacity plan based on job requirements and production constraints and then dynamically processing the jobs based on the production criteria and capacity constraints for production on available production resources. This may be referred to as load balancing. Of course, many criteria customary in manufacturing may be used in production scheduling. The difference being that the results are then applied to the 3D CAD Model files and the geometry within the 3D CAD Model files, treating them as the object being scheduled by the system.

The processing of the jobs and their corresponding 3D CAD Model files by the invention includes multiple steps after job acceptance. The production criteria include but are not limited to the material selections required for the physical version of the product, the physical location for delivery (geospatial location), computed build-time estimates for each “job” or batch tray file, how may “job” files will fit within the printable area or bounding box of each Additive Manufacturing Machine and current production jobs in the queue and other concepts generally understood in manufacturing or industrial engineering.

In order to accomplish these and other tasks, the invention is comprised of modular software controllers arranged to control general computing hardware in the performance of computing operations for dynamically processing a plurality of 3D CAD Models as a set of preprocessing steps prior to production by AM machines.

The modular software controllers performing the workflow of the invention are arranged and configured to perform the processes described in the figures and specifications and are intended to be installed on networked computers.

Stated another way, the function of the invention is to receive and aggregate 3D CAD models files and meta-data for each respective 3D CAD model describing production criteria for the 3D Cad model within the 3D CAD Model file. The system is arranged to receive and aggregate the 3D CAD Models in a production buffer or queue (a print buffer). The Meta Data and 3D CAD Models represent production jobs to be processed by the system. The system is further arranged to programmatically parse the meta-data and analyze the 3D CAD Models geometry to obtain production criteria for each production job and subsequently utilize the production criteria and operational system parameters received by a commercial user to process the 3D CAD Models based on the production criteria.

The processing steps of the system include but are not limited to sorting the aggregated production jobs and corresponding 3D CAD Models into production queues according to the production criteria previously obtained by the analysis performed by the system and assigning, by the system, each production job and its corresponding 3D CAD Models to production queues based on the production criteria. The system additionally provides modular controllers for production scheduling the production jobs and organizing the 3D CAD Models according to at least one production schedule determined by the system. The system further provides modular controllers to sort and arrange the production jobs and corresponding 3D CAD Models into subset groups of 3D CAD Models according to the production schedule and or production criteria. The system additionally provides modular controllers for dynamically arranging, also called nesting or “packing” of subset groups of 3D CAD Model geometry contained within the 3D CAD Model files in into batches of 3D CAD Models fitting within the printable area or bounding box of an indexed and defined Additive Manufacturing printer device in order to optimize utilization of the 3D Printer device and then compiling and storing the nested or packed arrangements of 3D CAD Models as “tray files” and making the tray files available for assignment to a 3D Printer device where the data within the tray files is used, at least in part to instruct an Additive Manufacturing device to fabricate the geometry within the tray files. The assignment of the tray files is also referred to as production scheduling since each tray file is assigned to the schedule of the 3D printer device determined to meet the production criteria of each of the 3D CAD Models that have been packed into the tray files.

The invention therefore provides a novel solution for processing computerized operations for receiving, aggregating, analyzing, sorting, organizing, grouping, nesting (packing) and scheduling activities in a manner that is particularly useful for Additive Manufacturing and wherein the workflow performed is conducted in a manner that results in treating the 3D CAD Model files and the geometry they contain as the object being electronically processed by the system and therefore providing meaningful, practical, useful application for industrial-scale or “Enterprise-scale” workflow management for Additive Manufacturing.

The present invention also addresses aspects of distributed manufacturing, Just-In-Time Manufacturing, edge manufacturing and On-Demand Manufacturing by the methods described in the invention in a manner particularly useful to and in conjunction with Additive Manufacturing or 3D Printing technology. The system performs these operations to determine a location for production of each 3D CAD Model file received by the system in order to optimize delivery of the object produced by the workflow of the system from the 3D CAD Model files received and processed by the system. The systems and methods include local and distributed or de-centralized just-in-time manufacturing

The present invention also describes how the Digital MES may receive 3D CAD Model files from an electronic commerce system that may additionally include mass-customization and Co-Design methods performed by other portions of the invention.

The present invention further provides modular controllers for dynamically generating part traceability features as 3D CAD geometry affixed to or adjacent to each 3D CAD Model to make each part identifiable after production in a high mix Additive Manufacturing production environment.

The present invention further provides interfaces for input, and utilization by a commercial user to define system operating parameters for each modular controller.

The present invention additionally provides for communication between nodes of the system by method of encryption, treating each 3D CAD Model contained in the 3D CAD Model files received by and processed by the system as the objects being processed in the workflow performed by the system in an automated or semi-automated fashion.

The present invention additionally provide software modules for retrieving revision controlled CAD Model data from Enterprise Product Data Management systems and or Product Lifecycle Management Systems and software modules to enable the presentation of said PLM/PDM content by e-commerce.

The present invention additionally describes software modules for generating and preparing web-compatible 3D views of the 3D CAD Models and renderings as well as enabling web-based co-design of the 3D CAD Models that are transferred from the co-design system to the additive manufacturing (AM) workflow management portion of the system called a Digital MES. The system and its novel commercial utility hereafter referred to as a Made-to-Order and a Digital MES (MTO-Digital MES) system and embodied in a commercial software system entitled Digital Factory.

The present invention is additionally configured to manage fleets of additive manufacturing machines which are indexed within the system and capable of receiving tray files prepared by the workflow of the system and the production schedules of each of the devices in the fleet by the commercial user using the invention.

The present invention additionally describes how the system may perform the tasks of the invention by means if an API or Application Programming interface, enabling 3^{rd} party integration with the system.

### BRIEF DESCRIPTION OF THE DRAWINGS

FIG. 1 illustrates a personal computer or workstation [100] utilized by a CAD Designer or engineer to create a CAD Model, using a CAD Design software package of the types available from many commercial providers [101]. The Base 3D CAD Model is uploaded to the system of the present invention. The system deploying the method of the present invention, shall allow for the input of any geospatial/3D geometry design produced in a plurality of design software tools including but not limited to Solidworks, Inventor, Rhino, Strata-Studio Pro, Maya, CATIA, PRO-E, Alias Wave Front, Alias Sketch, Lightwave 3D, DesignCAD, Enovia Amapi, Carrera 4, Hexagon, Shade 3D, Poser 6, Axel Core, Recon 3D, Anatomica 3D, Adobe Dimensions, DeICAM, Form-Z, Mechanical Desktop, Pilot 3D, Solidthinking, Unigraphics, TouchCAD, as well as Solidworks, Inventor, Rhino, Strata-Studio Pro, Maya, CATIA, PRO-E, Alias Wave Front, Alias Sketch, Lightwave 3D, DesignCAD, Enovia Amapi, Carrera 4, Hexagon, Shade 3D, Poser 6, Axel Core, Recon 3D, Anatomica 3D, Adobe Dimensions, DeICAM, Form-Z, Mechanical Desktop, Pilot 3D, Solidthinking, Unigraphics, TouchCAD an online tools such as OnShape.

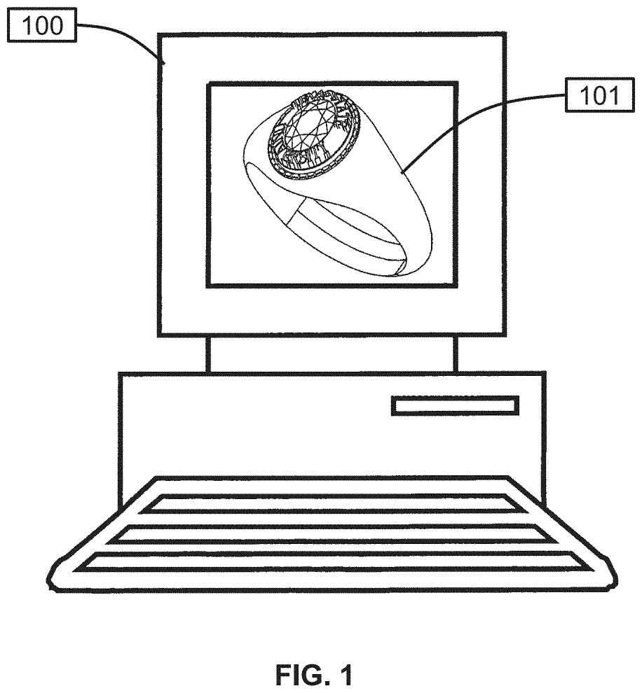

FIG. 2 illustrates an embodiment of the Co-Design configuration interface for setting up and configuring Co-Design features or constraints. The interface enables the first commercial user the ability to define constraint features, parameters, specifications, and values [102] that are referenced as CAD Kernel functions within the system to alter the geometry of the base 3D CAD Model during a Co-Design session, as well as to input a description of the Constraint features and a description of the product [103]. The interface and its functionality additionally enable a user to define regions and zones for each defined constraint to be applied on the base 3D CAD Model [104] and provides advanced constraint definition tools [105] or any geometric modifier possible by CAD Kernels. When the Save button [106] is pressed, the system stores the configured parameters for the current constraint, the current constraint becomes a modification “feature” having a name, and associated values related to the 3D CAD Model in the system [107]. The Co-Design interface additionally provides the ability to test the configured constraint features as a co-designer or consumer user would see the product in a browser session [108]. The commercial user may then “publish” the base 3D CAD model having one or more constraints as a co-designed 3D CAD Model having the Co-Design features associated with by publishing the 3D CAD Model as a product in the Web Shopping cart system [109] or course, the commercial user may also publish the 3D CAD Model without defining any constraints or the consumer user may opt not to configure any of the defined constraints and purchase the design as-is.

FIG. 3 illustrates an embodiment of a web page commonly referred to a product fly page in e-commerce parlance. The web page reflects an electronic shopping cart system adapted to enable the Co-Design method within the cart interface. The web page showcases a product that is represented by one or more 3D CAD Models [110]. The Interface provides a viewing option prepared by the system and caused to be displayed on the user device by the system [110] within the ecommerce page where previously configured constraint features are displayed graphically to the user as options for altering the geometry of the base 3D CAD Model [111] according to the constrain definitions previously defined by the seller and where the constraint features defined are associated with graphical elements relating to defined geometric modifiers available from the 3D CAD Kernel(s) associated with the system. The user intending to acquire the product, may alter the design by interacting with the interface which in turn occurs by the user selecting visible functional icons that case the system to apply functions that alter the base 3D CAD model utilizing computer instructions present in the modular controllers of the system. The user may see not only the 3D view of the CAD Model but also see a rendering of the 3D CAD Model [112] also prepared by the system. When satisfied, the user having Co-Designed the 3D CAD Model representing the product may request to obtain the product represented by the 3D CAD Model as well as other functionality [113] [114].

FIG. 4 illustrates the computing operations performed by the modular e-commerce system controller [183] portion of the invention in FIG. 5. The modular system generates and causes to be displayed, at least portions of a website or web page on the users/customer device and may include a browse and search function for searching the catalog of products [114]. The system receives a selection of the product through the system-provided interface [115] and the modular system prepares and causes to be displayed on the user device, the consumer customization interface demonstrated in FIG. 3 [116]. The system processes commands for applying the geometric alterations to the base 3D CAD Model [117] and the user is iteratively provided an updated view of the alterations caused to be performed by the user which are processed by the system [118]. The system accepts a request to place the order to obtain the product [119]. Of course, e-commerce systems also accept other information such as payment types, shipping location information, quantity and other common information needed for processing an order. As denoted by the illustration, the system may provide the functionality by API.

FIG. 5 illustrates processing steps performed by the modular input/output controller system [157] for coordinating system commands between a user/customer and other modular controllers contained within the system. The “input/output” control system demonstrates certain commands performed by or functions of the I/O control system. The system processes requests to obtain a product represented by the 3D CAD model [120] and processes the actual 3D CAD model data files, processes catalog browse requests [121] and product selection requests in order to then display the product in the flypage and initiates the user interface [122]. The modular controller also processes requests for the base 3D CAD model for a user session for presentation in the web interface [124] and causes the system to process 3D CAD Model geometry alteration requests [125] through a 3D CAD Kernel or “engine” which is also a modular controller within the system. Throughout the Co-Design process, the I/O system iteratively processes subsequent Co-Design modifications to the base 3D CAD model through the 3D CAD Kernel as requested, depending on the selected function [126]. Finally, the I/O system provides an execution command that initiates a process for manufacturing command [127] that causes additional system steps to be performed. The I/O system modular controller initiates a set of subroutines to produce a physical copy of the 3D object by Additive Manufacturing, triggering processing steps that are novel to the Co-Design systems and methods. Of course, this module is capable of being run on any computer and by independent commercial users running e-commerce systems arranged to perform the e-commerce operation in the manner described that is particularly useful for Additive Manufacturing.

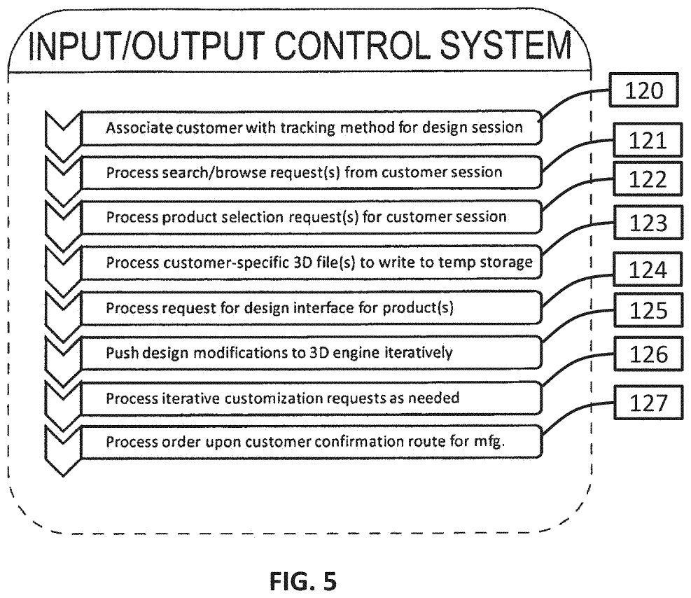

FIG. 6 illustrates processing steps performed by the modular 3D-Viewer controller system [158] which provides functions that includes establishing a design session for each user of the system when accessing a web page [128], and receiving requests from a modular I/O controller system to process a base 3D CAD model in a manner that creates a web-compatible version of the base 3D CAD Model [129] and causes a web-compatible view of the 3D CAD Model to be displayed on the user device [130] and iteratively causes additional web compatible views of the 3D CAD model to be displayed on the user device as needed during a Co-design session in a web page. Of course, as demonstrated, the displayed 3D CAD model may take the form of a 3D representation of the CAD model from the system or a system generated pixel-based rendering of the 3D CAD Model by methods such as Raytracing, radiosity, Phong shading or Gourad shading or other methods.

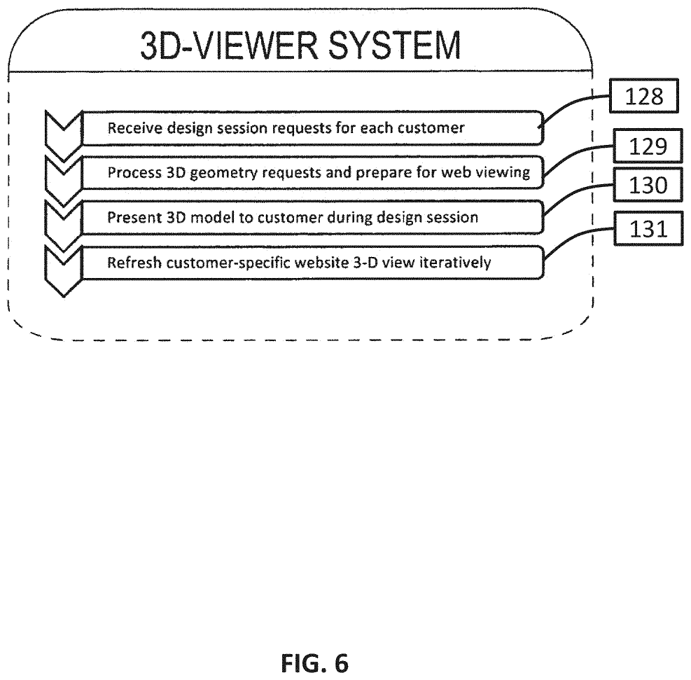

FIG. 7 illustrates processing functions performed by the modular database controller system including; retrieving 3D CAD model files from the database or file system [132] and receiving requests from a system to parse 3D CAD models through a 3D CAD Kernel [133] for varying functions as well as delivering 3D CAD models to other modular controllers [134] such as the web viewer module which may request a 3D CAD model from the database and or file system based on a co-design session initiated in a website. The dataset and or file system and associated controllers may also store temporary 3D CAD model data in a database or file system for each unique customer [135] as well as fetch additional 3D CAD models for a user during a design session [136] or for processing by other processing controllers and modules [137], receive and store temporary 3D CAD Models [138], storing “meta-Data” parameters necessary for print processes [139], storing nested tray files for production [140], storing 3d printer printing device parameters and capabilities [141] and storing remote or geospatially located 3D printer device capabilities [142] such as those available from a remote product facility.

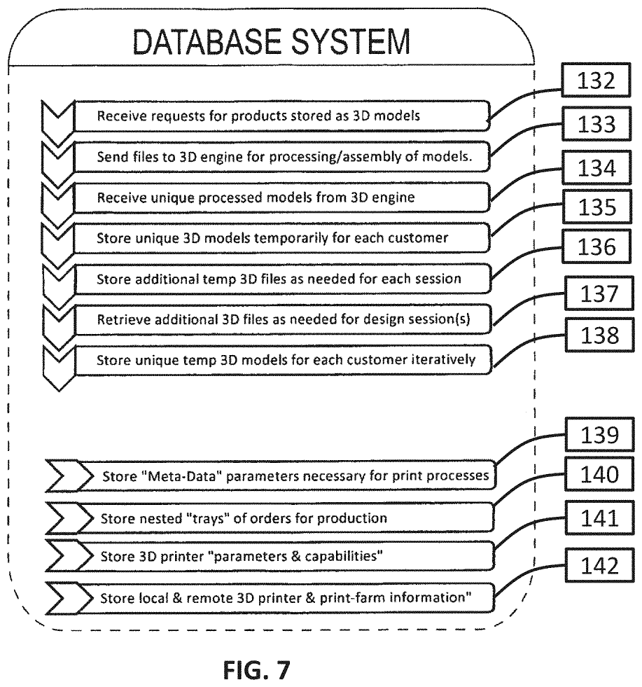

FIG. 8 illustrates processing steps performed by the 3D Kernel or engine controller system [159] including; requesting that a 3D CAD Model be retrieved and “parsed” by the Kernel, meaning it is processed to accomplish a geometry change according to a selected function [143]. retrieved 3D CAD Models from a database or file system [144], performing a mate function [145] which is essentially joining two or more 3D geometries virtually or rather merging data of two 3D objects in a manner that defines their relative position to one another, an output command to store 3D CAD models in a buffer or file system or database [146] transferring 3D CAD model data to a web-viewer module for further processing in order to parse and prepare an iterative updated web compatible view of a 3D CAD model during a Co-Design Session [147] and process iterative requests for such tasks [148] including unique customer sessions in a co-design system [149], iteratively updating the web view after each processed function is performed [150], processing traveler geometry functions [151] using the 3D Kernel to generate the 3D Geometry containing the traveler information defined in the traveler feature, [152], providing 3D CAD Model analysis comprising parsing 3D CAD model data file and processing it, using the 3D CAD Kernel or engine to determine the models physical performance based on material selections [153] and enabling the configuration of co-design constraints by a commercial user within a browser session that define Co-Design features against a base 3D CAD models uploaded to the system [154].

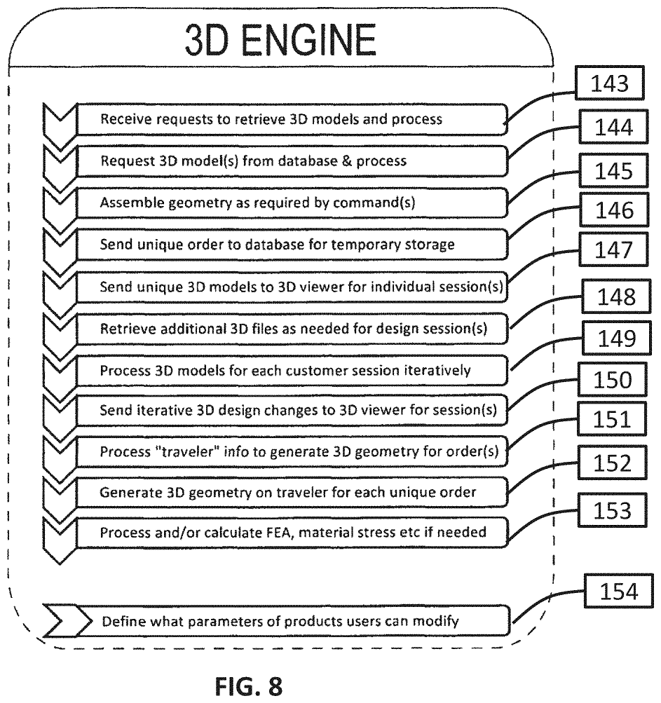

FIG. 9 illustrates the modular nature of the overall Made-To-Order Digital MES comprised of containerized or modular controllers. Each controller comprised of software programming code arranged for performing computing steps on general computing hardware and arranged to provide an array of processing functions in a manner particularly useful for Additive Manufacturing. It is additionally illustrated that the system is interconnected between the modular controllers exemplifying that the system controllers are designed and arranged to provide input and output of data by and between the modular controllers regardless of physical computing location. In particular, attention is drawn to the Application Programming Interface (API) [182] module which, according to commonly understood computing practices provides methods to enable the various modular controllers to be able to communicate between each other and for 3rd party users to integrate and control the system. The figure generally divides the made-to-order portions, on the left side of the figure, from the Digital MES or Digital MES portion of the invention on the right side. Each containerized application working in and arranged to function in conjunction with other modular controllers. The arrangement and use of the various portions of the invention may therefore be used or not used by the commercial user of the system and likewise by a 3^{rd} party user using the system.

FIG. 10 illustrates, 3D CAD Models described in computer CAD Model files and representing “products” stored in a database [184] or file system. Examples of the products include a spaceship top [185], a heart-shaped pendant or charm [186], an anniversary ring [187], a message band [188], an airplane model [189] and a football charm [190]. Of course, the database or file system can also be a PDM/PLM system as employed by Commercial Enterprises. Revision controlled documents are available from PDM/PLM systems.

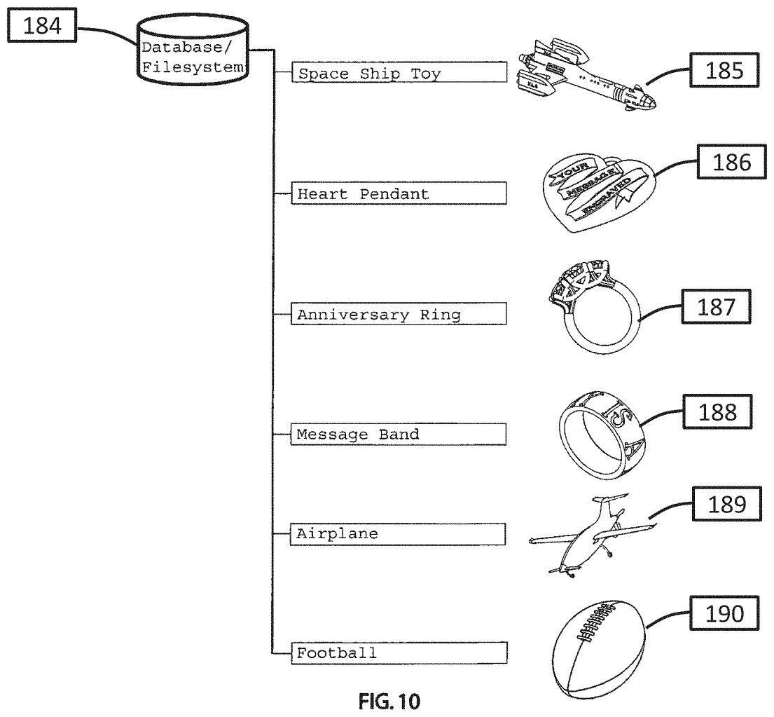

FIG. 11 illustrates an exemplary configuration of a deployment model of the invention comprising; a group of computer server devices providing database functionality for bulk storage and retrieval operations of the operation of the system [191], the e-commerce system operating on a separate computer server [192], Search functions [193] operated on a separate computing device, a 3D Printing print server [194] operated on a separate computing device, a file server [195] operated on a separate computing device and storing 3D CAD models, the Co-Design system operated on a separate computing device, a 3D file buffer for temporary storage and retrieval of 3D CAD model data [197], a web server [198] enabling a plurality of users simultaneous access to the operations of the system over a communication network [199] where the computer servers, utilizing the modular controller software performs the invention. The physical location of each server is not relevant to the functionality of the system. The figure also illustrates the opportunity for portions of the system to be divided amongst commercial users.

FIG. 12 illustrates access to the invention by users utilizing a home PC [200], a notebook computer [201], a mobile cellular device [203] which communicates through a communication network [210] enabled by a the web server [212] to provide system functionality demonstrated within the dashed line of an array of computer servers performing the functions of the invention utilizing the software and general computing hardware. The figure additionally illustrates a distributed manufacturing server device [213] enabling communication with geospatially located additive manufacturing facilities. Each remote manufacturing facility having at least one computing device [204] and each remote facility [205] having Additive Manufacturing device(s) [206] for production of products from 3D CAD Model build files transmitted to the remote facilities and received from the system [211] over a communication network. The remote facilities accessing the Digital MES portions of the system over the communication network, using the computing device at each facility or bureau. The figure additionally illustrates Additive Manufacturing devices located locally and available for production of parts by additive manufacturing from build files prepared by the system. For example, these machines might include a wax printer [207], a DMLS printer [208] or a plastic printer [209]. The system functionality is illustrated herein to enable distributed manufacturing. Distributed Manufacturing denotes that each of the remote computing devices is also using the Digital MES portion of the invention at their location for aggregating, organizing, arranging, scheduling, and packing tray files for production on local printer devices.

FIG. 13 illustrates an abbreviated or simplified representation of the operational model of the invention. A CAD designer creates a base 3D CAD Model [213] and uploads it to the system. The system is configured to receive and store the model as a product and to present an online catalog of such 3D CAD Models to consumers on a web page in an e-commerce fashion. The consumer is able to make a selection of a product represented by one or more 3D CAD Models from a catalog of 3D CAD models presented on the web page and may receive and have displayed on the users computing device, an interface [216] that includes the Co-Design interface. The invention is exemplified as a computing system [217] handling the computerized operations and workflow management of the invention and arranged to transfer build files generated by the system to a 3D Printer device [215] for output. In this figure, a Solid-Scape wax casting pattern for Lost Wax Investment Casting.

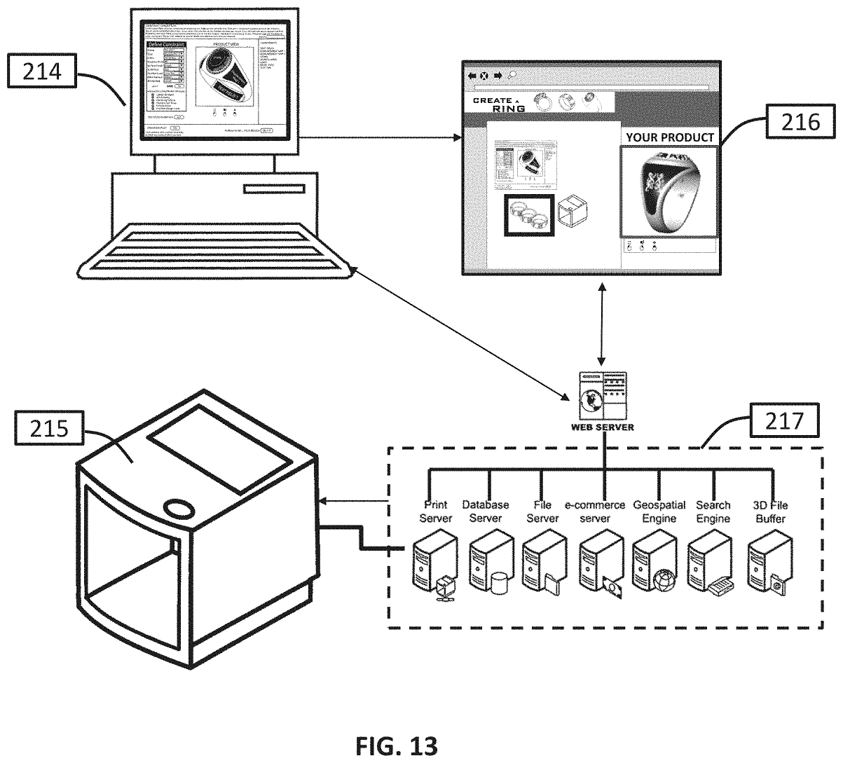

FIG. 14 illustrates an exemplary embodiment of a commercial use case of the invention for design, sale and manufacture of custom Class rings including; the design of 3D CAD Models [218] designed in any 3D CAD Modeling package and comprising a core of a ring [221], a bezel or crowns [222], a gemstone [223], a combined gemstone and crown [224], a core with a casting sprue [225], shank art panels [220], a core having a shank suppressed [226] in a web view, a complete 3D CD Model representing a class ring [227] and an array of 3D CAD models held within a database [228] and representing optional configurations available for the class ring and an interface [219] for the selection, Co-Design and purchase of the product—represented by 3D CAD Models within the system.

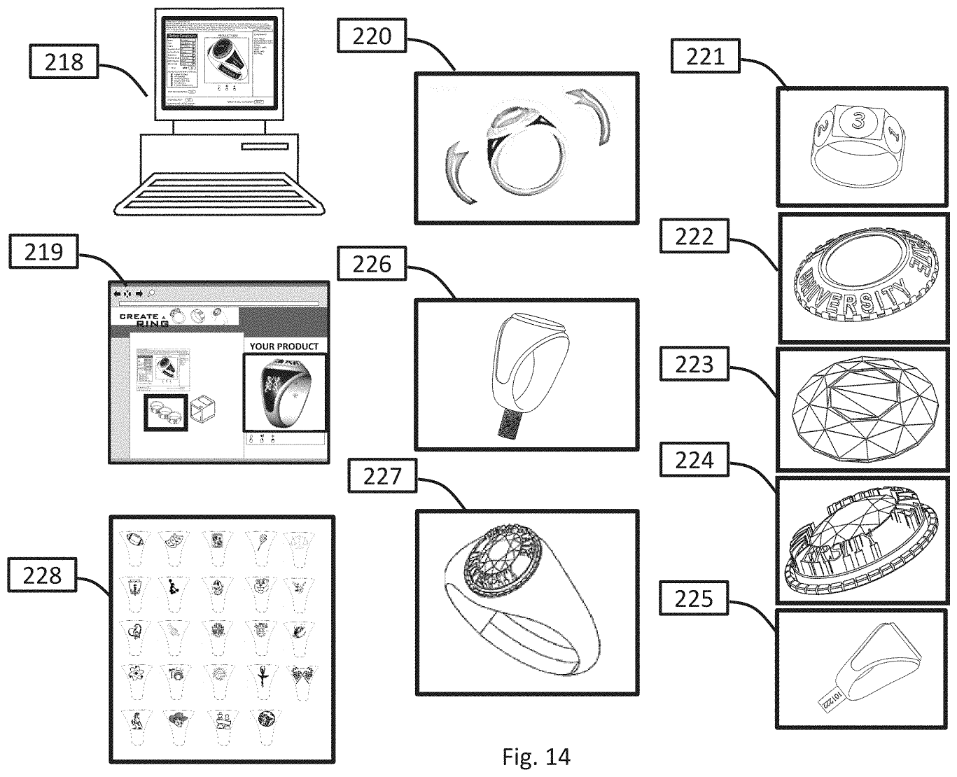

FIG. 15 illustrates a general concept for a class ring comprised of multiple interchangeable 3D CAD model parts. Each part mated to the core [232] by a part mate function controller and representing a left-hand shank [2], a bezel [230], a right-hand shank [231] and a core [232]. Each panel interchangeable by computer function within the system performing the Made-To-Order portion of the invention.

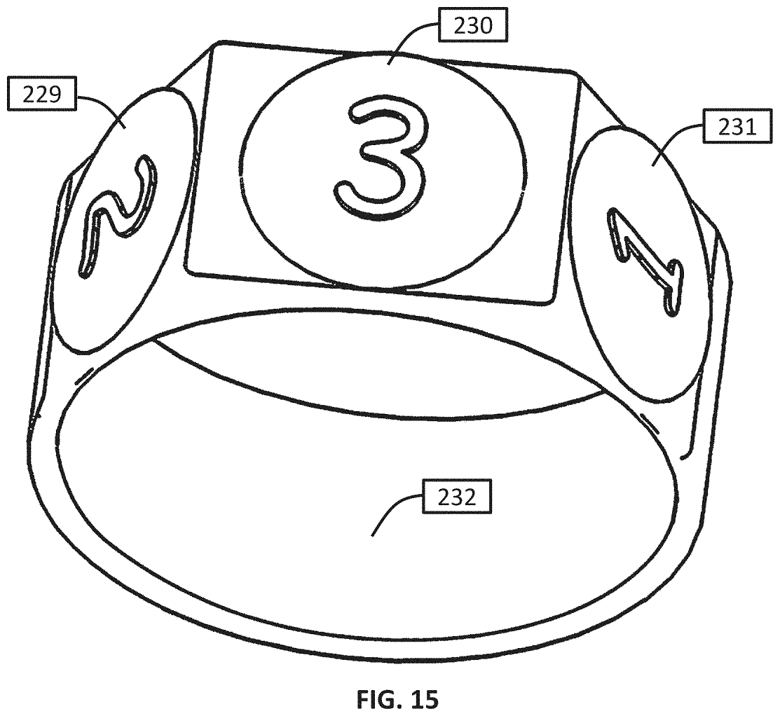

FIG. 16 illustrates a configured Co-design feature for text. The text feature [234] is configured in the Co-Design interface from FIG. 2 as a text feature to the base 3D CAD model, which is in this case, a class ring bezel [233].

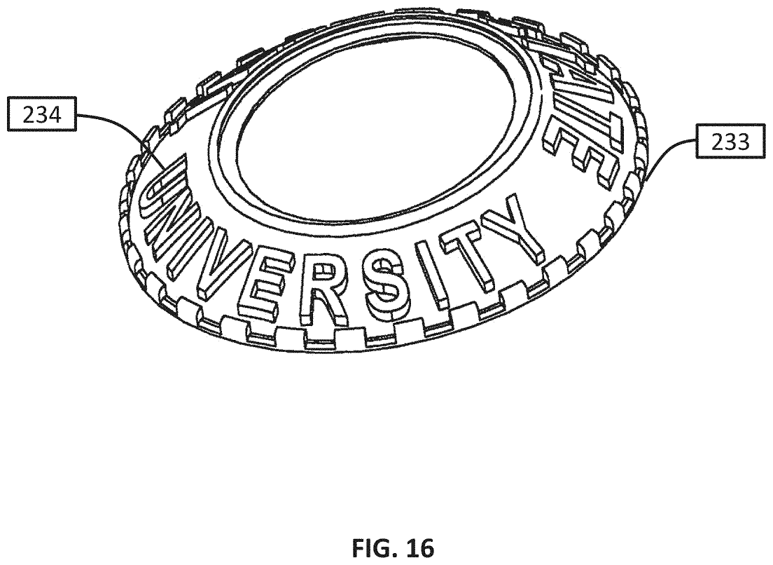

FIG. 17 illustrates a gemstone which is common in jewelry. The inclusion of the 3D model of gemstones within the system is a necessary feature because otherwise the ring products would appear odd to the users in an e-commerce environment and therefore included for visual representation only because gemstones are in many cases natural made and not 3D printed.

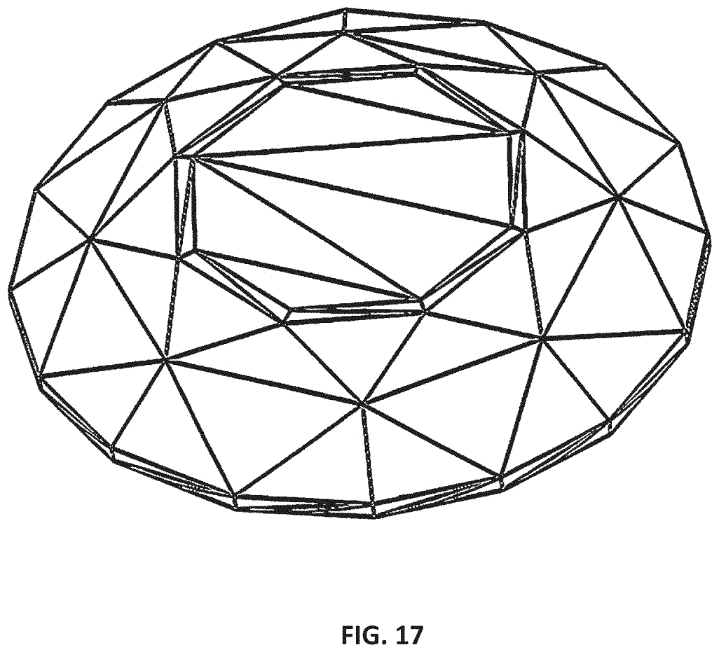

FIG. 18 illustrates a gemstone [235] 3D CAD model mated by a part mate controller [175] to a 3D CAD model of a ring bezel [236] where the bezel has a co-design configurable text feature configured in the co-design interface of FIG. 2 and where the text is arranged as an extrusion in 3D [237] performed by the extrude module [172] and font module [174].

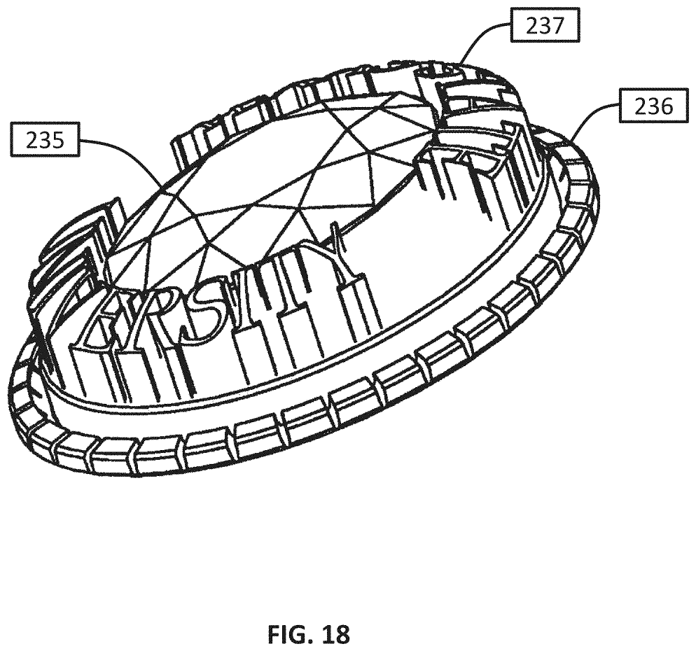

FIG. 19, illustrates a novel commercial business model for on-demand manufacturing by additive manufacturing of class rings or other custom jewelry including consumers shopping online [238] via website enabled by portions of the invention and containing the co-design interface and served to the consumers by the method and system operating on computers [239] which is used to generate Co-Designed 3D CAD Models and prepare them for production by 3D Printing. In the case of jewelry, 3D printing [240]. In this example, the workflow of the system aggregates 3D CAD Models from the ecommerce system and creates nested batches 3D CAD Models which are then scheduled and produced as a wax patterns [241] which are used for lost-wax investment casting [242] and then prepared and packaged for shipping to the customer [243] by customary delivery methods [244]. The business model is applicable to many other market verticals.

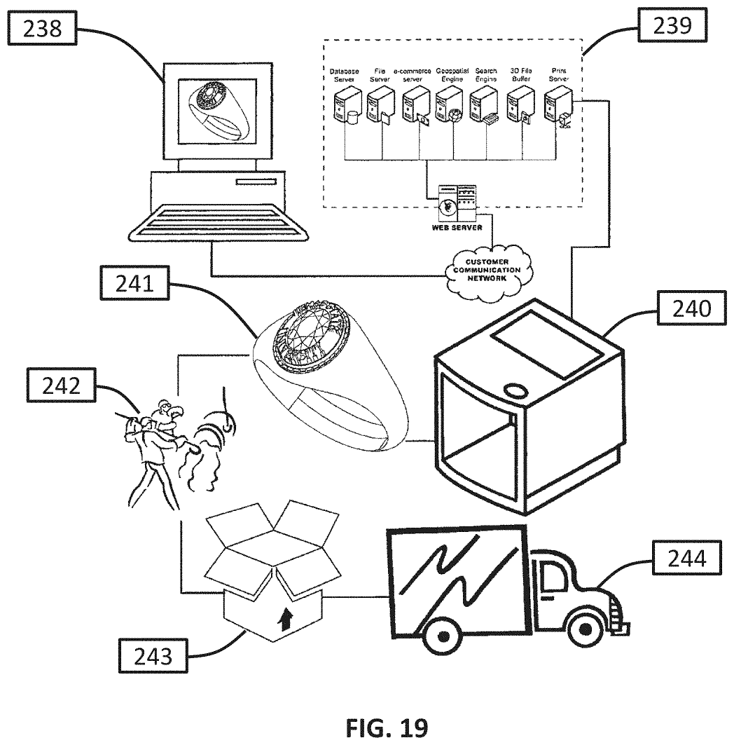

FIG. 20 demonstrates system processing steps performed by the modular production system controller or “production system”. The system is programmed to use general computing hardware to perform the processing steps. The orders are represented by a 3D CAD Model files and meta-data describing the production criteria for the 3D model file and its corresponding 3D CAD geometry. The processing steps include; receiving orders for production queuing [245], analyzing the production needs for the 3D CAD model [246], determining an capacity plan and or organization production plan for the 3D CAD models locally [247] and or remotely [248], determining quality ratings of remote production facilities [249] and using the quality data to make a determination to use a remote facility indexed in the system [250], selecting a 3D printer device indexed within the system locally or remotely [251], routing orders through additional processing steps through the system based on the analysis performed an organization production plan determined by the system [252] the order for production according to production scheduling techniques [252] and generating and providing an estimated delivery time based on estimated production lead time [253]. The controller additionally enables commercial users to input production equipment information including quantity, type, materials [014] and other criteria and creating device profiles within the system which are utilized by the system for organizing, arranging, scheduling, and routing 3D CAD Models through the system workflow [254]. The figure also illustrates the production system including a Product Data Management System, Product Lifecycle Management System and ERP functionality along with the Additive Manufacturing Production System functionality.

FIG. 21 demonstrates system processing steps performed by the nesting system modular controller [162] which performs system processing steps of; parsing and analyzing 3D CAD model geometry within 3D CAD model files for orientation, determining the optimum build angle to minimize build time for the model based on the analysis [256], re-orienting the 3D CAD model geometry for nesting and staking operations based on the determination [257], passing the data off to the stacking system modular controller [258] and accepting commercial user input for parameters for the nesting system operations [259].

FIG. 22 demonstrates system processing steps performed by the stacking system modular controller [161] which performs system processing steps of; receiving re-oriented 3D CAD model file geometry for production [260] from the nesting system [258], electronically and virtually adding the 3D CAD Models received to an arrangement of 3D CAD model files [261] based on a build envelope or printable area defined in the system [262] or reaching a preset limit and writing a completed nested arrangement of a batch or group or subset group of 3D CAD models to a “tray” file [265] which is a nested arrangement of the batch or group of individual 3D CD model files combined in a single computer file and representing a build file for production by an additive manufacturing device. The figure illustrates the result of the system processing steps performed by the stacking system modular controller [161] and nesting system modular controller [162]. The figure reflects the preparation of nested and batched arrangements of 3D CAD model file geometry fitting with the printable area or bounding box of a 3D Printer device based on parameters defining the printable area or bounding box of an Additive Manufacturing device and processing steps of the nesting system [015] [259] and stacking system [265] for a 3D printer device.

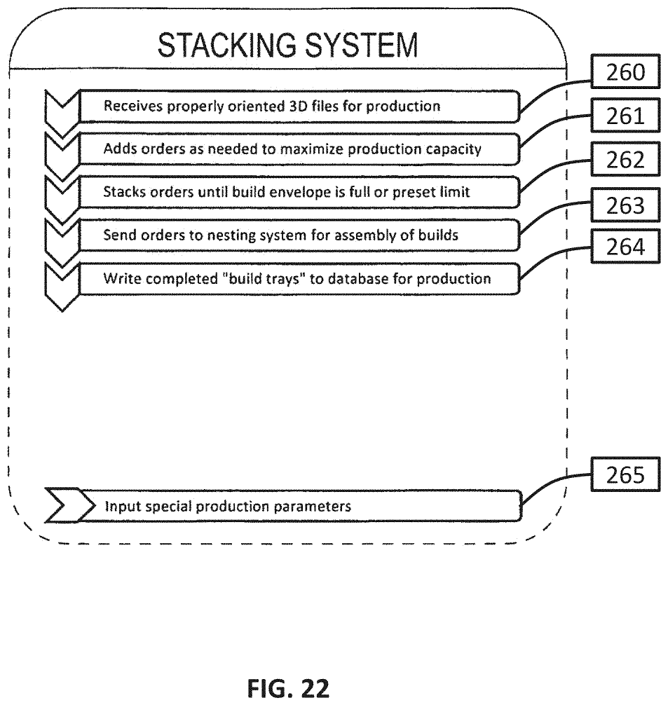

FIG. 23 illustrates a class ring core [268] and an appendage [269] commonly known to one known in the casting manufacturing industry as a sprue. A sprue is used as a flow path for molten metal in the lost-wax investment casting process. The sprue in this case provides two benefits, a casting sprue function, and a digital traveler feature function. The Traveler feature function is highlighted to reflect its function and that it may be suppressed from view in the web browser during a Co-Design Session.

FIG. 24 illustrates the class ring core [270] and the sprue appendage [271]. The sprue has numerical values which are also 3D geometry generated on the sprue geometry [272] which were generated by the digital traveler system modular controller [163] processing steps. In this figure, the digital traveler geometry has been generated and output by the system as geometry so that a 3D Printer device outputs the traveler geometry along with the 3D CAD Model geometry enabling the easy identification of an individual order within a larger array of individual orders [266] output by the system. The Digital Traveler geometry is essentially an update to the base 3D CAD model performed by the system in a manner that may occur before nesting and stacking operations such that the geometry is included in the analysis of the nesting and stacking operation resulting in nested batches of 3D CAD models. Of course, the operation could also be performed after the nesting operation. Additionally, the Digital Traveler can be operated as a stand along feature by a commercial user and having obvious commercial utility.

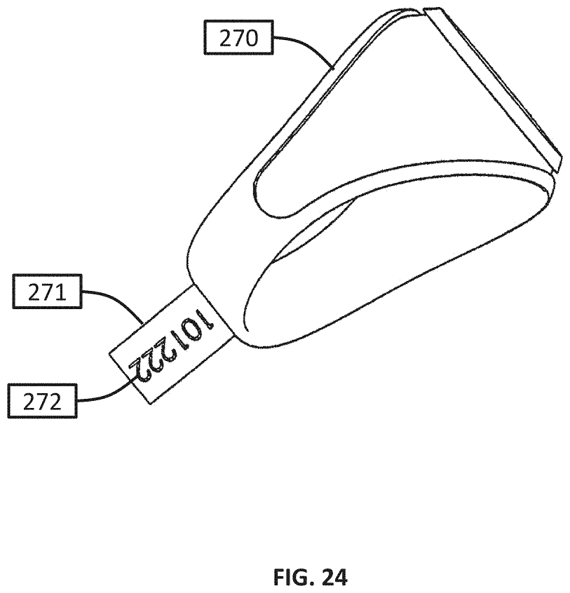

FIG. 25 illustrates several versions of digital traveler geometry, methods and locations including; the class ring sprue geometry [273], an appendage [274] or direct part marking [275]. The Digital Traveler geometry in each case enabling part tracking and identification information to be generated dynamically by the system modular controllers during system workflow performed to prepare production.

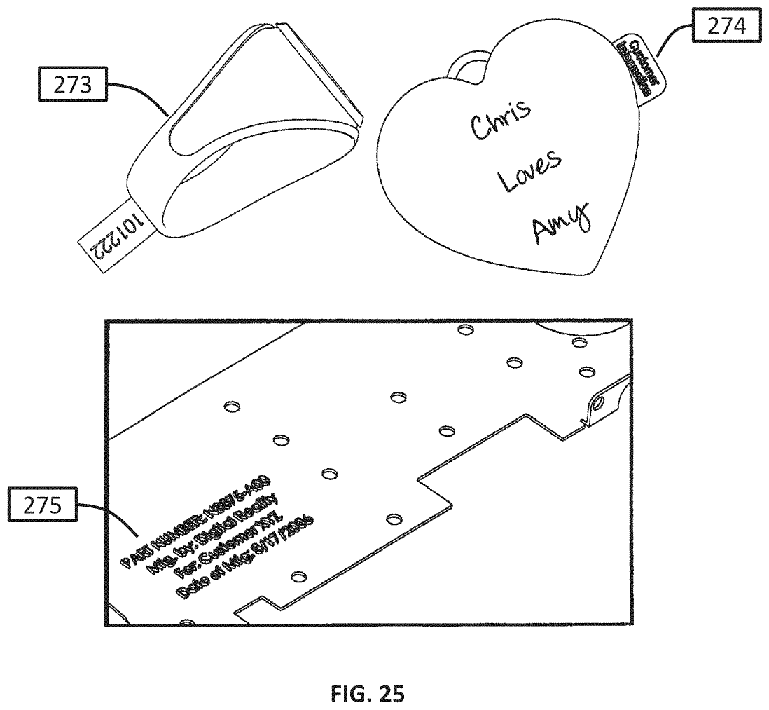

FIG. 26 illustrates an exemplary production scheduling interface of the invention. Each Additive Manufacturing device [276] indexed within and representing a production resource available to the system is presented, along with its production schedule. Each additional machine in the production resource list is also reflected in the system such as machine 6 [279]. Each black bar represents a production scheduled bath job of 3D CAD models prepared and arranged for production by the system in a nesting operation, in a sequence of jobs and assigned to each Additive Manufacturing device [277]. Each job bar represents a “tray” file of properly nested or “packed” arrangements of 3D CAD Models. The chart or graph [278] represents production utilization statistics for each machine such as machine number 1 [276] which is shown selected to present the statistics for the selected AM machine. The production system including production scheduling adapted to perform in a manner particularly useful for additive manufacturing.

FIG. 27 illustrates system processing steps performed by the modular traveler controller system or Digital Traveler controller and performing processing steps for; receiving a production request for processing a 3D CAD Model during a production subroutine routing [280], parsing production criteria required to be converted to geometry related to the unique order [281], submitting a request from the controller to a 3D CAD Engine to generate the data as geometry [282], waiting for the 3D Kernel or engine to generate the geometry [283] and update the 3D CAD Model file with the geometry and routing the production command to the next processing step in the production subroutine [284]. The modular controller also provides and enables traveler definition as geometry to be defined in an interface including traveler geometry, traveler location relative to the base 3D CAD Model and what information is to be converted to geometry [285].

FIG. 28 illustrates system processing steps performed by the modular material matching controller including; receiving processing requests from the production controller to analyze the design intent of a 3D CAD model and its corresponding production criteria information [286], parsing the database of indexed production resources for 3D printer devices meeting the production criteria [287], sending the 3D printer device information for 3D printer devices meeting the production criteria to the system production scheduling controller [288] and storing information in the database for recall [289]. The modular controller also having and providing a commercial user with an interface to define material criteria, in a manner, associating it with 3D printer devices indexed within the system and therefore design intent [290]. For example; a Wax Solid-Scape 3D printer device may be associated with a material selection by a consumer user selecting gold or sterling silver where the wax is needed to cast the gold or silver. The material matching controller determines which 3D Printer devices indexed within the system and available as production resources can produce each production job and its corresponding 3D CAD Model(s) in the material intended to meet the production requirement of the job.

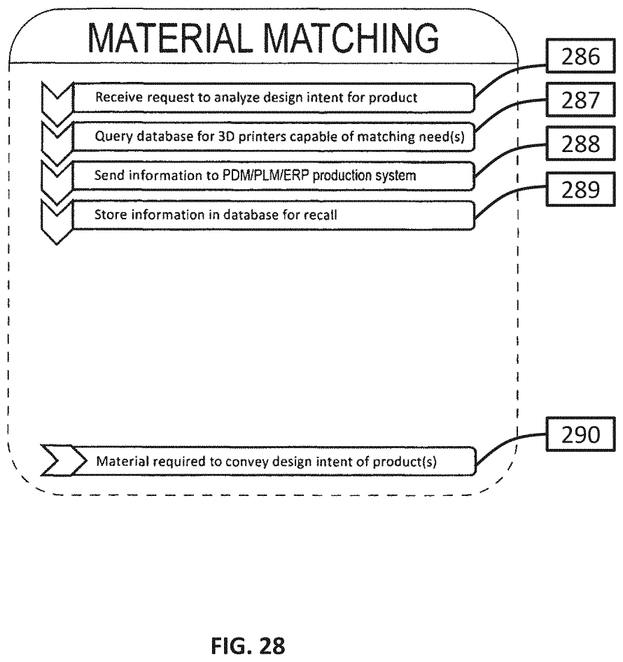

FIG. 29 illustrates system processing steps performed by the modular remote manufacturing controller including; analyzing remote manufacturing facilities and capacity indexed within the system for capabilities to produce the 3D CAD Model remotely [291] and providing the analysis information to the production scheduling system controller [292], sending requests to the quality rating system subroutine modular controller to compare past production event quality to database characterization for the remote facility selected [293] and storing information in the database for recall by the system. The remote manufacturing controller module also provides an interface for external production facilities to create a profile within the system and to input facility production capabilities, equipment, materials, and quantities of equipment [295]. The production capabilities of the remote facilities input by remote commercial user manufacturers being made available to the systems production scheduling controller for production scheduling activities performed by the system. The remote manufacturing controller performs the function of enabling distributed manufacturing or edge manufacturing by enabling other facilities having printer farms to be indexed within the system and available as production resources, serving as nodes in a distributed manufacturing deployment of the invention.

FIG. 30 illustrates system processing steps performed by the modular quality rating system controller including; receiving inquiry requests from the production scheduling controller for quality information [296] where the quality rating information is comprised of characterized ratings based on past production jobs and the machine and or facility having produced past jobs by, analyzing the past quality information for reputation data based on remote factories connected to the system [297] and making the resulting information available to the production scheduling system [298] during order processing as well as storing information in the database related to the quality metrics [299]. The system also providing an interface for customers to input quality ratings based on orders placed by the users to establish a past work quality rating within the system [300].

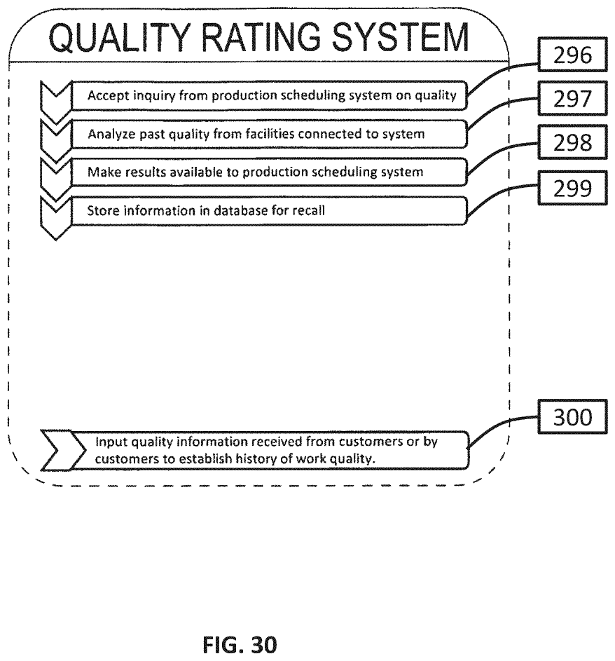

FIG. 31 illustrates one embodiment of the overall integrated workflow of the Made-To-Order portion and the Digital MES portion of the invention. The figure demonstrates that the system is comprised of modular systems and controllers including a website modular controller, a I/O modular controller [302], a 3D web viewer controller [303], a database system controller [304], a 3D CAD Kernel or Engine [305], a production scheduling system controller [306], a stacking system controller [307]. A nesting system controller [308], a traveler geometry generation controller [309], a quality rating system modular controller [310], a remote manufacturing system controller [311], a material matching system controller [312] and a payment gateway system [313]. An Interface for defining digital travelers [314] and processing steps to generate traveler geometry [501], an interface to input special needs for the functionality of the nesting system [315], a method to input quality ratings [316], a method for the commercial user to define production resources, printers, materials and system functionality [317], define co-design constraints [317B] and define materials for design intent [317A]. The figure also demonstrates the general arrangement of the workflow describing the generation of 3D CAD Models or copies of 3D CAD Models via a website and subsequent system processing steps for manufacturing that begin with a process for manufacturing subroutine that begins the production planning, and execution portions of the workflow of the invention.

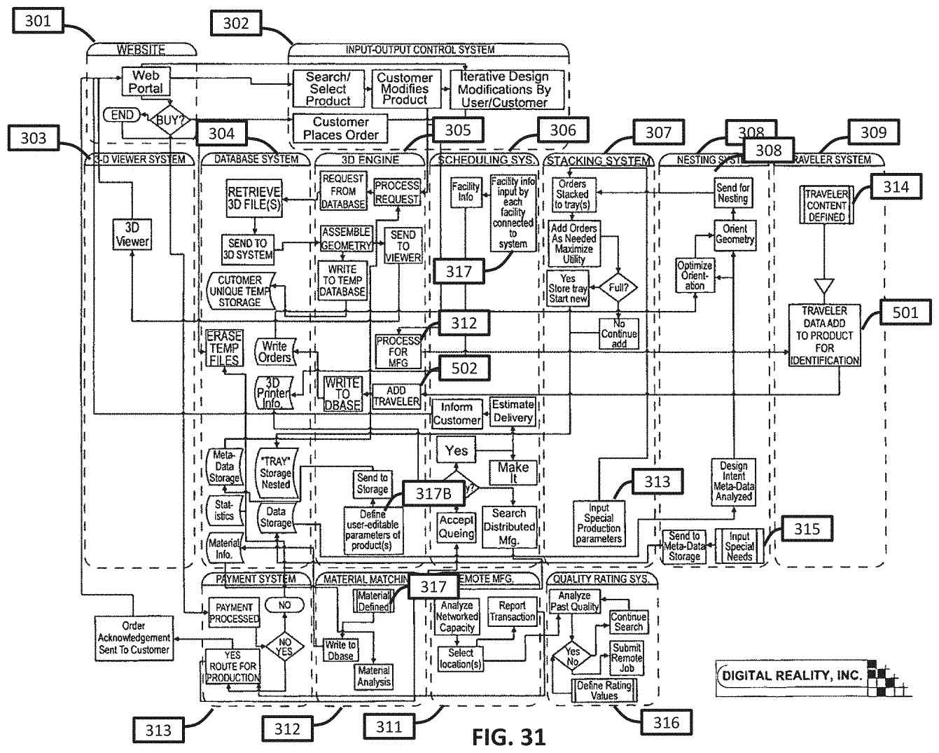

FIG. 32 illustrates an exemplary deployment of the invention including a website, displayed on a domain operated by a commercial user, offering by e-commerce, generated, at least in part, by the system controllers to retail customers [301] enabling retail customers to shop [503] for products within the e-commerce website portion. The figure additionally illustrates the ability to utilize the co-design interface within the system [504] to customize products before purchase. The figure additionally illustrates the commercial user enabling 3^{rd} party contributors to upload and sell products in the system through the website [505] where 3^{rd} party users may even be enabled to receive a sales commission [155] when the 3D CAD Models are sold and produced by the commercial user utilizing the invention. The illustration also demonstrates the ability for 3^{rd} party users to upload and configure base 3D CAD Models for Co-Design [505] of 3D CAD Models and the commercial sale of products based in an ecommerce store based on the 3D CAD models uploaded, received, and stored in the system and produced at least in part by Additive Manufacturing through the workflow of the invention and additive manufacturing. The illustration further demonstrates the availability of an API or application programming interface [506] for enabling 3^{rd} party integration into the invention.

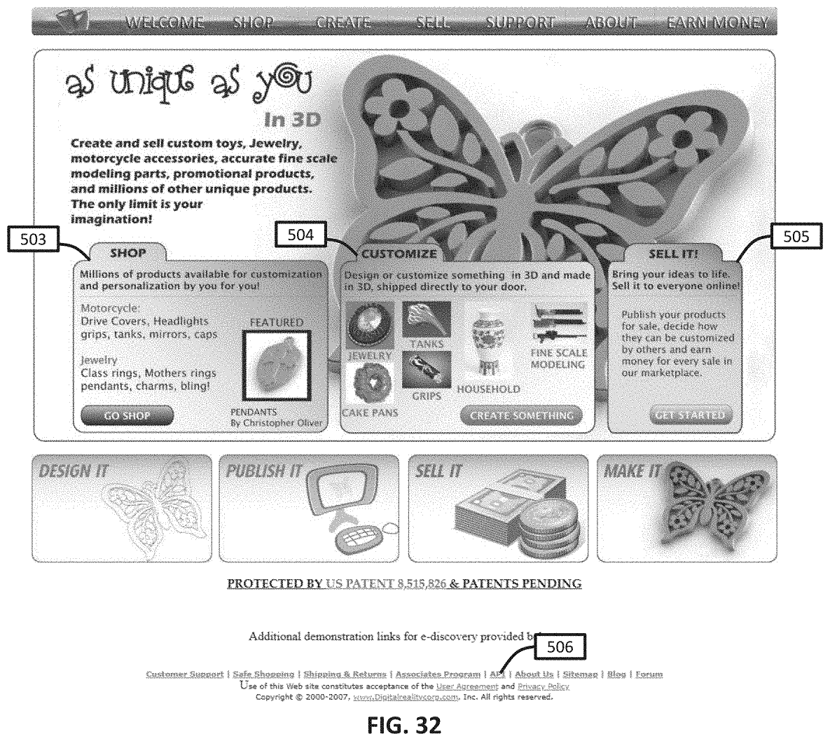

FIG. 33 illustrates a figurative exemplary embodiment of the nature of the invention as a commercial software system entitled Digital Factory and the Made-To-Order Digital Manufacturing Enterprise System statement on the software box and representing a computerized system for both Co-Design AND Digital Workflow Management utilizing 3D printers for additive manufacturing.

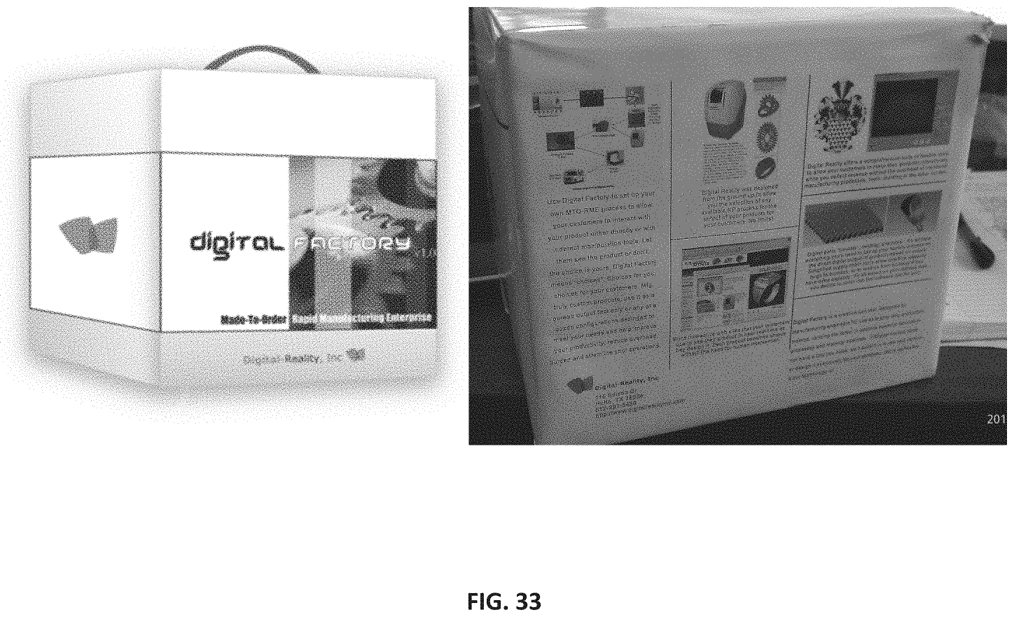

FIG. 34 illustrates an exemplary interface for defining and configuring a digital traveler feature [320] for a base 3D CAD Model uploaded to the system, in this case, a casting sprue containing digital traveler geometry. The digital traveler module [163] providing the functionality in conjunction with a 3D Kernel or engine. The interface enabling the commercial user to select an icon [318] representing the digital traveler function and causing the interface to be displayed for the configuration of the traveler feature. This is very similar to the co-design interface.

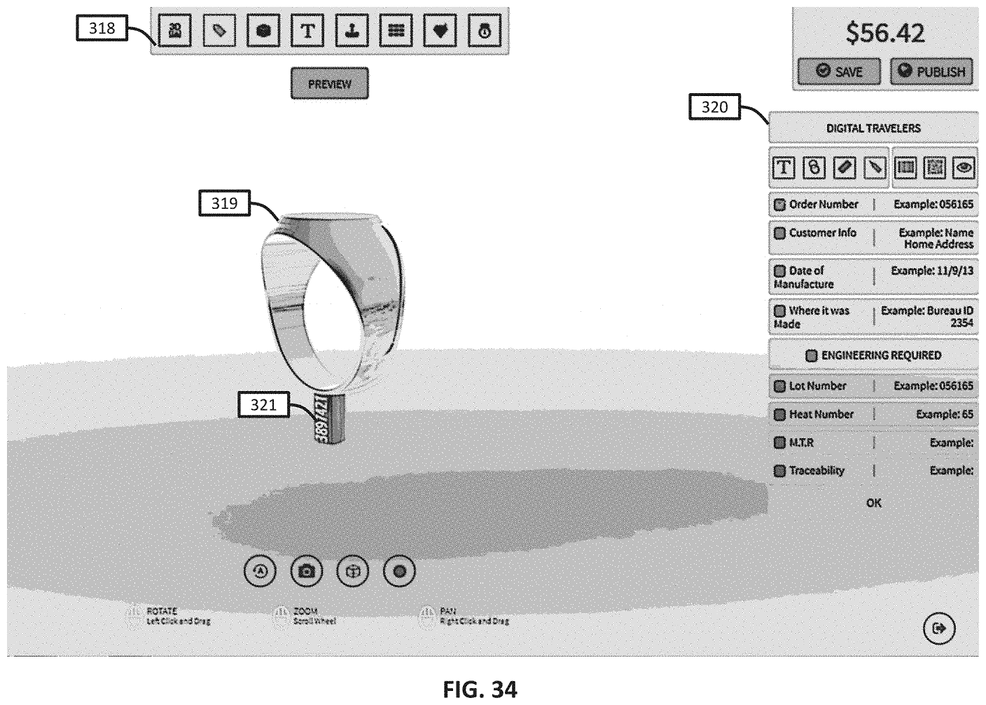

FIG. 35 illustrates the system operating on computer servers [325] controlling a fleet of additive manufacturing machines demonstrating the expandable capacity of the system for providing a flexible production system comprising the invention [325] and Additive Manufacturing production hardware exemplified as a metal AM printer [322], a wax printer [323] and a plastic printer [324] and or multiple discrete machined coupled or available to and indexed in the system representing production resources.

FIG. 36 illustrates a tray file, as prepared by the nesting [162] and stacking system [161] software controllers that results in a tightly packed arrangement of 3D CAD Models organized for production by the system. The arrangement is compiled by the system as a “tray” file [267] containing many CAD models and in this case also reflecting traveler feature geometry [266] also generated by the traveler system controller [163].

FIG. 37 illustrates an exemplary Additive Manufacturing device.

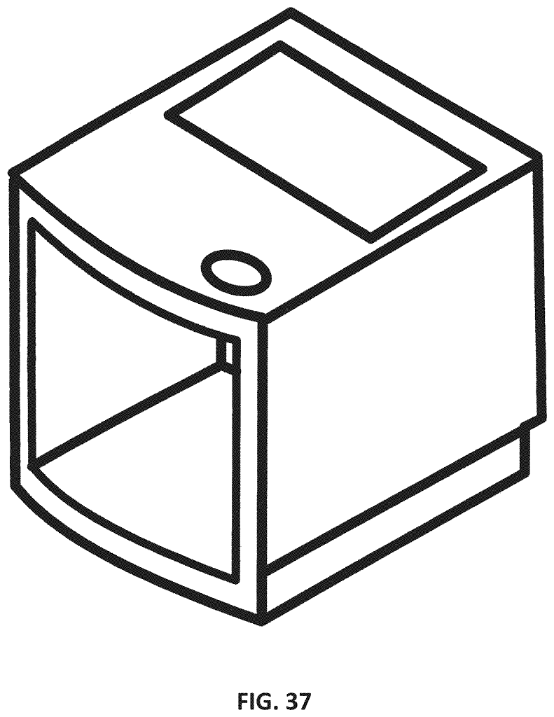

FIG. 38 illustrates the retail view of the Co-Design interface of the system which is the consumer-user version of the of the constraint definition system exemplified in FIG. 2.

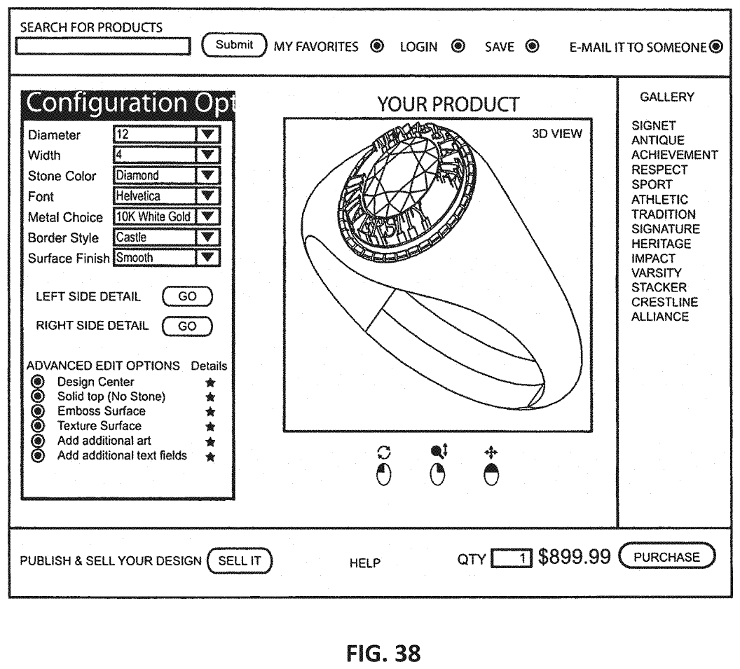

FIG. 39 illustrates a payment processing gateway for performing commonly understood payment processing steps prior to allowing the 3D CAD Model(s) to be transferred to the production queue of the system.

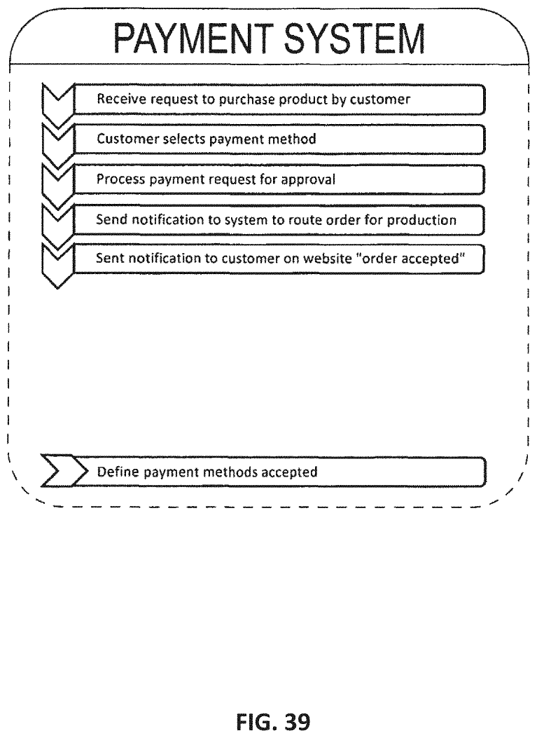

FIG. 40 illustrates a letter from Additive Manufacturing Expert Todd Grim supporting the development of the invention to the United States Military.

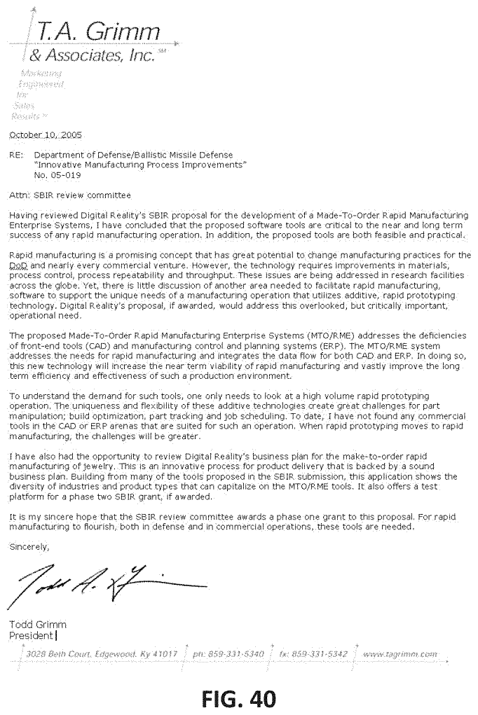

FIG. 41 illustrates a support letter from Additive Manufacturing Experts Dr. Joe Beaman and Dr. Richard Crawford supporting the development of the system to the United States Military.

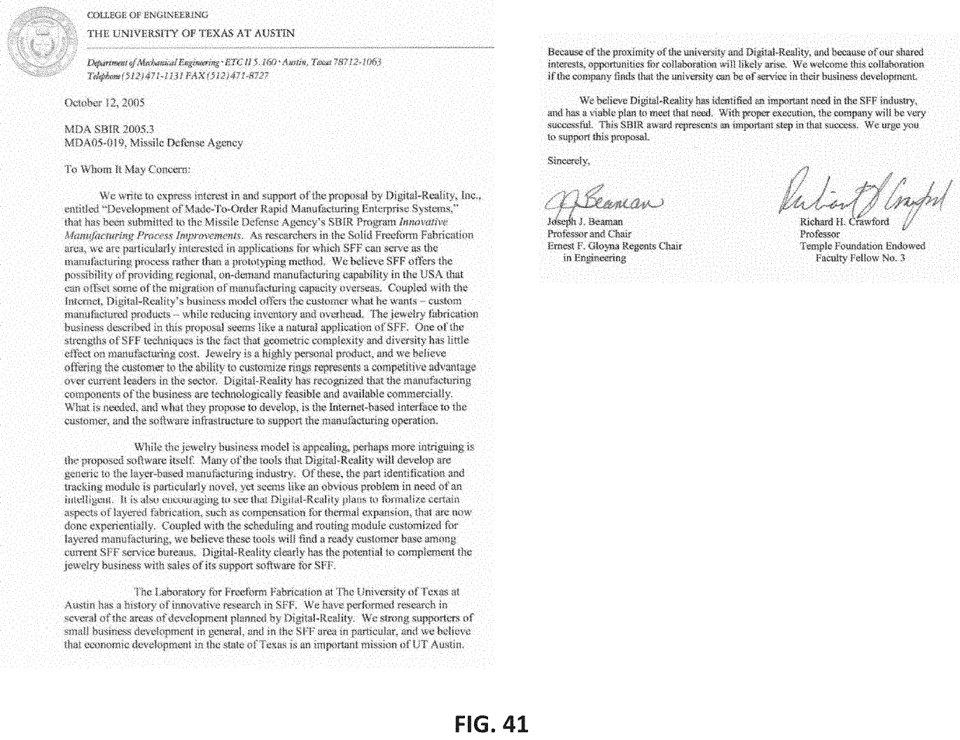

FIG. 42 illustrates a support letter from software and Manufacturing Experts Blain Wallace supporting the development of the system to the United States Military.

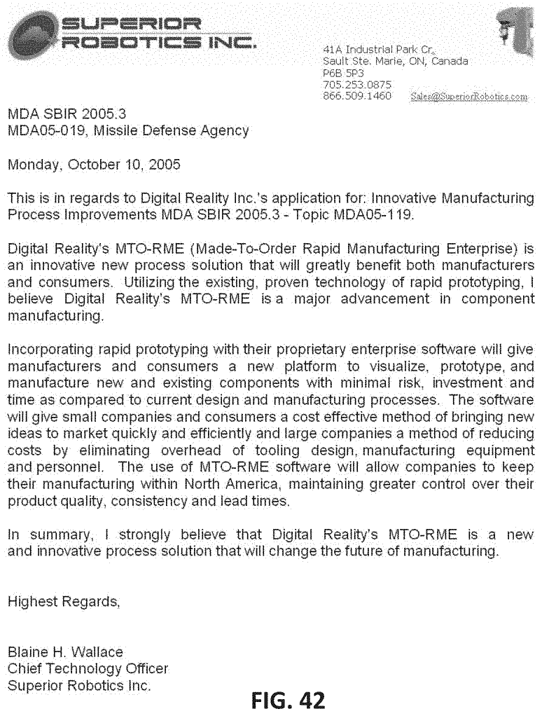

FIG. 43 illustrates a support letter from Dr. V. Jorge Leon, Manufacturing Engineering department head at Texas A&M University supporting the development of the system to the Texas Emerging Technology fund.

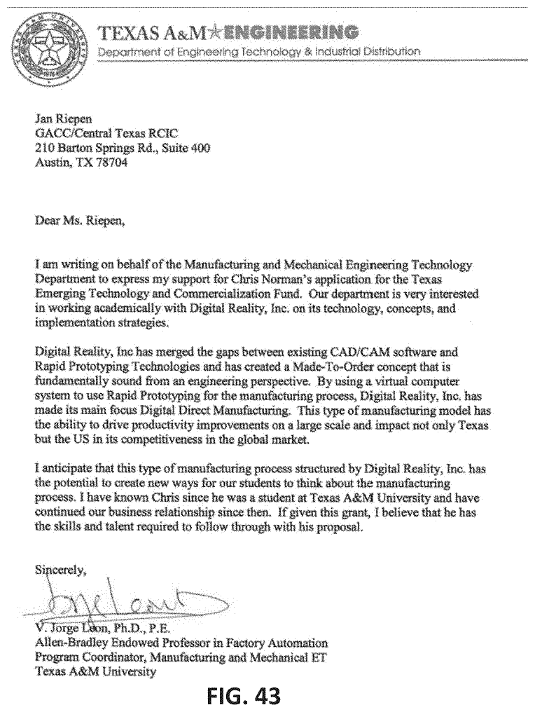

FIG. 44 illustrates a support letter from Jan Ripen, Texas Manufacturing Assistance Center supporting the development of the system to the Texas Emerging Technology fund.

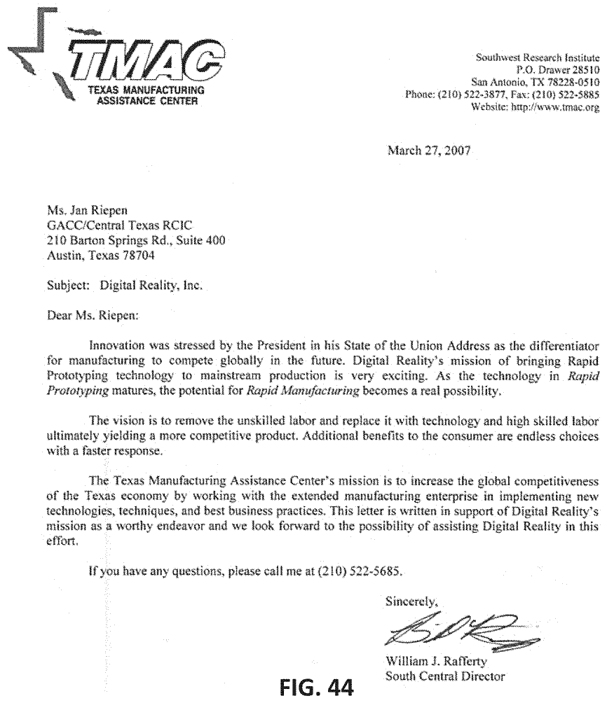

FIG. 45 illustrates a graded college paper received by the applicant of which an A was received for a business management class during an MBA program for the development of the invention.

FIG. 46 illustrates the invention as commercial software system entitled Digital Factory displayed at the domain www.digitalrealitycorp.com as retrieved from the way back machine for 1 Jul. 2007.

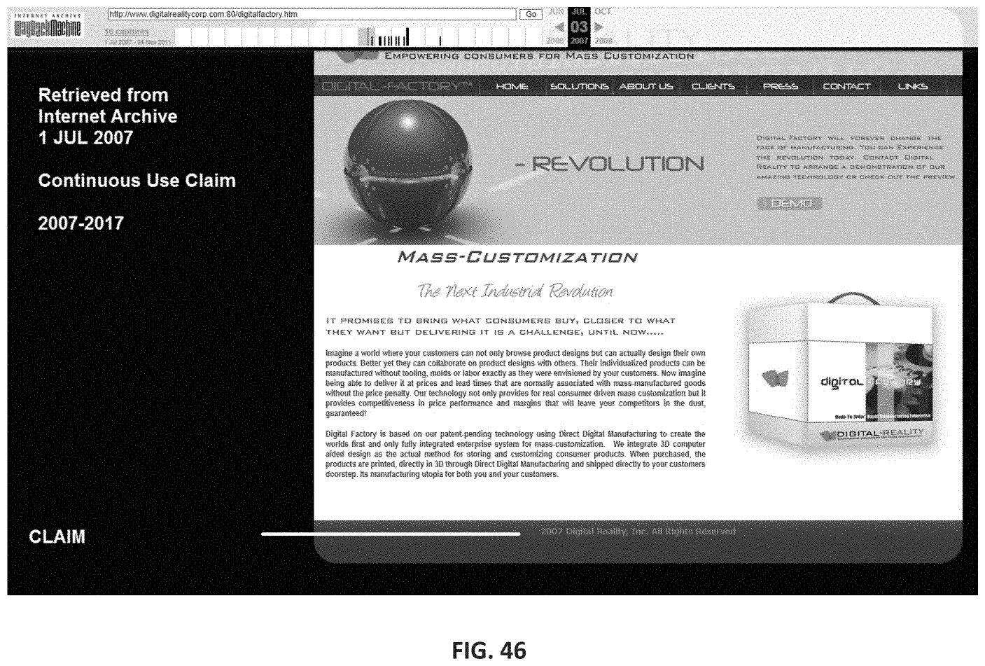

FIG. 47 illustrates the invention embodied as commercial software system entitled Digital Factory displayed at the domain www.digitalrealitycorp.com.

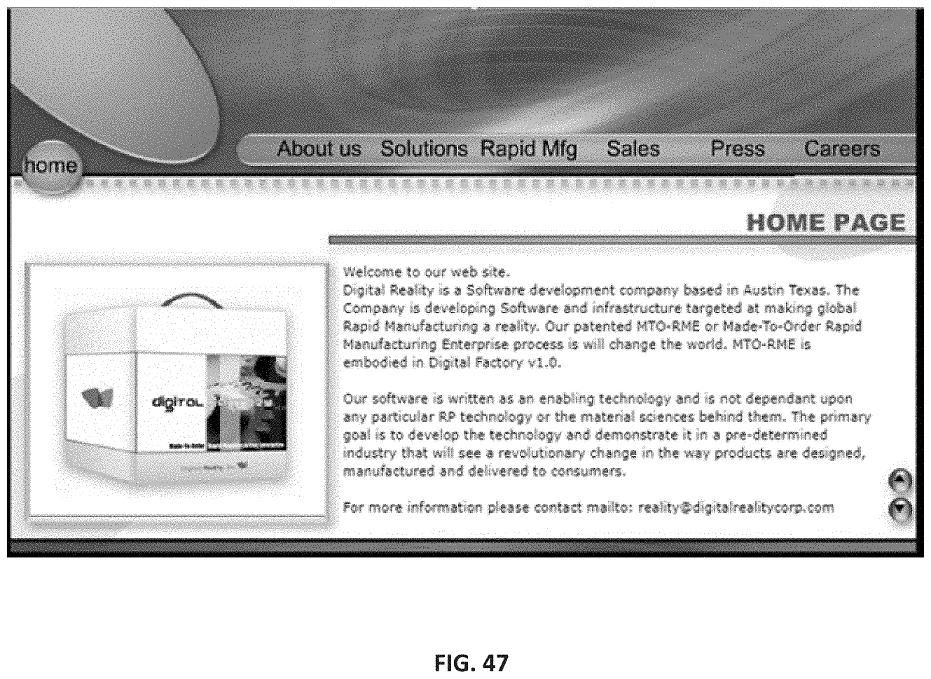

FIG. 48 illustrates an exemplary page of a proposal submitted to the United States Military for the development of the invention under Small Business Innovation Research Grant Proposal MDA05-019 B053-019-0706 circa 2005.

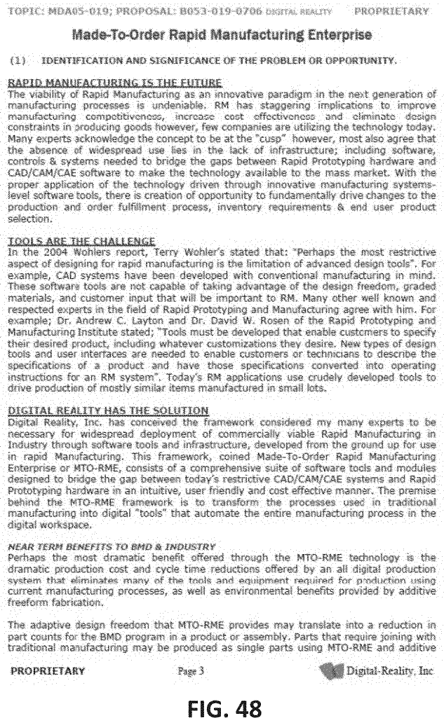

FIG. 49 illustrates an exemplary use of the production management and scheduling interface available to the commercial user for the Digital MES portion of the invention for managing the fleet of additive manufacturing machines indexed within the system and representing production resources available to the system for workflow management. The system generated tray files are queued for production by the fleet of machines available and indexed within the system. The figure demonstrates the computer system having a database system [304], a production scheduling system [306], a stacking [307] and nesting system [308], a traveler system [309], a cad model aggregation device, a tray file production queue device, several packed tray files of 3D CAD Models and a fleet of additive manufacturing devices. The manufacturing devices are indexed within the system [254] by the commercial user as well as the system operating parameters for the nesting system [259] and stacking system [265], parameters for the traveler system [285], the material matching system [290] and other configurable operating parameters.

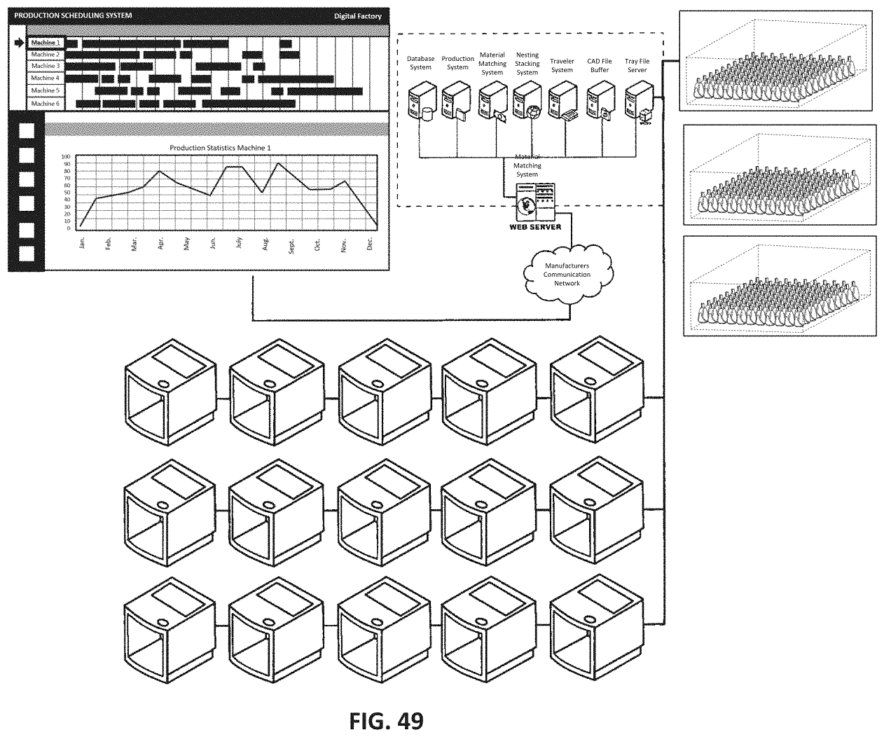

### DETAILED DESCRIPTION OF THE INVENTION

In following specifications, details and descriptions various embodiments will be described and set forth to provide a thorough understanding of the embodiments. However, it will be apparent and therefore understood to one skilled in the art that the embodiments related to the disclosure that the embodiments may be practiced without the specific details in various ways not outlined herein. In other instances, well-known methods, procedures, modules, and controllers have not been described in detail so as not to obscure the embodiments and therefore do not constitute a definition of all possible embodiments. Additionally, it should be recognized that embodiments of the invention disclosed may be implemented according to various protocols and systems capable of providing the functionality described herein. This includes the use of an Application Programming Interface protocol and web-based interfaces; however, it should be appreciated that various other similar frameworks, protocols, and/or mechanisms may also be employed to accomplish the inventions intent.

### Terminology

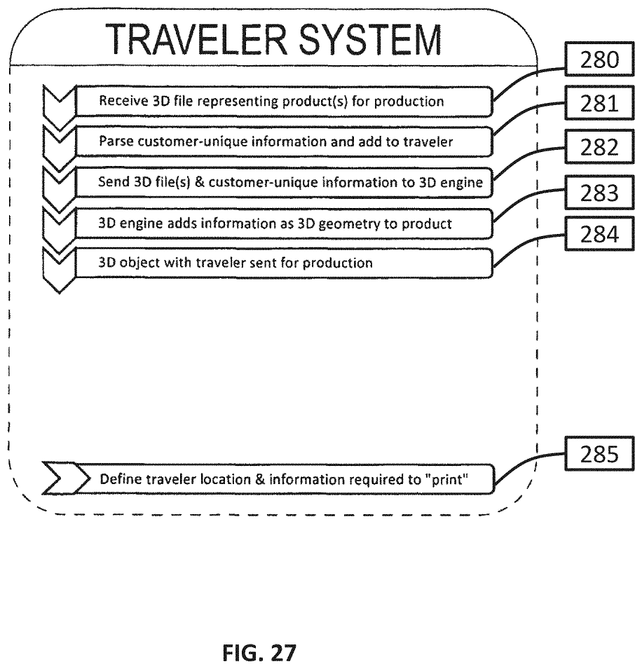

As used herein, the term Scheduling should be understood to refer to a type of timetable for the use of production resources and processes required to produce goods by Additive Manufacturing Machines (Manufacturing Devices). The timetable reflected in the interface of FIG. 27.

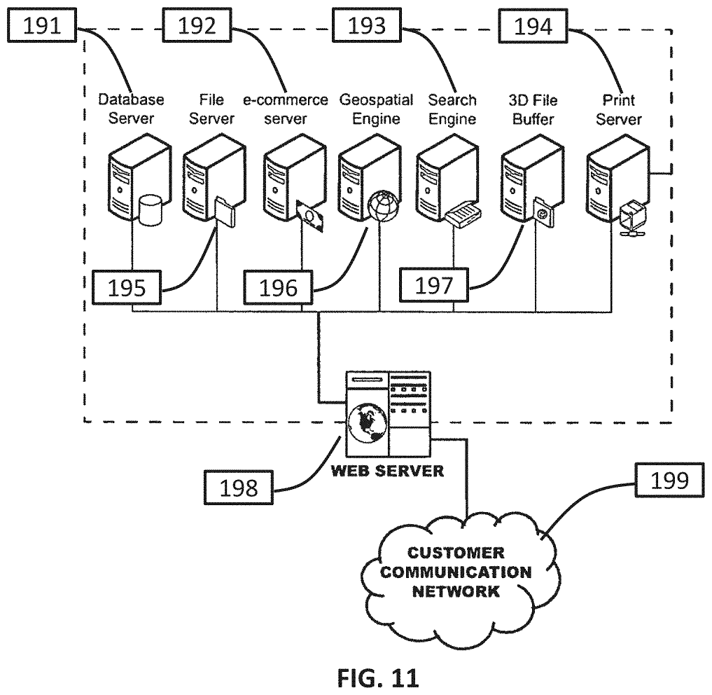

As used herein, the term routing should be understood to refer to the determination of the route to be followed by each 3D CAD Model/Build File and meta-data being transformed from input/raw material into a final product (Object) and the routing of the data packets and files of the 3D CAD Model files digitally being transferred between computing devices as demonstrated in FIG. 11.

As used herein, the term aggregating should be understood to refer to the “collecting” of build files in a queue and or the collecting of 3D CAD Model files in a file buffer or memory or hard drive.

As used herein, the term build file should be understood to refer to a computer file containing 3D CAD Model Geometry used to instruct an Additive Manufacturing Machine (Manufacturing Device) to build the geometry of the object defined in the build file.

As used herein, the term production criteria should be understood to refer to the physical size required for the output of the build file, the quantity of duplicate copies of the object to be produced from the build file, the manufacturing media (material) in which the object defined in the build file must be produced, the type of Additive Manufacturing Machine (Manufacturing Device) required, the physical or geospatial location of the Additive Manufacturing Machine (Manufacturing Device) and or facility operating the Additive Manufacturing Machine (Manufacturing Device).

As used herein, the term database should be understood to refer to an organized or structured collection (set) of data held in a computer, generally stored and accessed electronically from a computer system, especially one that is accessible in various ways including the storage of a ledger of records for Additive Manufacturing. Such ledgers may be public or private depending upon the desired participants. The database is controlled by a Database management system (DBMS) which is the software that interacts with end users, applications, and the database itself to capture, store, retrieve and analyze the data.

As used herein, the terms “additive manufacturing device” and “3D Printer” should be understood to refer to any manufacturing device that serves to produce a three dimensional output object from a digital file using techniques that may include, but are not limited to, fused deposition modeling, fused filament fabrication, direct ink writing, stereo-lithography, digital light processing of photopolymers, powder bed 3d printing, electron beam melting, selective laser melting, selective laser sintering, direct metal laser sintering, laminated object manufacturing, directed energy deposition, electron beam freeform fabrication and any form of Additive material deposition to generate an object.

As used herein, the term organizing should be understood to refer to the sorting of aggregated build-files by production criteria into subset groups according to production criteria.

As used herein, the term stacking should be understood to mean “packing of the geometry of 3D CAD models contained in build files into the virtual printable area or bounding box of an Additive Manufacturing device for the purpose of optimizing the utilization of the Additive Manufacturing device for production.

As used herein, the term Nesting refers to and should be understood to mean the “action” of analysis, by a computer system and determination by the computer system, of the optimal orientation of the geometry of the 3D CAD models and the subsequent “arrangement”, performed by the computing system of a batch of 3D CAD Models that will fit within the bounding box or build envelope of an additive Manufacturing Machine in order to maximize the efficiency of machine utilization and where the build envelope criterion used by the nesting operation is defined by the user of the system and where the output is a single computer file comprising a “nested” or “packed” arrangement of a batch of 3D CAD Model geometries fitting within the printable area or bounding box.

As used herein, the term Tray File should be understood to refer to densely nested or “Packed” arrangements of build files according to production criteria and or scheduling criteria in order to maximize productivity or machine utilization of the available printable area or build envelope of an Additive Manufacturing Machine (Manufacturing Device).

As used herein, the term distributed manufacturing, also known as distributed production, cloud producing, edge manufacturing and local manufacturing should be understood to refer to a form of decentralized manufacturing practiced by enterprises using a network of geographically dispersed manufacturing facilities that are coordinated using information technology In this case, each facility comprising a node on a network and each node having Additive Manufacturing Machines and a controller for managing the production of objects from build Files received by the controller or node.

As used herein, the term co-design or Participatory design should be understood to mean an approach to design attempting to actively involve all stakeholders (e.g. end-users, merchants, designers, manufacturers) in the design and manufacturing process to help ensure the result meets end user needs, is producible and may or may not violate design intent (fit, form function or strength of materials. In this case additionally meaning generating a 3D CAD Model and transmitting/transferring the 3D CAD Model as a build file to an order aggregation device for Additive Manufacturing.

As used herein, the term Product Data Management (PDM) System or Product information management should be understood to mean a software business function often [018] within product lifecycle management that is responsible for the management and publication of product data. In software engineering, this is known as revision control.

As used herein, the term Product Lifecycle Management (PLM) System should be understood to mean a software system for the engineering aspect of a product and for managing the entire lifecycle of the product from inception, through engineering design and manufacture. PLMPLM, therefore, providing a product information backbone to companies and their extended enterprises. Additionally, in this case, meaning a method to speed up product development processes.

As used herein, the term Application Programming Interface (API) should be understood to mean a set of subroutine definitions, communication protocols, and tools for building software. In general terms, it is a set of clearly defined methods of communication among various components. The API is usually related to a software library and provides remote computing devices programmed to use the API to manipulate resources and obtain transaction and data from the device hosting the API program & protocol. It is a way to hook multiple computers together for co-processing tasks or transferring data.

As used herein, the term 3D Kernel or 3D Engine should be understood to be a 3D modeling software component used in computer-aided design package for geometric modeling. The 3D Kernel provides capabilities including model creation and editing utilities for both parametric modeling (Solid modeling) and mesh modeling (Polygon modeling). 3D Kernels may be any number of software packages or modules designed to generate geometry.

As used herein, the term 3D Viewer System should be understood to be a workflow method for converting 3D CAD Models or build files of any 3D CAD Model format into a web-compatible view format for viewing in a browser.

As used herein, the term ERP or Enterprise Resource Planning ERP should be understood to mean a category of business management software—typically a suite of integrated software applications—that an enterprise can use to collect, store, manage, and interpret data from many business activities including manufacturing.

As used herein, the term Module should be understood to be part of a program. Programs are composed of one or more independently developed software modules that are not combined until the program is linked. A single module can contain one or several routines. In this case one such link method is an Application Programming Interface (API).

As used herein, the term traceability should be understood to mean the tracking of objects processed by the invention for the purposes of information determining information about the part, the date of manufacture, customer information, lot number, serial number, heat number or other traceability criteria desired by the user of the system or the recipient of the object, including a means to physically identify the marking.

As used herein, the term Traveler should be understood to mean data or documents carried along a work order's lifespan from entry for production through shipping to a customer. When a manufacturing “job”, in this case a 3D CAD Model and production criteria, are released for production, the traveler and the 3D CAD Model are routed from station to station throughout the electronic production process where the system tracks progress until the item is produced, inspected and the job completed.

As used herein, the term Digital Traveler should be understood to mean software module or process for first receiving data criteria designated that should be generated as geometry for each build file processed by the system. The geometry generated by the Digital Traveler module based on pre-defined criteria and available in multiple geometric forms. The Digital traveler geometry aiding in identification of objects produced in a high-volume/high-mix additive manufacturing environment.

As used herein, the term Material Matching should be understood to mean a material identifier comprising an identifier electronically stored in a database, a computer file or file system correlating to Additive Manufacturing Materials and comprising a “virtual” ledger of materials available for generating an object from by Additive Manufacturing. The materials may additionally be correlated to Additive Manufacturing device types including Make, Model and Brand such that the Material and Hardware can be identified and matched to a build file being processes by (traveling) through or being “routed” through an electronic production system.

As used herein, the term website or web site should be understood to mean a collection of related network web resources, such as web pages, multimedia content, which are typically identified with a common domain name, and published on at least one web server. Websites can be accessed via a public Internet Protocol (IP) network, such as the Internet, or a private local area network (LAN), by a uniform resource locator (URL) that identifies the site. Websites are typically dedicated to a particular topic or purpose, ranging from entertainment and social networking to providing news and education. All publicly accessible websites collectively constitute the World Wide Web, while private websites, such as a company's website for its employees, are typically part of an intranet. Web pages, which are the building blocks of websites, are documents, typically composed in plain text interspersed with formatting instructions of Hypertext Markup Language (HTML, XHTML). They may incorporate elements from other websites with suitable markup anchors. Web pages are accessed and transported with the Hypertext Transfer Protocol (HTTP), which may optionally employ encryption (HTTP Secure, HTTPS) to provide security and privacy for the user. The user's application, often a web browser, renders the page content according to its HTML markup instructions onto a display terminal.

As used herein, the term E-commerce should be understood to mean the activity of buying or selling of products on online services or over the Internet. Electronic commerce draws on technologies such as mobile commerce, electronic funds transfer, supply chain management, Internet marketing, online transaction processing, electronic data interchange (EDI), inventory management systems, and automated data collection systems. Modern electronic commerce typically uses the World Wide Web for at least one part of the transaction's life cycle. There are three areas of e-commerce: online retailing, electronic markets, and online auctions. E-Commerce can be used for Business to Consumer, Business to Business or Business to business to consumer transactions.

As used herein, the term control system should be understood to mean a system that manages commands, directs, or regulates the behavior of other devices or systems. Control systems, comprising software commands can control other software programs. In the case of an Application Programming Interface, the control system is a set of subroutine definitions, communication protocols, and tools for building software. In general terms, it is a set of clearly defined methods of communication among various components. The API is usually related to a software library and provides remote computing devices programmed to use the API to manipulate resources and obtain transaction and data from the device hosting the API program & protocol. It is a way to hook multiple computers together for co-processing tasks or transferring data.

As used herein, the term Quality Rating System should be understood to mean tools designed to or arranged to assess, improve, and promote quality of manufacturing production. In this case, a means to manage the production quality of objects built on Additive Manufacturing Devices operating as a fleet in a facility or in a distributed network of production facilities each operating as a production node in the network and each having a fleet of additive manufacturing devices. The data collected by the quality rating system being stored in a database comprising a ledger of past production performance of each machine or facility (node) in order to analyze, asses and improve future production quality based on past performance criteria as part of a distributed or “edge” based additive manufacturing network.

As used herein, the term Product Browse module should be understood to mean a software module for accessing, retrieving and presenting structured data, from a database comprised of a catalog of information pertaining to a product or object available from one or more electronic catalogs of objects available to be physically obtained from the one or more electronic catalogs by means of additive manufacturing. The module typically used as part of an electronic commerce system or electronic catalog system such as a PDM/PLM system, including by means of an API.

As used herein, the term Product Search module should be understood to mean a software module for accessing, retrieving and presenting structured data, from a database comprised of a catalog of information pertaining to a product or object available from one or more electronic catalogs of objects available to be physically obtained from the one or more electronic catalogs by means of additive manufacturing. The module typically used as part of an electronic commerce system or electronic catalog system such as a PDM/PLM system, including by means of an API.

As used herein, the term Manufacturer Interface should be understood to mean an interface used by a commercial user. The interface is provided by a software module that generates the interface and enables the system to receive input and configuration options and variables from the commercial user or manufacturer. The criteria input into the interface by the commercial user, provides a mean of for configuring the workflow of the system.

As used herein, the term Constraint Configurator should be understood to mean a software module designed for enabling the configuration of geometric modifiers for altering the geometry of 3D CAD Models in a co-design methodology. In this case, for altering the geometry of a base 3D CAD model received by the system. The base 3D CAD Model designed in any 3D CAD application. The module is configured to receive 3D CAD Models from a user, generate an interface, responsive to the uploading of the 3D CAD Model and to present a configuration interface. Within the interface are tools for definition customization features and for the user to input parameters and values defining constraints as customization features. The constraints stored are saved and or stored in the system in a manner associating them with the base 3D CAD Model for presentation to a second user, typically a client or customer, and enabling the second user, using the previously designated constraints to alter the geometry of the base 3D CAD model in order to generate a derivative design. The 3D CAD Model derived from the base 3D CAD model. The 3D CAD Model being generated and or made available as a build file to an [019] additive manufacturing production scheduling and planning system arranged to receive such information from the Co-Design system including by means of an API.

As used herein, the term displacement map module should be understood to mean a mathematically derived geometric modifier for altering the geometry of a base 3D CAD Model. The geometric modifier also referred to as a customization feature accessible for altering the geometry of a base 3D CAD Model. The modifier function being made available at least by means of an API and by presentation in a browser. The Module comprising executable computer code that generates a displacement map according to a pre-defined co-design constraint representing a customization features including by means of an API.

As used herein, the term extrude module should be understood to mean a mathematically derived geometric modifier for altering the geometry of a base 3D CAD Model. The geometric modifier also referred to as a customization feature accessible for altering the geometry of a base 3D CAD Model. The Module comprising executable computer code that generates a displacement map according to a pre-defined co-design constraint representing a customization features including by means of an API.

As used herein, the term emboss module should be understood to mean a mathematically derived geometric modifier for altering the geometry of a base 3D CAD Model. The geometric modifier also referred to as a customization feature accessible for altering the geometry of a base 3D CAD Model. The Module comprising executable computer code that generates a displacement map according to a pre-defined co-design constraint representing a customization features including by means of an API.

As used herein, the term font module should be understood to mean a mathematically derived geometric modifier tool for altering the geometry of a base 3D CAD Model. The geometric modifier also referred to as a customization feature accessible for altering the geometry of a base 3D CAD Model. The Module comprising executable computer code that generates a displacement map according to a pre-defined co-design constraint representing a customization features including by means of an API.

As used herein, the term Part Mate module should be understood to mean a mathematically derived geometric modifier for joining two or more geometries of a base 3D CAD Models to form an assembly. The Module comprising executable computer code that generates a displacement map according to a pre-defined co-design constraint representing a customization features including by means of an API.

As used herein, the term Suppress on print module should be understood to mean a modifier for designating a modifier against one or more 3D CAD Models and then suppressing a geometric feature of a 3D CAD Model assembly during fabrication. The feature referring to a portion of the geometry of a base 3D CAD Model or one or more additional 3D CAD Model geometries in an assembly. In this context, an example being a 3D CAD Model of a Gemstone. The Gemstone, in this case, being generated and presented to one user and suppressed when generating a build file. The Module comprising executable computer code that generates a displacement map according to a pre-defined co-design constraint representing a customization features including by means of an API.

As used herein, the term Upload Artwork module should be understood to mean a method for electronically receiving one or more raster images. The module providing a mean to the constraint system to receive artwork for generating, by means of the displacement mapping module, geometry on the topology surface of a base 3D CAD Model received by the system. The Module comprising executable computer code that generates a displacement map according to a pre-defined co-design constraint representing a customization features including by means of an API.

As used herein, the term Sketch Design module should be understood to mean a mathematically derived 2-Dimensional sketch that may be converted, by means of a geometric modifier, such as the extrude module or text module for generating geometric features on a base 3D CAD Model. The Module comprising executable computer code that generates a displacement map according to a pre-defined co-design constraint representing a customization features including by means of an API.

As used herein, the term Stretch/Skew/Smorf Module should be understood to mean a computer function for altering a base 3D CAD Model, as a geometric modifier, by selecting and dragging vertices, handles or faces of base 3D CAD Models. The Module comprising executable computer code that generates a displacement map according to a pre-defined co-design constraint representing a customization features including by means of an API.

As used herein, the term Paint Surface Module should be understood to mean a method for generating a texture map for a received base 3D CAD Model or a base 3D CAD Model first altered by another constrain modifier. The method arranged to provide color to the surface of a model in a co-design environment. The Module comprising executable computer code that generates a displacement map according to a pre-defined co-design constraint representing a customization features including by means of an API.

As used herein, the term Constrain Module should be understood to mean a mechanism for receiving and storing structured data as part of a co-design system. The constrain module enabling the system to receive designations and values defining variables that may be modified in a co-design session. The Module comprising executable computer code that generates a displacement map according to a pre-defined co-design constraint representing a customization features including by means of an API.

As used herein, the term Sales Commission system should be understood to mean a software module for enabling payment to a designer of a 3D CAD Model, the 3D CAD Model being received, by the system and made available for presentation to 3rd party users as part of an Omni-channel sales and distribution (Additive Manufacturing) system. The Module comprising executable computer code that generates a displacement map according to a pre-defined co-design constraint representing a customization features including by means of an API.

As used herein, the term Preflight should be understood to mean the process of confirming that the digital files required for the printing process are all present, valid, correctly formatted, and of the desired type. The basic idea is to automate the preparation of the files to make them feasible for production and subsequently organize and generate a plan of operations for systematically causing the conversion of the received CAD files and production criteria into physical objects, at least in part by additive manufacturing.

As used herein, the term Mass-Customization should be understood to mean a manufacturing technique which combines the flexibility and personalization of custom-made products with the low unit costs associated with mass production, in this case, at least in part by Additive Manufacturing.

As used herein, the term Finite Element Analysis refers to the most widely used computerized method for solving problems of engineering and mathematical models. Typical problem areas of interest include the traditional fields of structural analysis, heat transfer, fluid flow, mass transport, and electromagnetic potential. The FEM is a particular numerical method for solving partial differential equations in two or three space variables (i.e., some boundary value problems). To solve a problem, the FEM subdivides a large system into smaller, simpler parts that are called finite elements. This is achieved by a particular space discretization in the space dimensions, which is implemented by the construction of a mesh of the object: the numerical domain for the solution, which has a finite number of points. The finite element method formulation of a boundary value problem finally results in a system of algebraic equations. The method approximates the unknown function over the domain. The simple equations that model these finite elements are then assembled into a larger system of equations that models the entire problem. The FEA then uses vibrational methods from the calculus of variations to approximate a solution by minimizing an associated error function. FEA analysis is usually performed using a CAD Kernel or 3D Kernel comprising the math libraries necessary to perform the functions described for a given 3D CAD model.

### Introduction

The Made-To-Order Digital Manufacturing Enterprise System invention can be described as a first part or a “made-to-Order” part and a second part or a “Digital Manufacturing Enterprise” part hereafter referred to as a Digital MES. The Made-To-Order portion of the prior disclosure provides an electronic commerce method and Co-Design method adapted an arranged to define, generate, compile and or transfer 3D CAD Model files and associated production criteria or meta-data to an order aggregation and workflow management system in a manner particularly useful for Additive Manufacturing.

The Digital MES portion of the previous disclosure is arranged and configured to provide data processing and workflow management of the received 3D CAD Models in a manner also particularly useful for additive manufacturing. Furthermore, the figures provide and disclose the modular nature of the invention as being a software system comprised of a plurality of modular controllers.

Each modular controller collectively performing the functionality of the invention is demonstrated to be comprised of computer programming code arranged for controlling general computing hardware in the performance of the invention. The figures also provide processing steps performed by each modular controller as well as a workflow of the overall system in an embodiment of the invention however; additional embodiments of the invention are possible based on the modular nature of the invention. As such, this patent application describes such additional embodiments along with declarative and exemplary embodiments of the invention. As such, the following disclosure details the portions of the invention and their novel utility to enable commercial use for Additive Manufacturing of 3D CAD Models utilizing the Digital MES portion apart from the Made-To-Order part such that the Digital MES portion provides commercial utility apart from the Made-To-Order part of the invention.

### Digital Manufacturing Enterprise System

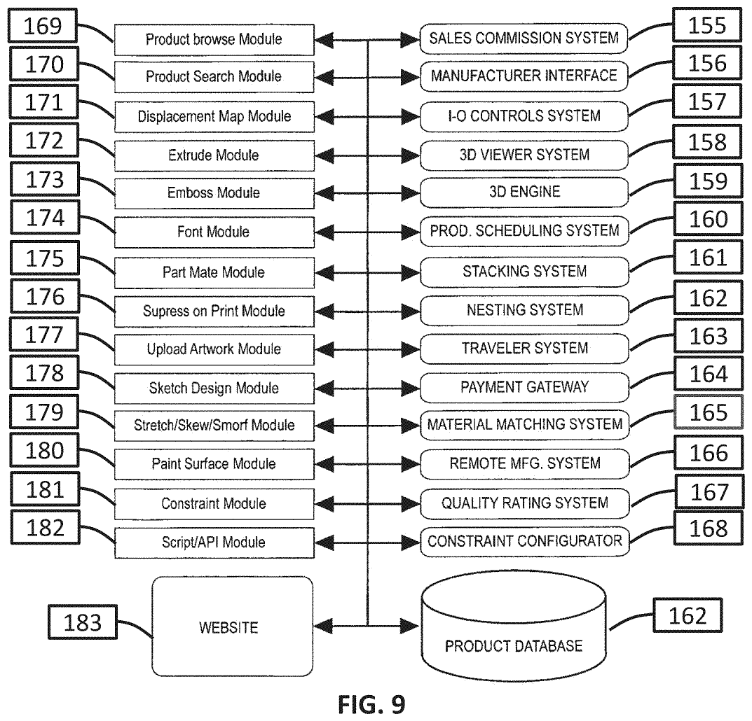

In one embodiment the Digital MES portion of the invention provides commercial utility apart from the Co-Design and ecommerce portions of the invention also called the “Made-To-Order” portion. In such an embodiment the modular controllers as illustrated in FIG. 9 provide the ability to split the functionality. The Digital MES portion of the system is comprised of a manufacturers interface [156] providing a commercial user access to the system through the interface. The system provides modular controllers for processing the 3D CAD models including a production scheduling system controller [160], modular controllers for stacking [161] and nesting [162] operations of 3D CAD model geometry for creating packed arrangements of 3D CAD Models and compiling them into tray files, a digital traveler system [163], a material matching system [165], a remote manufacturing system [166], a quality rating system [167] and a Scripting/API module system [182] enabling 3^{rd} party commercial integration with the system. The interface and system functionality are arranged to enable the commercial user to configure the Digital MES Portion of the system to carry out the processing steps performed by the system.

In one embodiment the Digital MES portions of the invention providing a commercial user with a Manufacturers interface [156], enables the commercial user to input of system operating criteria including 3D Printer device parameters and capabilities [141], receiving and storing both local and remotely located production facility information [142], receiving instructions for defining processing and or calculating requirements by FEA for material stresses [153], receiving facility and equipment capacity instructions, materials and other production criteria [254], receiving operating parameters for the nesting system [264], receiving operating parameters for the stacking system [265], receiving operating parameters for the digital traveler system [285], receiving operating parameters for the material matching system [290], receiving operating parameters for the remote manufacturing system [295], receiving quality information from prior customers in order to establish work quality ratings within the system [300] and other parameters for operation.

In one embodiment, the types of information the system may receive from the commercial user may include, 3D printer device profile information that comprise, 3D printing materials producible by each device, the printable area or bounding box of each printer device, the quantity of identical the 3D Printer devices and where the profile represents at least one production resource available to the Digital MES and its processing steps and capabilities.

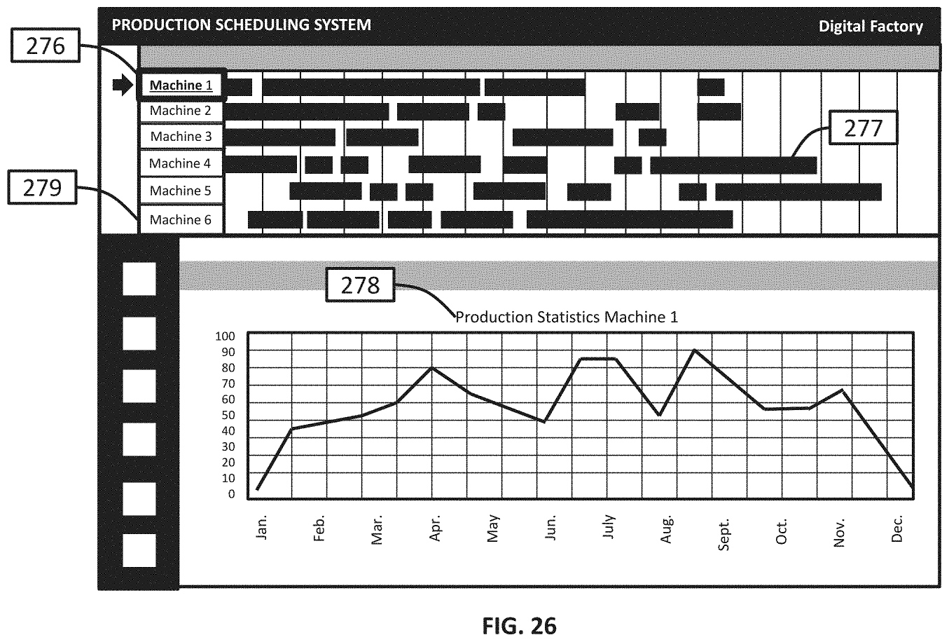

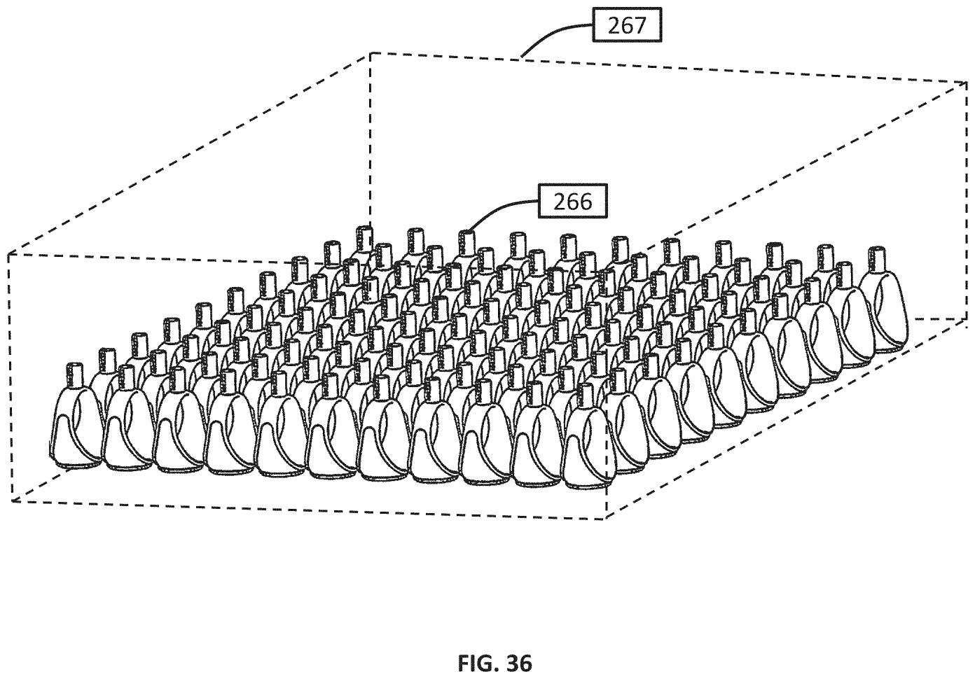

In one embodiment, the Digital MES additionally includes a production scheduling system [306]. The production scheduling system is comprised of a modular controller [160] comprising computer programming arranged to control general computing hardware in the production scheduling of 3D CAD Models. The production scheduling subsystem comprises an interface as illustrated in FIG. 26. The production scheduling system utilizes the 3D printer devices indexed within the system as production resources for scheduling operations [276] of nested batches of 3D CAD Model files as demonstrated in FIG. 36. The nested batches of 3D CAD Model geometry are comprised of discrete 3D CAD Model geometry [266] representing orders within the system and fitting with the bounding box or build envelope [267] of a 3D Printing device representing a production resource within the system and scheduled according to the production scheduling criteria and assigned to a production resource [276] by the system. Each nested “tray file” is generated by the system, utilizing the stacking module [161] and nesting module [162] to pack and generate the tray files.

In one embodiment, tray files, prepared by the system, and comprising nested batches of 3D CAD Models, as demonstrated in FIG. 36, are displayed on the timetable within the production scheduling interface as bars [277] on the timeline of each Additive Manufacturing Device [276] indexed as a production resource within the system. The production scheduling functionality performed by the system is adapted to perform scheduling activity in a manner particularly useful for additive manufacturing.

In one embodiment, the production scheduling system may additionally provide production statistics [278] for each indexed production resource according to production scheduling concepts understood by one skilled in the art.

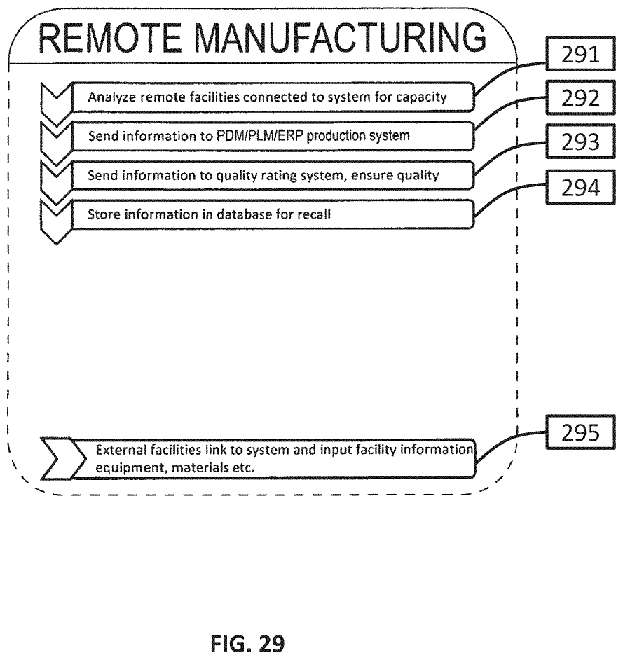

In one embodiment, the Production scheduling system may additionally be supported by a remote manufacturing subsystem [166]. The remote manufacturing subsystem is responsible for enabling remote production facilities to interface with the Digital MES and enabling each remote production facility, operating fleets of additive manufacturing machines to create a profile within the system. The profile enables the additional commercial user to input facility production resource information like the first commercial user, including production resources that are indexed within the system [295]. The remote manufacturing facilities indexed production resources are made available to the production system by the processing steps of the remote manufacturing subsystem in FIG. 29. The Remote Manufacturing system analyzes remote facility capacity capability [291] and makes the available production resource information available to the production scheduling system [292] for determining and using available remote production resources for fulfillment of orders. The remote facilities representing geospatially located production resources available to the system.

In one embodiment, the remote manufacturing system may additionally process the remote manufacturing resource information utilizing a quality rating subsystem [167] where the quality rating system receives the remote facility information for consideration of using the remote facility for production [293] and stores such information within a database for recall by the production system [294].

In another embodiment, a quality rating subsystem [167] may receive information from a remote manufacturing subsystem [296] and process the request by analyzing past quality for the remote production facility [297] utilizing a DMS or Distributed Manufacturing score to determine if the remote facility may receive the order and making the results available to the production scheduling system controller. The quality rating system may additionally store quality rating information for recall by the system and additionally, enables the system to receive quality rating information from customer users based on previous work history in order to establish a quality rating within the system [300]. I such an embodiment, the Quality Rating system allows data regarding objective reputation characterization to become the basis for future automated or semi-automated transactions in the distributed manufacturing (remote manufacturing) selection of the system. In such an embodiment, the quality rating system enables, encourages, and monitors quality ratings and reviews of production facilities participating in the distributed production operations of the Digital MES.

In one embodiment, the quality rating system enables the commercial user to set “levels” to which a particular remote or distributed Manufacturing facility or supplier may receive orders from the system. As such the embodiment provides a means for building trust between many companies using the method and system of a Digital MES. In such an embodiment, the system provides a means for the commercial user to establish feedback criteria categories such that the categories represent various parameters relative to manufacturing such as on-time delivery rating, quality of product, defects found after receipt, on-time payment, canceled orders due to late discovery of production issues and other types of useful information. Ratings left by 3rd party users within the system regarding past performance are used by the system to create a numerical scale called the DMS score.

In one embodiment, the DMS rating generated will provide a weighted average based on time of old jobs and newer jobs so that the quality of work from each company on the system can be weighted against the quality of their work recently. Poor performance on recent work carries a higher weight than good performance historically. Likewise, good performance recently will help provide a more positive score than poor work that is very old. In this embodiment, canceled orders shall be represented as several times a particular company using the system has canceled an order or failed to pay for an order. The overall method and spirit of the embodiment provides a method to enhance quality and customer satisfaction in a Digital MES distributed manufacturing method performed by the system.

In one embodiment, the Digital MES may additionally comprise a material matching subsystem [165]. In such an embodiment, the subsystem provides organizing capabilities to the Digital MES portion of the system [312]. The system receives a request to analyze design intent for the product comprising the material. The subsystem then queries and generates a list of production resources indexed within the system matching the printer device meeting the material requirements specified in the order production criteria [287]. As a result of the analysis, the material matching system module may make the selection list of production resources available to the production scheduling system [188] for the purpose of organizing 3D CAD model files within the order aggregation system into subset groups of 3D CAD models according to the material required to meet the design intent. Additionally, the material matching system enables the commercial user to input and correlate materials to design intent for products and materials. In this manner, the system is capable of dividing aggregated orders into subgroup aggregations or “batches” of CAD Model files according to material specification for each 3D CAD Model file representing production jobs within the system.

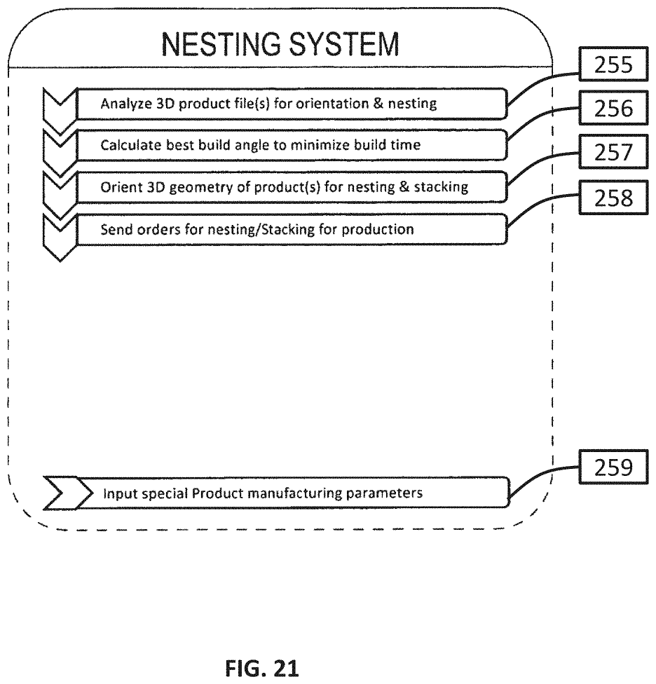

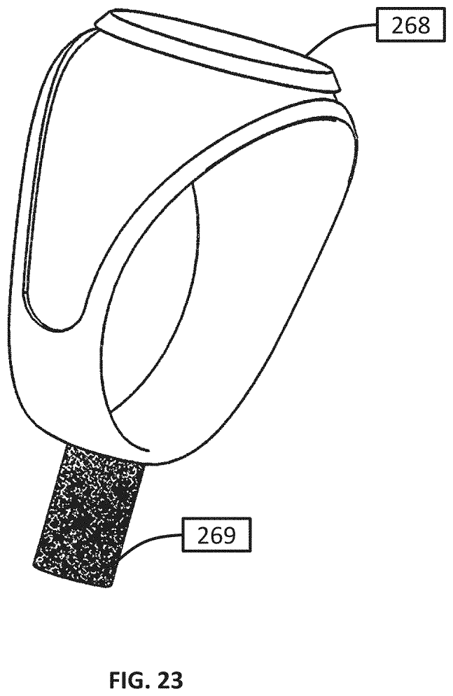

In another embodiment, the Digital MES portion of the system includes modular controllers for generating nested “tray” files of 3D CAD model file geometry fitting within the printable area or bounding box of 3D Printing devices defined by a commercial user and indexed within the system. The “tray” files are comprised of tightly “packed” arrangements of 3D CAD Model geometry as demonstrated in FIG. 23. The operation of the “packing” is performed by subsystems including a Staking system [162] and nesting system [163]. The stacking system and nesting system work collaboratively to receive, process analyze and re-orient and arrange 3D CAD model files to optimize the printing process by tightly packing nested arrangements within a bounding box or printable area. The performance of the operation is provided by and outlined by the processing steps of the Nesting system in FIG. 21 including receiving a request to process and analyze a 3D CAD model file [255], causing the nesting system to parse the 3D CAD Model file using one or more 3D CAD Kernels available to the system in order to obtain the geometry and size of the 3D CAD Model file. The nesting system then performs a calculation to compute the optimum build orientation of the 3D CAD model geometry that will result in minimizing the print time and or maximizing printer utilization and then re-orients the geometry of the 3D CAD Model according to the angle determined by the processing steps [258] for staking and nesting and then makes the re-oriented geometry data available to the staking system for further processing [258]. The subsystem additionally provides commercial user input for defining production manufacturing parameters for the operation of the nesting system [259]. In conjunction with the nesting system, the stacking system [161] performs processing steps including receiving the re-oriented 3D CAD Model geometry [260] from the nesting system for production [260] and adds the 3D CAD model geometry representing the order as needed to maximizing production capacity of the selected 3D Printer device meeting the production criteria of the order and fitting the geometry of the 3D CD Model matching the order within the printable area or bounding box the printer device [261] and continues to add 3D CAD Models until the build envelope is full or reaching a preset limit [262] based on commercial user input [265]. The stacking system additionally “writes” a computer file called a “build tray” file to the system for production [264]. The build tray files represent nested or packed arrangements of 3D CAD model files intended for production by a printing device meeting the production criteria for each model in the nested batch. Therefore, each tray file is also a batched arrangement of many 3D CAD Models intended to be produced by a single machine in a single print job according to the production timetable.

The problem of nesting for an Additive Manufacturing system is based on the number of 3D CAD Models that will fit within the bounding box or build area of the Additive Manufacturing Device selected for production. The invention electronically performs this process by analyzing the geometry of the CAD Models, computing the best build angle to minimize the build time of the queued jobs and based on the analysis results, the system then re-orients the geometry of the 3D CAD Models. The system then electronically positions the re-oriented 3D CAD Model geometry within the virtual build envelope and repeating the process until the build envelope is full or the system reaches a preset limit set by a user (a constraint). When the subroutine is completed, the now fully nested “tray” file is written to the system as a Build File for production and placed into a production queue. The output build file containing the nested geometry of the CAD 3D Models from the batch such that the output file can then be transferred to (assigned to) a 3D Printer Device (queued) to produce the entre batch as a single operation. The purpose of this functionality it to determine and optimize utilization of the production resources indexed with and available to the production scheduling system.

In one embodiment, the stacking [161] and nesting [162] systems are regulated and controlled by input of special needs and production parameters defining the nesting operation [259] and stacking system [265]. In practice the build envelope is based on data received by the system defining the Additive Manufacturing equipment's available print area or bounding box also defined in the system [254]. In the Digital MES System the nesting operation [308] works in conjunction with a Stacking operation [307] collaboratively responsible for the task of arranging a batch of 3D CAD Models submitted to the system by analyzing and then generating a nesting solution for a batch from the total aggregated jobs in the queue. The Nesting or packing operation is therefore automatically combining many 3D CAD Model geometries within the virtual bounding box area of 3D printer(s). The automation of the system is a substantial leap forward over manually nesting 3D CAD Models. Prior solutions required a human to manually select, locate and orient each 3D Model in the virtual build envelope.

In one embodiment, the nesting and stacking system utilizes one or more CAD Kernels or “engines” [305] to parse each 3D CAD model file, determine its size and orientation and compute an optimal build orientation that allows more 3D Models to be nested for production within the build envelope of an additive manufacturing device. The kernel(s) arranged to perform the analysis and perform the re-orientation of the geometry. Of course, many various CAD Kernels are available as previously described and may be used to perform these tasks.

In one embodiment, the result is that the system “packs” the batch of models into a single file prepared for fabrication. The tray files are then assigned to machine queues which represent production resources where they are scheduled for production utilizing the selected machine and where the selected machine, having been chosen, by the system based on the machines capabilities as defined previously by the commercial user within the system utilizing the commercial user interface to provide the input by the commercial user of the system. In this manner the files are prepared for fabrication on one or more production resources meeting the production criteria. The production Scheduling subsystem utilizes estimated times to fabricate the batch being determined by the production criteria defined in the system for the machine. This criterion may include the Z-axis build rate per unit time or other methods. In this manner, a production schedule slot may be determined or estimated because the time to print the batch is known because of the production criteria defined by the user in the system for the printer.

In one embodiment, the nesting and stacking subsystems for packing tray files may be used in conjunction with the production scheduling system to generate nested build files comprised of batches of 3D CAD model geometry and assign the nested and packed batches to the production queue of one or more machines available to the system. In this manner, the system establishes a production schedule for when the next batch or tray file may be processed after the current batch completes and in doing so dynamically generates a production schedule.

In another embodiment, stacking and nesting subsystems may “pack” the batches as a stand-alone subsystem offering commercial utility as such a subsystem. In such an embodiment, the “nesting” subsystem may additionally make the 3D CAD model “tray” files directly downloaded able from the system by a commercial user for use in an AM printer. In such a deployment, the operation of the system may be used in conjunction with an Application programming interface (API) to transfer a batch of files to the system, enabling the system to “pack” or “nest” the batch and then return the nested tray file now containing the batch to the remote system utilizing the system and system requesting the operation. In such an embodiment, the system may additionally provide n web-based interface for the operation of uploading and downloading the batch to be nested and the nested or packed batches respectively. In all cases the system is a commercial application particularly useful for additive manufacturing at scale and provides commercial utility alone and or in conjunction with other modular systems outlined herein.

In one embodiment, the Digital MES system is dynamically and automatically packing 3D CAD Models representing products, including nesting operations into a batch order that maximizes the production capacity and delivery timeline for the products. In essence, the Digital MES Nesting and stacking system is “packing” the 3D CAD Models together so that a “tray” of unique orders is combined into a file that contains many individual orders such that the available print area on an Additive Fabrication machine is efficiently and completely utilized. Of course, based on order volumes and forecasts, the Digital MES system may decide to limit how many 3D CAD modes it combines into a “tray” of orders to best manage the tradeoff between capacity and delivery time.

In one embodiment, each nested or “packed” tray file has then been prepared by the system for production scheduling on available production resources available to the Digital MES system.

In another embodiment, the Digital MES system deploying the method of the invention may make use of multiple types of Additive manufacturing hardware simultaneously or concurrently to manifest a plurality of components of an assembly that comprise a product that are by design or by desire, necessary to be made of different materials and assembled from the various from components after they are manifested on Additive Manufacturing machines. Examples of this material may include metals of varying natures, plastics or polymers of varying nature, waxes or even composites. Such varying needs require the embodiment of the present invention to encompass the entire gamut of Additive Freeform Fabrication hardware. The system carrying out the invention is therefore routing each 3D CAD model to a different 3D Printer device, by sorting a scheduling each discrete portion of the assembly represented by a 3D CAD model file to different production devices and or locations.

In another embodiment, products may require other Additive Fabrication Hardware depending on the desired mechanical properties of a particular product or part of a product or assembly. For example, a toy may be made of a single or multiple plastic parts or a similar constitution of metal parts. They may also be combinations of dissimilar materials and even dissimilar colors of similar materials. For example, a particular product may be made of an assembly of parts that are each unique both in dimensions and the material they are composed of. For example, a toy car may be made of a blue plastic body, black plastic wheels, a metal axle, and a rubber bumper. To make each part would require a different Additive Freeform Fabrication machine to output each unique product. After manifestation through the Additive Fabrication hardware, the post processing of this example would include assembly of the constituent parts that together comprise the final product. To properly utilize the method of the invention, the system deploying the method would require a method to adequately relay the necessity to distribute the individual or constituent parts of an assembly to an appropriate Additive Fabrication machine for producing the parts in an automatic or semi-automatic methodology.

In another embodiment, the Digital MES system may additionally provide a Digital Traveler system module [163] providing a method for tracking or identifying customer-specific or product specific products which are processed through the subsystem.

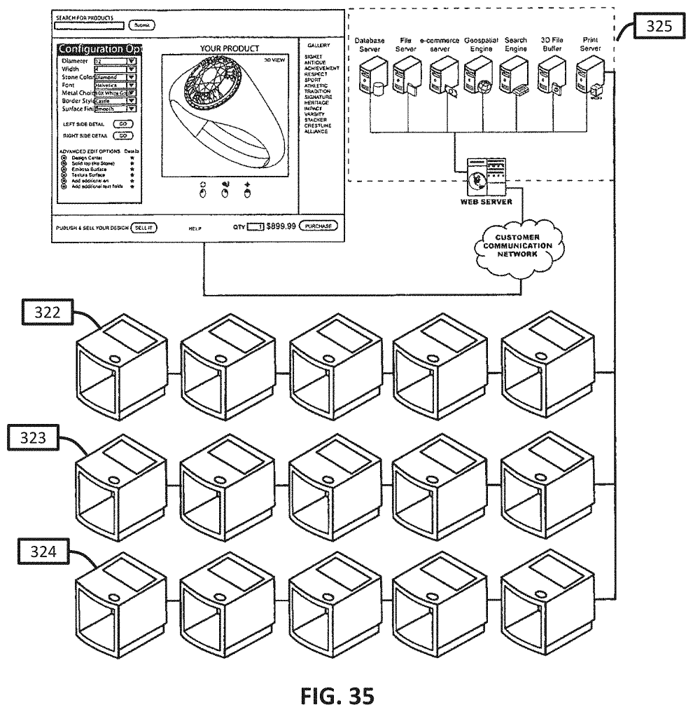

In one embodiment, the Digital Traveler system provides an interface as demonstrated in FIG. 35. The interface, resembles the Co-Design interface and enables the commercial user, using the system, via an interface to select a Digital Traveler function [218] and is presented with a digital traveler definition interface [320] enabling the user to define a digital traveler feature [321] for a base 3D CAD model [319] within the interface. The Digital Traveler system enables the commercial user to define the traveler location, geometry, and information to be conveyed [285] by the commercial user. The digital traveler feature may take many general forms including but not limited to a casting sprue [273], a break-away tab [274] or direct part marking [275].

In one embodiment, the digital traveler system may convert and generate geometry for a traveler feature including traveler data into any type of geometry including but not limited to alphanumeric, hieroglyphic or art and translate or parse the data, barcodes or graphics in such as manner as to make it possible to attach or append the data to a 3D geometry representing a product. The system is further programmed to attach or append the data to a 3D product in an automated fashion wherein the data is parsed and or transposed as 3D geometry directly on a 3D product or part or affix the data to an appendage to the 3D part in such a manner that it becomes a part of the 3D geometry representing a part or product. This appendage or placard is then manifested along with the 3D product as part of the overall geometry of the part and shall become part of the object. The 3D geometry serves the purpose of providing order, lot or other specific data needed to identify the part after manifestation via Additive Manufacturing. In this manner, the Digital Traveler may additionally enable identification of discrete components that collectively describe a product when assembled and enable the identification of these parts as they relate to other components enabling the parts to be batched after production and therefore enable all parts relating to a unique production job to be identified post-production and readily and easily grouped together.

In one embodiment, the processing steps of the digital traveler system are automated in the following manner. The Commercial user accessing the system uploads a 3D CAD Model file intended to be made available from a catalog [280] and representing a product. The user defines the traveler [285] using the interface illustrated in FIG. 35. The commercial user then saves and publishes the 3D CAD Model making it available to be obtained by 3rd parties using the system. Upon placing an order, the traveler system receives a command to process the 3D CAD model for production. The system initiates a command to the traveler system which receives the 3D CAD model file for processing [280]. The traveler system then parses the order or customer unique information and generates the traveler geometry {281] by instructing a 3D CAD Kernel or engine [282] to generate the geometry according to the requirements defined by the traveler [283] and updates the 3D CAD Model file, now containing the traveler geometry and submits the updated 3D CAD model back to the system for additional production processing [284]. In this manner the Digital Traveler system and its processing steps also provide a quality control function that may, for example, prevent mix-up of orders produced in a high velocity/high-mix manufacturing environment.

Therefore, the nature and spirit of the Digital Traveler system is therefore to digitally automate the conveyance of information necessary to identify the order or unique customer to whom a product processed by the system belongs. This may include but not be limited to where to ship the product, how to cross reference the product with a database containing other information. Furthermore the data on the appendage may reflect manufacturer specific data including logos, artwork, text, barcodes, 3D data matrices, batch code, lot number, manufacturer's number, part number, location number, city state or zip code information or other alpha-numeric or other pictorial symbols conveying information that can be mathematically described in a manner that allows the data to be manifested through an Additive Freeform Fabrication process. It should be obvious that the system could be deployed to apply the data described throughout this patent to any product that is manifested via Additive Freeform Fabrication.

The Digital MES portion of the system has now been adequately described to provide processing capabilities in a novel method and arrangement that is particularly useful for receiving and processing 3D CAD Model files and Meta-Data according to production criteria and production scheduling in a manner that is useful for Additive Manufacturing. The processing steps included aggregating 3D CAD model files in an order aggregation device and processing the production requirements for each 3D CAD model file according to the production criteria defined in the meta-data for each 3D CAD model file in order to determine organizing steps for the 3D CAD Model files including sorting the 3D CAD Model files by production criteria including material selection and geographical location for delivery into subset groups of 3D CAD model files based on the production criteria and then arranging the 3D CAD model files into batches of 3D CAD model files and nesting the batches into tightly packed arrangements of multiple 3D CAD Model files fitting within the bounding box or printable area of a production resource. The system additionally compiles the nested or packed tray files into a single computer file containing instructions for causing, at least in part, an additive manufacturing machine to produce the CAD Models in the nested batches of 3D CAD models and scheduling the nested batches of 3D CAD model files on available production resources according to a dynamic production schedule determined by the system according to concepts of production scheduling understood by one skilled in the art.

In one embodiment, the production scheduling system, utilizes organizing criteria for the jobs comprising one or more of; 3D printing materials required for each object, the size of the object to be printed relative to the build envelope of indexed Additive Manufacturing Machines available and or defined in the system, the geospatial location for physical delivery of the object, the quantity of the object to be produced, the quantity of 3D Printers available to the scheduling system, the geospatial location of the 3D Printers available to the system and other capacity constraints defined in the system.

In one embodiment, facilitating the production scheduling requires the computer system to parse data from the 3D CAD Model files, the Meta-Data for the 3D CAD Models, and other production criteria (including materials, location and quantity) and then determine a capacity plan for producing the jobs in the production queue which is comprised of 3D CAD model files. Of course, the production plan is dynamic as all production scheduling systems are dynamic, meaning that the production scheduling is continuously being updated, based on capacity constraints, volume and criteria received by the system. The activities arranged to optimize production workloads between indexed production resources (Additive manufacturing printer devices) available to and indexed within the production scheduling system. The production scheduling system making determinations, based on previously received and indexed information that includes equipment, processes, materials and locations for such facilities having Additive Manufacturing Machines. The production system is therefore, determining a respective capacity plan for each production resource including the location of each production resource to be used for production of each 3D object in the production plan. This includes the location of each production resource to be used, locally and as previously disclosed, optionally, remotely located production resource.

In one embodiment, the Production Scheduling subsystem can be utilized as a stand-alone system much in the same way that the Co-Design system has been described. The production scheduling system is accessed through a website or web portal. The production scheduling system being adapted to process 3D CAD Model data files containing 3D CA Model geometry. The computer system routes a plurality of individual 3D CAD Model files, representing orders through the production scheduling system including properly nesting the 3D models representing the unique orders into a batch order that maximizes the production capacity and delivery timeline e for the products. In essence, the computer system is virtually stacking the products together so that a “tray” of unique orders is combined into a file that contains many individual orders such that the available print area on an Additive Fabrication machine is efficiently and completely utilized. Of course, based on order volumes and forecasts, the system may decide to limit how many units it combines into a “tray” of orders to best manage the trade-off between capacity and delivery time.

### Additional Exemplary Embodiments

In the following additional exemplary embodiment, the Made to Order portion of the invention is operated by a first commercial user and the Digital MES portions of the system and their modular controller subsystems are operated by a second commercial user and together performing the overall Made-To-Order Digital MES method and system.

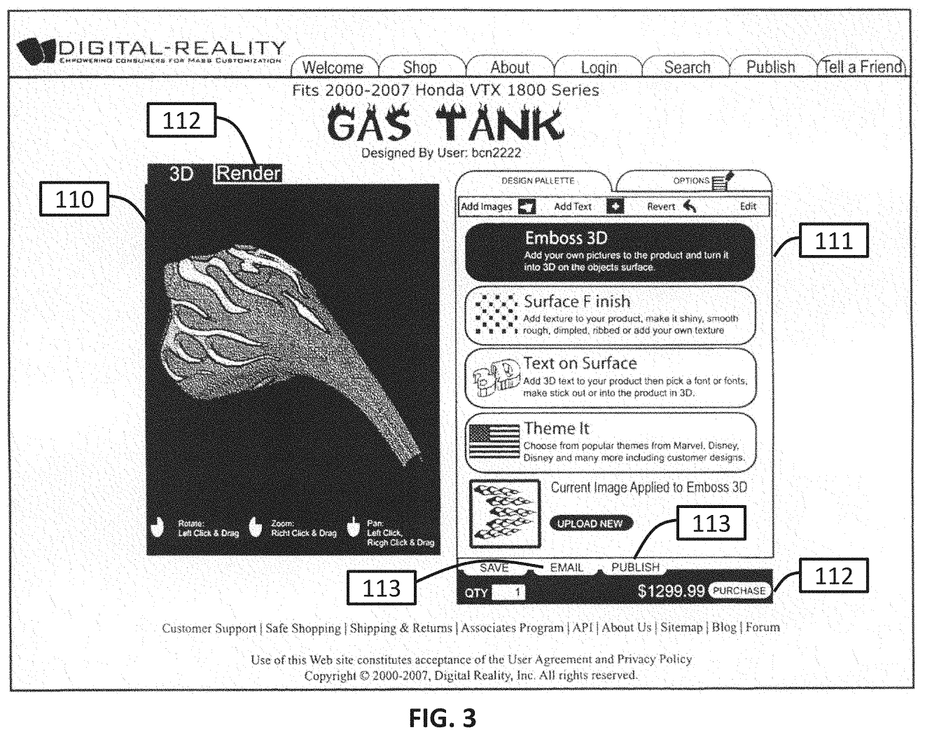

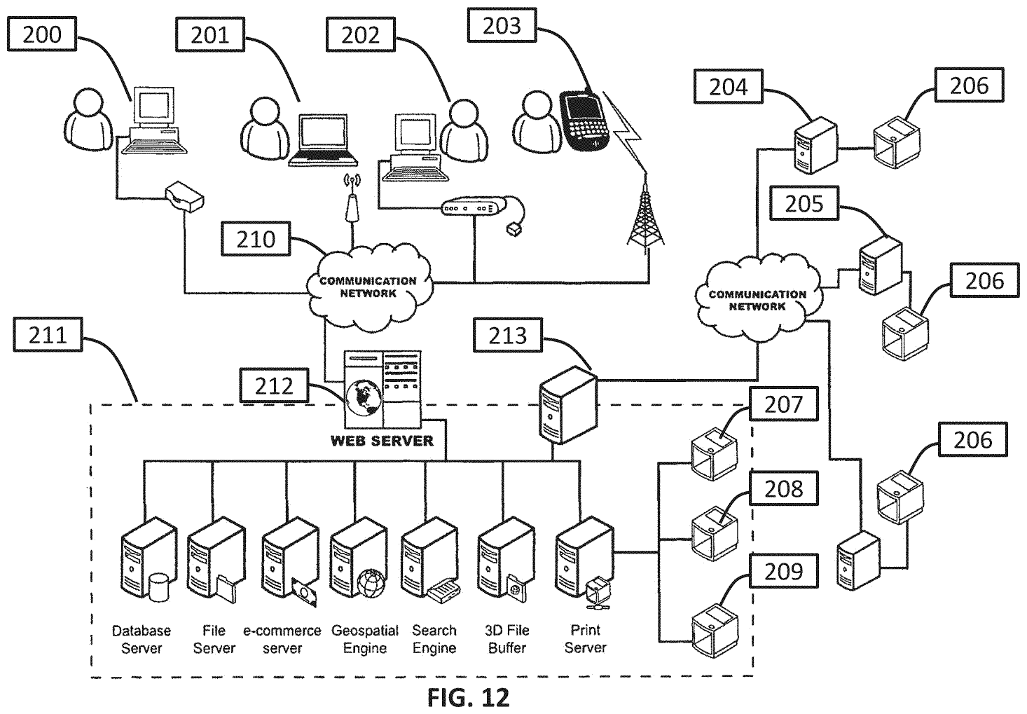

A first commercial user, using the Made-To-Order portion of the modular system to publish an exemplary website on a domain of the commercial user as demonstrated in FIG. 3. The website subsystem [183] provides an electronic commerce interface [238] and enables the Co-design subsystems [214] to provide Customization of products [216] within the first commercial users website. The modular system is deployed on multiple distributed computer servers that are networked as demonstrated in FIG. 11 and comprised of a plurality of modular controllers as demonstrated in FIG. 9. The system enables a plurality of users to access the made-to-order system as demonstrated in FIG. 12 by various means and communication methods.

In one embodiment, the Made-To-Order portion is arranged to generate, compile and transfer 3D CAD Model files and meta-data containing production criteria to a Digital MES system arranged to receive and process such data in a manner particularly useful for Additive Manufacturing.

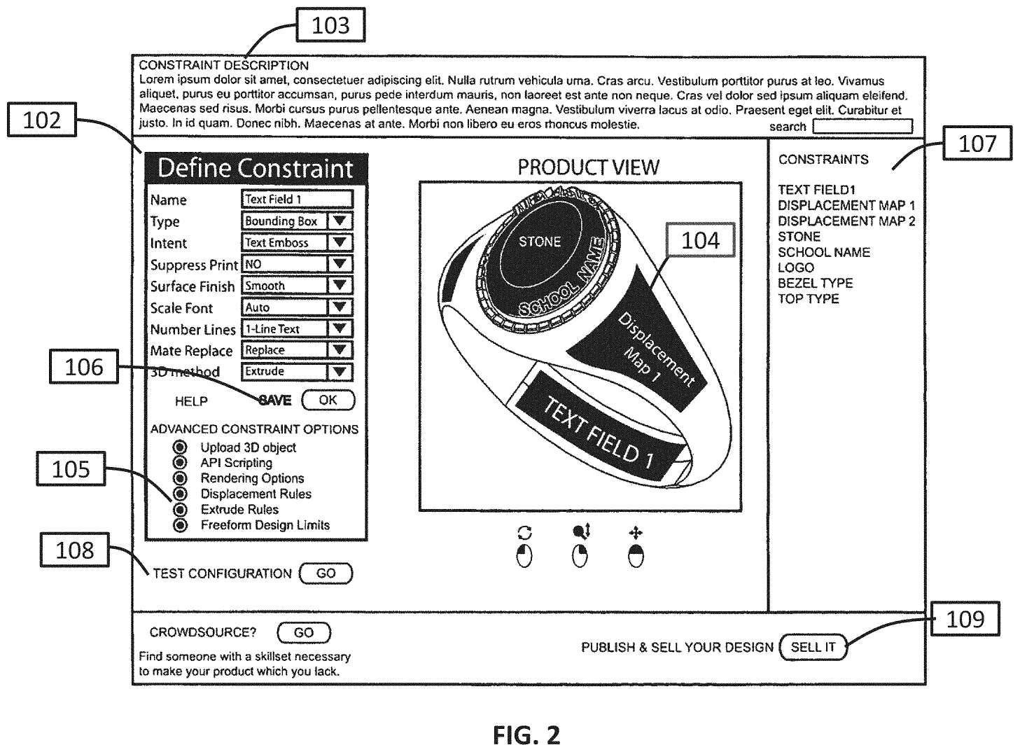

In one embodiment of the exemplary deployment, Made-To-Order system operated by the first commercial user is arranged to receive a selection of a base 3D CAD model from a user using a user device in communication with the system. Upon receiving the base 3D CAD model from the user device, the modular system generates and causes to display on the user device, a Co-Design interface, and a representation of the base 3D CAD Model [104] as demonstrated in FIG. 2. The Co Design interface provided by the Co-Design subsystems enables the user using the Co-Design Interface Input-Output controls system to define co-design constraints [102] representing customization features configurable by a 3rd party user. The user can publish and sell the design within the system [109] and the system enables making the design available within a marketplace on a website [315].

In one embodiment, a 3rd party consumer user, using a user device, accesses the website of the first commercial user publishing the catalog of 3D CAD models within the electronic marketplace. The 3rd party user searches [170] and or browses [169] and selects one or more products available within the system and represented by at least one 3D CAD Model stored within and available from the system [162]. The system causes to display, at least in part, on the user device, a web page [183] containing information enabling the user to acquire the product [112] within an interface exemplified in FIG. 3 an additionally providing the interface of the Co-Design subsystem [111]. In this case, the base product is a Motorcycle gas tank [110]. The interface provides controls for editing any co-design constraints previously configured by the commercial user [111] or 3rd party user adding content to the system and Configuring Co-Design constraints [102]. The customization feature tools displayed to the consumer user on the website are based on the co-design features [102] such that not all co-design tools are loaded unless the product has a feature requiring any particular co-design function from the Co-Design subsystem since the Co-Design subsystem is comprised of other subsystem modules such as an extrude command [172] or an emboss command [173]. The 3rd party user is enabled to configure the pre-defined co-design constraints by selecting and inputting values within the website page [183] that are converted to geometry changes to the base 3D CAD model by the various subsystems and a 3D CAD Kernel or engine [159]. Of course, to one skilled in the art of ecommerce, a user may also purchase a product as-is without customization selections, even if presented with such options. Likewise, the user may elect to not configure co-design features and simple publish the design in the site. As such the Co-Design subsystem would not display customization options to the 3rd party acquiring the product within the website.

In one embodiment, when the 3rd party user requests to obtain the product [112] represented by the 3D CAD Model [110], the Made-To-Order portions of the system initiates a process to compile the Co-Designed 3D CAD model file into a final 3D CAD Model file and initiate a route for manufacturing subroutine [127] causing the Made-To-Order system to transfer or transmits the finalized CAD Model file and meta-data representing production criteria to an order aggregation device arranged to receive and aggregate 3D CAD models [135] representing orders for the product represented by the 3D CAD Model [137].

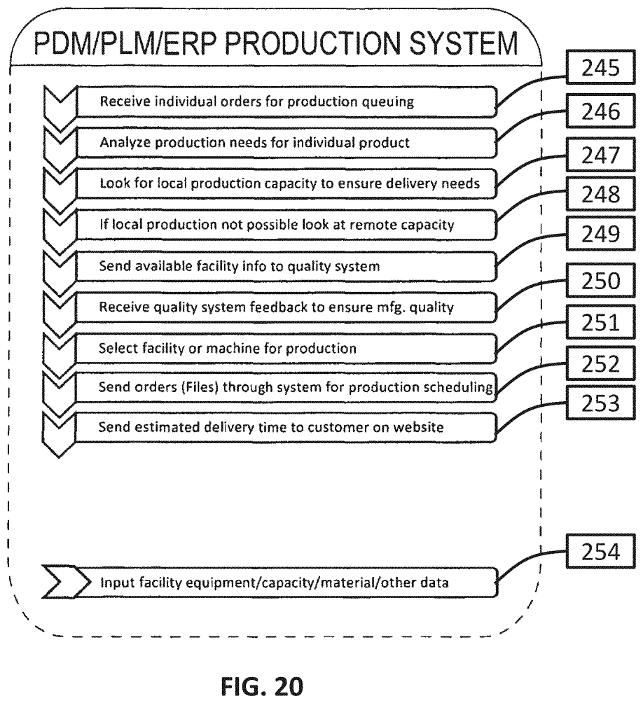

In one embodiment, the Digital MES portion of the system is operated by the second commercial user and arranged to receive 3D CAD Model files in an order aggregation device associated with the Digital MES and the corresponding production criteria meta-data [139]. The Digital MES system initiates a process for manufacturing subroutine [312]. The receipt, by the system initiates and causes a series of processing steps to occur which are conducted on both the production data and the 3D CAD model file data itself by the modular controllers of the Digital MES portions of the System as demonstrated in FIG. 20. The processing steps include submitting a request to the production system causing the production subsystem to initiate a series of processing steps including analyzing the production criteria of the product [246]. This includes a material matching subroutine as demonstrated in FIG. 29. The material matching subroutine is provided by the material matching modular controller [165] which matches a production jobs material requirements to production indexed resources capable of meeting the production specifications for the production job [287] by parsing the production criteria and 3D CAD model file geometry to determine the production requirements for the 3D CAD Model and providing the information to the production system controller [288]. Another step is the analysis of the production criteria [246] is the analysis of the 3D CAD Model geometry, by the system to ensure that the system distributes the various production jobs to the appropriate machines depending on defined parameters including the maximum printable size, print speed or throughput (Capacity) of equipment defined in the system. This information is used by the production system controller to determine production operation information including orientation and size of the 3D CAD model described in the file. This is accomplished by one or more 3D CAD Kernels associated with the system and the production system controller. The results of the analysis are utilized for downstream processing steps provided by the Digital MES portions of the system.

The downstream processing steps include organizing the 3D CAD Models according to production criteria including determining the material requested or required and geospatial location for physical delivery. The location for physical delivery is a geospatial location on earth received by the system during an e-commerce transaction where the user provides such information to the system and represents meta-data representing a production criterion to the system. This enables the Digital MES to match the location for physical delivery of the product with an indexed production resource when utilizing the remote manufacturing system modular controller [166]. This enables the production system to then determine a capacity plan and organize the production jobs and their corresponding 3D CAD Models into subset groups of 3D CAD models according the production criteria, including the location criteria while the material matching modular controller [165] enables the system to further determine and organize production jobs and their corresponding 3D CAD models into groups according to their material production requirement as demonstrated by FIG. 29. The subset groups of 3D CAD models organized by the system are then routed to and processed by the nesting [162] and stacking [161] modular controller subsystems. The Stacking and nesting systems process the 3D CAD Models in order to “pack” the subset groups of 3D CAD Models into nested arrangements [267] of 3D CAD Model geometry where each 3D CAD Model may represent an individual order [266].

In one embodiment, the sorting of the 3D CAD models to a particular 3D Printing machine, device or facility may additionally comprise production criteria or parameters for each type of 3D Printing device including the maximum size or build envelope, speed or throughput or material science of the particular process utilized by each 3D Printer Device indexed as a production resource within the system. It may also be a customer defined option, utilizing the system, to manifest the product as plastic, metal, or other material as limited only be the available equipment locally. Such a system might also determine to schedule and send the 3D CAD Model representing the product to a distributed facility for manifestation if capacity restrictions or other parameter limits or restricts local production options.

In one embodiment, after determining a respective capacity, a quality rating, and a location from a plurality of indexed manufacturing resources, the modular production scheduling subsystem [160] assigns the nested tray file to an indexed production resource available to and indexed within the system that met the production requirements for the order [276] and may assign other nested tray files to other indexed production machines [279].

In one embodiment, the Digital MES portion of the system may additionally provide part tracking and traceability functions utilizing a digital traveler subsystem modular controller. The Traveler subsystem provides for the generation of part marking information making each order easily identifiable by a human after production operations by additive manufacturing. This feature provides substantial utility in a high mix/high volume enterprise additive manufacturing factory or facility and enables identification of an order after printing. The traveler geometry is appended to the 3D CAD Model before nesting and staking operations so that the added geometry is accounted for during the packing operations performed by the system.

In one embodiment, the traveler geometry is suppressed during view within the browser to the user during the co-design session but generated during production and printing. This is done to not confuse the customer during the design-to-purchase process.

In another embodiment, the Digital MES system may additionally comprise a distributed manufacturing operation. In such a deployment, additional commercial users' access, define profiles within and input production resources available at the remote production facility. In such an embodiment, the system is additionally enabled to consider remote production resources as capacity available to the system for scheduling operations. In this manner, the system may then communicate with a remote order aggregation device and transfer or transmit 3D CAD Models and or nested tray files to a remote production facility arranged to receive and aggregate such information. In this exemplary embodiment, the remote facility fulfills the order by producing the 3D CAD Model file for fulfillment and delivery to the user requesting the product from the system, according to the production criteria received by the system, in this case including the delivery address. The selection of the remote facility to receive and produce the product is made by the processing steps performed by the Digital MES system.

It should now be recognized that the receipt of the 3D CAD Model by the system does not require a co-design of a 3D CAD Model and merely requires that the system receive a 3D CAD Model file and production criteria in order to perform the various production system and subsystems processing steps and in doing so, all processing steps are performed and result in operations that ‘route” or move virtually, the 3D CAD Model file geometry with the intent of scheduling each 3D CAD Model for production in a dynamic production system in a manner particularly useful for additive manufacturing. As such the Digital MES portion of the system is agnostic to the geometry of the 3D CAD model file data received by the system and will perform the processing steps in the same manner regardless of the Co-Design method or not.

In another embodiment, the Digital MES System additionally provides utilization of encryption methods for the data in the system including for distributed manufacturing of wartime assets to the US military including forward battlefield manufacturing, shipboard manufacturing, or other deployment methods. In this methodology, the Digital MES provides an on-demand distributed manufacturing system for the United States Military. The encryption and digital distribution of Digital Manufacturing assets for the US Military is a highly advantageous technology. Coupled with the Digital Traveler methodology of the system, it enables the automatic, on-demand distributed manufacturing of military assets complete with part markings for traceability and serialization.

In another embodiment the Digital MES includes, and an API or application programming interface enabling 3rd party integrators to devise and submit 3D CAD Model files and production criteria to the system.

In another embodiment, utilizing a computerized approach to intelligent adaptive thermal compensation of part geometry, the system accommodates and processes the coefficients of thermal expansion and desired end part dimensions, the system can eliminate the need for designers to consider thermal properties from the design cycle by placing the burden on computerized processing. Utilizing one or more 3D CAD Kernels and additional parameters and constraints, the system can “simulate” the thermal expansion or shrinkage of the part being analyzed. In this manner it may “compensate” for process variables to ensure a better part fit, prevent warping, or predict shrinkage of a part based on consolidation and burnout of binding materials.

In another embodiment, the Digital MES may utilize a computerized approach to intelligent adaptive geometry generation performed utilizing Finite Element Analysis methodology to predict geometry performance to given loads in a given material by means of one or more approaches to design utilizing one or 3D CAD Kernels and as a result, modifying the geometry of the base 3D CAD Model adaptively. In such an embodiment, the utility is apparent, for example, in Battlefield Forward Manufacturing of replacement parts for the military. In such an environment, the Military employs Mobile Parts Hospitals to manufacture replacements components on-the-spot. When inexperienced personnel attempt to create usable parts for combat replacement in the field and installation at Forward Repair Areas, they manufacture apart from an available material that does not have the same performance characteristics as the original material. This can lead to an unintended consequence. Although the original part may be scanned or measured and then machined or printed on-site, the material may be inferior. A field failure during combat could result in objective failure or loss of life. Since the forward Manufacturing center (mobile Parts Hospital) likely lack engineers to perform finite element analysis (a level of expertise requiring specialized training or an engineering degree) to determine if the part will adequately withstand the stresses encountered during use in a different material, another method must be found.

In another embodiment, the Digital MES may provide additive Manufacturing process technology for net-shape battery production utilizing Voxel modeling which is a process that describes heterogeneous product composition. When Voxel modeling is coupled with multi-jet additive modeling technology, it becomes possible to directly manufacture batteries, complete with casing in shapes that maximize capacity in constrained spaces. One practical application of this concept is a power source for non-lethal weapons technology being developed by Peter Bitar in an SBIR funded DOD program through Extreme Alternative Defense Systems Ltd. Using batteries “printed” with their own encapsulation and conducting elements, the entire weapon body could become an energy storage device with cavities built-in for electronics and other necessary hardware. EXADS current Close Quarters unit prototype weapon requires a separate power source roughly the size of a suitcase. Highly efficient dense energy systems including Li-Poly batteries or fuel cells may be producible using RM technology.

In another embodiment, the Digital Traveler system has commercial utility as a stand-alone system or module. The Digital Traveler system may provide a user interface for configuring the digital traveler feature to pre-existing base 3D CAD Models. Then, upon production by AM, the desired information that was previously defined is converted into 3D Geometry in the desired configuration and produced along with the actual geometry by the Additive Manufacturing device. The result is identification markings for each part, in each build envelope on each 3D Printer device regardless of the final customer obtaining the part. The Digital Traveler therefore is used to convert required/desired information into physical form.

In another embodiment, the Made-To-Order and or Digital MES may provide for 3D CAD Model file retrieval from an Enterprise Product Data Management and or Product Lifecycle Management system. In this embodiment, the system enables the retrieval of the revision-controlled CAD model data from the system by creating a cop of the 3D CAD Model file and submitting it to one or more order aggregation devices.

In one embodiment, each modular controller may be coupled to the remaining portions of the entire system by means of an application programming interface.

In another embodiment, multiple commercial users may deploy and utilize multiple installations of the Digital MES portion of the invention. This is possible and enabled because the invention is a commercial software system. In such an embodiment, each discrete location in this distributed manufacturing embodiment represents a node having production criteria including the materials, machines and capabilities at each node and stored in each locations deployment of the system. The systems or nodes are interconnected by the remote manufacturing system and therefore share the information about each facilities production capability with other nodes and therefore creating a distributed ledger of Production resources and capacity in a distributed network, much like DARPANET. In such an embodiment, a node using the Digital MES receives the 3D CAD Model and generates a build file. Digital Factory node then uses its ledger to determine a local or remote machine meeting production criterion and routes the file to the local or remote machine/node.

In one embodiment, the Digital MES provides a completely flexible and scalable production operation as demonstrated in FIG. 36. Capacity within the system is expanded by purchasing additional Additive Manufacturing hardware [322] or [323] or [324] and indexing the production capabilities of the new printing device in the system. Adding more hardware to the system may not include purchase if the deployment model takes advantage or distributed networking, the internet and available remote production facilities having hardware available and coupled to the system as illustrated in FIG. 12. Remote production facilities are each arranged to access and use the system and have order aggregation devices attached to their remote facility [204] and having AM machines [206] representing production resources and where the local instance of the Digital MES [211] may also have local AM machines [207] or [208] or [209] and representing local production resources available to the production scheduling controller.

In one embodiment, each 3D Printing Device indexed in the system has unique features and specifications including a build envelope, a material it can print, a process type, a print speed, or other parameters.

As demonstrated herein the embodiment of the Digital MES and its various modular subsystem controllers adapt and apply the concepts known to one skilled in the art of industrial engineering and manufacturing engineering of production scheduling and organizing activities applied to 3D CAD models, treating the 3D CAD models as the object being routed and scheduled by the system processing steps and thus providing a novel approach to enterprise-scale or industrial-scale Additive Manufacturing workflow management in an automated or semi-automated computerized Digital MES enabling a commercial user to deploy such a system. In this manner, the invention provides

In the following exemplary embodiment, the website [313], e-commerce system and the Digital MES portions of the system and modular controller subsystems are utilized by a commercial user selling and manufacturing replacement antique car parts.

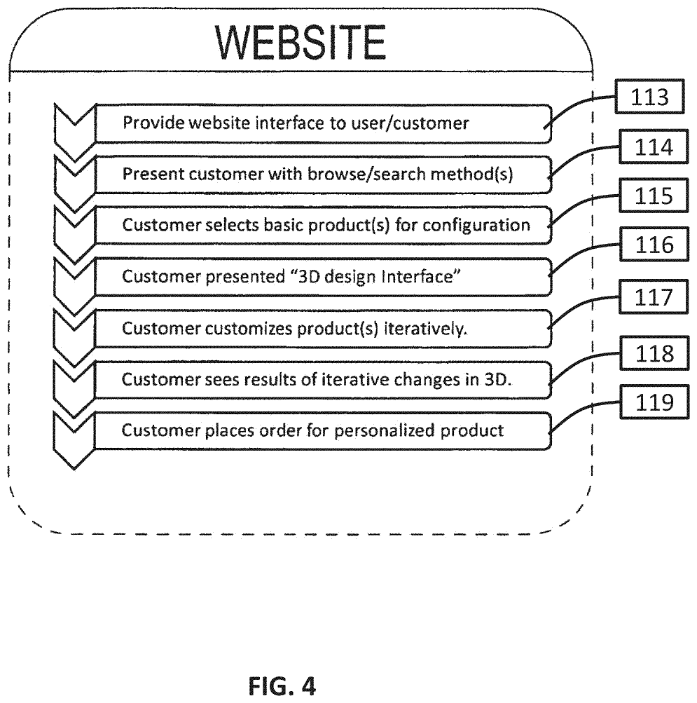

A commercial user uses a website e-commerce system as demonstrated in FIG. 4, adapted to retrieve copies of 3D CAD models representing products from a PDM/PLM system. The commercial user publishes the e-commerce website on the commercial user's website domain. The website subsystem provides the electronic commerce system [313] and enables 3rd party users to obtain the products available for sale within the website which are produced, at least in part by the processing of the Digital MES system and Additive Manufacturing machines.

in such an embodiment, the commercial user ensures that the PDM/PLM system contains the 3D CAD Models of the parts and products representing the antique car parts or products. For example, a 1957 Chevrolet Hood Bullet, which is chrome-plated, cast metal. Such products are hard to find and the sales of such products are infrequent. Therefore, maintaining inventory is a significant challenge to serve low volume parts infrequently however, the current invention makes such opportunistic sales much easier since the inventory is merely 3D CAD Models and production criteria for the 3D CAD models.

A 3rd party consumer user using a computing device accesses the website catalog of the commercial user and is presented with the catalog of products represented by the 3D CAD Models stored in the PDM/PLM system or in fact any database or file system. The 3rd party user browses and selects the product from the online catalog and subsequently requests to obtain the product. This request triggers a process for manufacturing subroutine [127] which results in a copy of the 3D CAD Model(s) representing the product to be generated, and associated with production criteria for the 3D CAD Model and transfers (routes) the 3D CAD Model(s) and meta-data containing production criteria for the 3D CAD model to a computing device arranged to provide an order aggregation device and the operations of the Digital MES Portions of the system as a workflow management system for Additive Manufacturing. In this exemplary embodiment, Additive Manufacturing workflow management system is operated by a 3rd party commercial user having production resources available and meeting the requirements of the 1st commercial user and representing production capacity.

The 3rd party commercial users Digital MES having received the 3D CAD Model file in an order aggregation device and corresponding production criteria meta-data [139], causes the Digital MES to initiate a process for manufacturing subroutine [312]. The receipt, by the system initiates and causes a series of processing steps to occur which are conducted on both the production data and the 3D CAD model file data itself by the modular controllers of the Digital MES portions of the System.

In such an embodiment, the system may be accessed simultaneously by many 3rd party consumer users and requesting to obtain a plurality of different products represented by a plurality of different 3D CAD Models within the system. Each 3rd party consumer user requests to obtain a different product from the plurality. Each request causes a similar processing step to generate a copy of the 3D CAD Model file data and associated production criteria and transfer (route) the respective 3D CAD Models and production criteria to the order aggregation device of the Additive Manufacturing Workflow Management system.

The receipt of the plurality of 3D CAD Models and corresponding production criteria causes the Additive Manufacturing workflow management system to convert each received 3D CAD Model and production criteria into production jobs and then initiates a series of processing steps including analyzing the production criteria of the 3D CAD Model [246]. This includes a material matching subroutine as demonstrated in FIG. 29. The material matching subroutine is provided by the material matching modular controller [165] which matches a production jobs material requirements to indexed production resources capable of meeting the production specifications for the production job [287] by parsing the production criteria and 3D CAD model file geometry to determine the production requirements for the 3D CAD Model and providing the information to the production system controller [288]. Another step is the analysis of the production criteria [246] is the analysis of the 3D CAD Model geometry, by the system to ensure that the system distributes the various production jobs to the appropriate machines depending on defined parameters including the maximum printable size, print speed or throughput (Capacity) of equipment defined in the system. This information is used by the production system controller to determine production operation information including orientation and size of the 3D CAD model described in the file. This is accomplished by one or more 3D CAD Kernels associated with the Additive Manufacturing workflow management system controller.

In the exemplary embodiment offering antique car parts, the AM workflow management system determines at least one respective organization plan for the 3D CAD Models representing products based on at least one production criteria for each 3D CAD model file and system indexed capacity resources and constraints. The AM workflow management system then organizes the 3D CAD Models according to the organization plan and transfers (route), by the workflow management system, subset groups of 3D CAD models in the order aggregation device to a controller arranged to receive the subset groups of 3D CAD Models for nesting and stacking operations (Packing) and generating tray files. The nesting and stacking controller receive batches (subset groups) of 3D CAD Model files and production criteria for each batch and determines a packing plan that optimizes utilization of a the printable area or bounding box of the 3D Printer device meeting the production criteria. The nesting and stacking system controller them compiles the optimized arrangement into a tray file containing the data describing the geometry of the batch of 3D CAD Models and transfers (routes), the tray files to an Additive Manufacturing Workflow Management system, in a manner also associating the production criteria. The Additive Manufacturing Workflow Management system then assigns each received tray file to an indexed production resource according to the at least one organization plan and then transfers (routes), by the Workflow management system, each tray file to at least one indexed Additive Manufacturing device for production of the geometry contained in the nested tray file. The tray file is used by the Additive Manufacturing device to instruct it to fabricate the batch of geometry described within the tray file, utilizing the instructions provided within the tray file to do so.

In such an exemplary embodiment, the production scheduling controller may provide the means for the commercial user to alter the production schedule using the production scheduling interface by re-arranging the production jobs each comprised of a nested and packed tray file and at least one production criteria.

Additionally, in such an exemplary embodiment, the Digital MES may additionally utilize a Digital Traveler System controller within the workflow operations. In such a manner, the workflow management system enables the 1st commercial user to utilize an interface to establish a digital traveler feature and saves the criteria for the feature for recall. A 3rd party consumer user then selects and requests to obtain a product in the same manner as before however, an additional workflow step occurs wherein the workflow management system submits the 3D CAD Model to the Digital Traveler controller which parses the digital traveler feature criteria and then instructs one or more 3D CAD kernels to convert the digital traveler information criteria to geometry and updates the 3D CAD Model file to additionally contain the Digital Traveler Feature. The system then conducts the remaining workflow steps as demonstrated previously including the nesting and stacking operations for generating the nested or “packed” tray files. And results in the production of geometry containing the traveler feature geometry according to the requirements. This crucial step enables the production shop to easily identify each individual order by the traveler data. This is especially useful in a high-mix production environment where many different parts for man different customers are all produced in nested batches optimizing production resource use.

In one embodiment, the Digital MES Portion of the system may again split into two or more parts, each offering commercial utility and benefit. 1 commercial user uses the Additive Manufacturing Workflow Management system and a 3rd commercial user offers the Nesting and stacking modular controller as a plug-in to the Additive Manufacturing Workflow Management system. Each of these workflow management systems may be operated on remote computing devices and communicatively coupled over the internet, including communicating by means of an API or Application Programming Interface. In this example, the Ecommerce portion delivers 3D CAD Models to the Workflow Management portion which in turn delivers the groups of models to a nesting and stacking system controller which in turn returns nested arrangement tray files to the production and fabrication shop (2nd commercial user). The tray files are produced with the traveler geometry enabling the shop to identify orders and their destination as well as post processing steps. In this case, the chrome plating of a metal part produced by Additive Manufacturing from the 3D CAD Model file. The final product is then shipped to the customer, based on the production criteria which included a shipping address.

### PDM/PLM Integration

Product Data Management and Product Lifecycle Management Systems (PDM/PLM) systems are typically used by organizations where manufacturing data is revision controlled with a revision controlled workflow requiring permission to check out the files, create a new revision and approve the new revision for manufacturing. It is therefore beneficial for Additive Manufacturing systems to enable storage and retrieval from PDM/PLM system to request 3D CAD Models directly from the Prevision controlled DM/PLM system.

In one embodiment, a PDM/PLM system may be incorporated into the workflow of the system as represented in FIG. 20. 3D CAD models stored in the PDM/PLM system represent products or parts that may be obtained using the 3D CAD Model and the workflow of the Digital MES Additive Manufacturing Workflow management system when output by Additive manufacturing. Upon request to obtain a physical product, the system generates a copy of the revision controlled 3D CAD Model data obtained from the PDM/PLM system and transfer or transmits (routes) the copy of the 3D CAD Model file to an order aggregation device for production of the object and where the order aggregation device is associated with the Enterprise Digital Manufacturing Production Workflow management System and is arranged to receive such data [245]. The receipt of the 3D CAD model by the system and or associated meta-data including production criteria causes a process for manufacturing subroutine to be initiated [312]. The subsequent processing steps of the Digital MES portion of the system having been previously described are then accomplished by the modular controllers and subsystems for organizing the 3D CAD models for production. In this manner, the Digital MES provides utility for the commercial user operating Additive Manufacturing Equipment and having PDM/PLM stored product data.

In one embodiment the PDM/PLM integration method is accomplished by means of an API or application programming interface and is arranged to access the PDM/PLM system data and or receive the data utilizing the API.

This workflow as an example has a substantial implication for producing replacement parts for everything from antique cars to washing machines to military hardware. A Company may make available all of its older legacy designs without having to physically store tooling or inventory to meet the demand and instead produce each part on-demand—potentially batched with other on-demand orders to efficiently utilize Additive Manufacturing production resources.

In another embodiment, the current disclosure enables the integration of the production scheduling workflow with enterprise PDM/PLM systems to create utility for at-scale Additive Manufacturing including the efficient production scheduling of the CAD Models into available production resources. In such an embodiment, the system is analyzing at least one of; the CAD Model geometry for size, the material requirements for the production, the location for production, the quantity for production, the production time required for production, the current production schedule, the current delivery schedule, the backlog of current production, local available production resources and remote production resources in order to manage the tradeoff between throughput and delivery time.

In one embodiment, the catalog may be presented to a customer/user that is able to see all revisions of the product. In this manner they may request any revision to be produced to meet the needs of their replacement part for the device at the revision level required. This is because companies often change parts over time as revisions improve the device, but this does not preclude the need for older versions of the parts for older products customers have previously purchase.

In another embodiment, the Digital Factory system may be used in conjunction with PDM/PLM systems AND a Co-Design system. In such an embodiment, the system additionally enables 3D CAD Models stored in the PDM/PLM system to be configured by Co-Design and therefore enables mass customization prior to production.

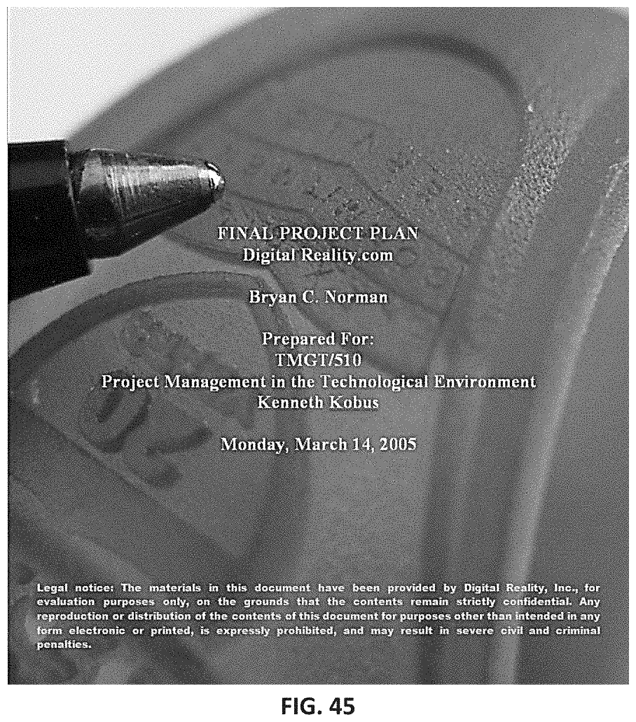

In another embodiment, utilizing the Digital MES, the United States Military can benefit by utilizing the system for combat-deployable flexible manufacturing centers that guarantee production capability in a time of war as exemplified in the SBIR proposal illustrated in FIG. 45. In such an embodiment, the Digital MES may provide an edge manufacturing system for military production where multiple nodes present in the network are comprised of production facilities distributed around the country and or the world. The production resources may also exist on ships and submarines or in aircraft and provide production resources to the Digital MES. Accordingly, the system, having the indexed production resources available to the system may organize the production of the parts required by the military according to a dynamic production scheduling operation.

In one embodiment, the Digital MES Additive Manufacturing Workflow Management system may be deployed in a manner similar to DARPANET or ARPANET and arranged to transfer or transmit (route) 3D CAD Models for production to a destination available as a production resource to the Digital MES Additive Manufacturing Workflow Management system. Since the purpose of packetized data in DARPANET and or ARPANET is to ensure delivery of the data to the destination. The data communication method can be adapted to ensure the delivery of production jobs for military assets in order to manufacture parts utilizing the CAD model data and production criteria. In this manner, the system delivers the 3D CAD model and production criteria to a production resources indexed within the system. In any computer networking system, a ledger is maintained by a computing device or multiple computing devices. The ledger identifies the address to deliver the data to. In networking parlance this is known as an IP Address. As such the networking system can ensure that data is routed to the correct destination. In a military application of such a method, the ledger additionally indexes the production resources that meet the production requirements for a part or products required by the military. As such, A Digital MES Additive Manufacturing Workflow management system may ensure that production is achieved, for military assets by routing the production job to a facility meeting the production requirements. Such a routing method may additionally include a destination that produces or causes the production of the parts and assets utilizing an edge manufacturing node producing the parts as close to the final destination as possible, minimizing lead time for the replacement parts. This method offers a significant strategic military advantage.

In another embodiment, the military deployment methodology of the Digital MES Workflow Management system may include data encryption methods to secure the digital assets routed by the system.

In another embodiment, the military deployment may provide production status updates to the appropriate users and or customers of the system.

In another deployment, the system may, include a Mobile Parts Hospital as a node in the production resource directory within the system ledger. The mobile parts hospital comprising a mobile facility having additive manufacturing equipment capable of being indexed as a node within the system.

In another embodiment, the invention may additionally provide integrated subsystem modular controllers useful to and benefiting the Military deployment model of the system including but not limited to;

Automatic, Physical Realization of an adaptive homogeneous design: This software system provides “adaptive” or morphing of geometry without direct user input applied to 3D CAD Model based on actual engineering part requirements of the physical product.

Digital Traveler part tracking module: This software module provides order tracking and management. The traveler geometry data can be textual, barcode, 2-D data-matrix in either human readable or encrypted formats such as Blockchain and is driven from database information derived from the part numbers and BOMS of the vendor deploying the software.

Digital production scheduling and routing module: This software module provides an extensive suite of automatic production routing and scheduling functionality including intelligent part nesting, automatic adaptable part routing, real-time feedback, estimated production times, system status, in-process order tracking. Electronic submission of job completion notifications and more. This module will adapt many traditional manufacturing supply chain tools in a manner consistent with the concepts of an all-digital production system for additive manufacturing.

Intelligent adaptive thermal compensation: This software module provides adaptive compensation for thermal properties, coefficients of thermal expansion and end part dimensions. The module removes the need for designers to consider thermal properties from the design cycle by placing the burden on the Digital MES.

Intelligent, novel slicing & support methodologies for additive fabrication: This module incorporates adaptive slice geometry manipulation into the Digital MES. It includes novel slicing methodologies to improve production throughput and/or adaptive orientation for surface finish optimization. The module considers feature contours in developing the slice geometries and uses an adaptive or learning fuzzy logic system to improve product output based on design intent.

Automatic adaptive intent-based production Technology matching: This software module incorporates user-defined parameters of available output technologies to select the appropriate AM technology for “optimized” additive fabrication based on design intent. The module also incorporates an adaptive, technology-based “definition engine” that selects and chooses the output technology best meeting the engineered product's needs.

Mass Customization Module: The mass customization subsystem or Co-Design system enables direct military user manipulation of pre-defined flexible design criteria built into a product by a designer. This module opens the door for mass customization or manipulation of products without the need for the user to have the complex knowledge typically required to interact with and influence the design of a product. It includes an extensive suite of API calls into the software to integrate it with other portions of a military's deployment of the Digital MES and production infrastructure.

calls into the software to integrate it with other portions of a military's deployment of the Digital MES and production infrastructure.

Automatic, Physical Realization of an adaptive materially graded heterogeneous or discrete design: This software module adapts the knowledge-based system supporting interoperability between the design tools and an adaptive assembly—engine to create and manipulate materially graded or homogeneous objects or complex assemblies. It also coordinates output activities of complex products and assemblies by automatically routing components of an assembly to an appropriate AM machine indexed within the Digital MES.

Materially Graded Production Module: This software module includes “Voxel” modeling or adaptations or materially graded solid object manufacturing such as parametrically defined materially graded products as opposed to “Voxel” models to define boundaries of graded materials.

Various modules including undefined needs: Many concepts and needs for full deployment of Digital MES for the military are undefined and will be impossible to define without detailed knowledge of military needs.

In another embodiment, the system and its various modules provides practical application of the invention for the military is the Mobile Parts Hospital system run by Todd Richman. According to Todd Grimm, one of the major roadblocks experienced by the MPH program in effectively deploying RP or RM technology is that the average 19-23-year-old lacks the technical knowledge to effectively use the technology presently available in the MPH. It basically requires a highly educated and experienced machinist to make the parts accurately and correctly. Their current technology also still produces a high amount of waste product, requires coolant for CNC equipment and an inventory of bar and block stock material to machine that is not completely flexible.

In one embodiment, the Digital MES provides several of the missing elements to enable the MPH to realize true combat-deployable flexible manufacturing centers that allow young inexperienced personnel to create usable products for combat replacement in the field and installation at Forward Repair Areas. For example: the MPH currently is outfitted with laser scanning technology to reverse engineer a part and build a 3D cad model of the part. The resulting geometry inevitably requires at least some level of editing to guarantee it is accurate. This requires an experienced 3D CAD designer. Also, the part that is reverse engineered will likely be manufactured out of a different material than the original. Therefore, an educated individual must perform finite element analysis to compute if the part will adequately withstand the stress levels encountered in the products intended use. This level of expertise is obtained in specialized training or a college engineering classroom. MTO-RME provides the tools to remove complications such as these from the MPH technician's workload by developing software modules and tools that automate many design elements and manufacturing parameters including adaptive “strength of materials” compensations to automate the guarantee that a part is usable. Finally, the MPH currently uses multi-axis milling machines which are not considered part of rapid manufacturing but instead post processing techniques.

It should now be apparent that the Made-To-Order and or the Digital MES portions of the invention and their various sub modular controllers can provide commercial utility in Additive Manufacturing Workflow Management for virtually any commercial organization including but not limited to business models such as car parts, Antique Car Parts, boats parts boat parts, appliance parts, radio control and hobby parts, promotional advertising products, gun parts, jewelry products or other industries where the product may be described adequately and may be manufacturable, at least in part by additive manufacturing. As such, the Commercial utility of the invention may radically alter the supply chain and manufacturing infrastructure by eliminating inventory and instead rely on On-Demand, distributed or edge-manufacturing where parts and products are produced in-country, as close to the customer as possible and in doing so bypass and or eliminate import & export duties, tariffs, VAT, shipping charges and other concepts related to traditional manufacturing and supply chains. In doing so, it may also provide competitive advantage to small businesses seeking to sell products internationally by providing a production supply chain for their products in the desired country. For example, a US-based jeweler cannot produce a product and ship it to Australia without paying high shipping costs, going through customs, paying import tariff and duties, and forcing the client to experience a long waiting period. As such the commercial jewelry faces obstacles against local merchants producing locally and not having the same obstacles.

In another embodiment, the digital traveler subsystem has stand-alone utility and provides a system enabling commercial opportunities for part tracking and identification in an Additive Manufacturing Workflow system by dynamically generating 3D CAD geometry.

in one embodiment, a Digital Traveler system controller [309] comprised of software programming code [163] arranged and configured to control general computing hardware and having at least one non-transitory computer-readable memory associated with the general computing hardware to receive, from a commercial user using a user device, by the Digital Traveler controller a selection of a base 3D CAD Model file [280], generate, by the Digital Traveler controller, and cause to be displayed, on the commercial user device, an interface [314] for configuring a digital traveler feature and a representation of the base 3D CAD Model geometry, receive, by the Digital Traveler Controller, from the commercial user, using a user device, criteria and configuration data for the digital traveler feature and storing the information for recall [285], receive, by the Digital Traveler controller, a request to generate geometry for a traveler feature for a 3D CAD Model received by the system, during a process for manufacturing subroutine [312], parse, by the Digital Traveler controller [281] both the base 3D CAD model and digital traveler configuration data for the respective 3D CAD model, cause, by the Digital Traveler controller, the Digital Traveler geometry to be generated [282], according to the digital traveler feature configuration [501], transfer or route, by the Digital Traveler subsystem the modified 3D CAD Model or data handling of the CAD Model [284], now containing the digital traveler geometry to an additional subsystem for downstream processing [502], and wherein the additional subsystem may be a stacking [307] and nesting controller [308] for generating nested arrangements of batches [267] of 3D CAD Model files arranged to receive the updated 3D CAD model file for production by Additive Manufacturing and now conveying the additional information as geometry for part tracking and identification.

In another embodiment the method and system is additionally configured to enable a commercial user to communicate with the Digital Traveler controller to establish a user profile or account and to input system performance criteria.

In another embodiment the method and system is additionally configured to perform the Digital Traveler controller functionality in conjunction with at least one of; an electronic commerce system adapted to store, generate and use 3D CAD models for order fulfillment by additive manufacturing, a PDM/PLM system adapted to use and generate copies of 3D CAD models for order fulfillment by additive manufacturing or a Co-Design system that uses and generates 3D CAD Models for order fulfillment by additive manufacturing.

In another embodiment the method and system is additionally configured to work in conjunction with additional subsystems and modular controllers by means of an API or other network communication method.

In another embodiment the method and system is additionally configured to enable the digital traveler geometry to take the form of at least one of; an appendage, a tab, a placard, a sprue, direct part marking and at least one of; human readable data, a corporate logo, emblem, 2-D barcodes, 3D Data matrices, 3D text or other geometry describable as 3D Geometry and formable by a 3D CAD kernel.

In another embodiment the method and system is additionally configured to allow conveyance of at least one of; order number, customer number, manufacturing date, manufacturing location, lot number, heat number, MTR number, Blockchain hash, facility number, origin code, routing code, serial number, or other required or desired information describable as 3D Geometry and formable by a 3D CAD Kernel.

In another embodiment the method and system is additionally configured to generate 3D geometry of a 2D hash related to a Blockchain sequence for part tracking and identification where the hash encodes product information or other data required or desired to be encoded.

In another embodiment the method and system is additionally configured to store nested tray files in a queue or buffer for transfer, upon request to an IP address, Mac Address, Web address or networked Additive Manufacturing device specified in the request.

In another embodiment the method and system is additionally configured to operate in conjunction with an PDM/PLM—Product Data Management/Product Lifecycle Management system where PDM/PLM systems used by commercial enterprises store revision controlled 3D CAD Model data and meta-data for each 3D CAD Model including Bills of Materials.

In another embodiment the method and system is additionally configured to operate in conjunction with a part marking and identification system to dynamically generate a digital traveler feature programmatically by defining the information to be generated and without first defining the feature location related to the base 3D CAD Model.

In another embodiment, the method and system are configured to optimize production resource utilization in a manner particularly useful for Additive Manufacturing and commercial use thereof comprising; a production system controller comprised of software programming code arranged and configured to control general computing hardware and having at least one non-transitory computer-readable memory associated with the general computing hardware to; receive, in an order aggregation device, associated with the Additive Manufacturing production system controller, an aggregation comprising a plurality of 3D CAD Model files and corresponding production criteria; analyze, by the production system controller, each discrete 3D CAD Model file and respective meta-data representing production criteria for each 3D CAD Model file; determine, by the production system controller at least one solution for sorting the plurality of 3D CAD Model files in the order aggregation device into groups of 3D CAD Model files based on at least one production criteria for each respective 3D CAD Model; cause, by the production system controller, an Additive Manufacturing packing system controller to arrange batches of 3D CAD Model files from groups of 3D CAD Model files into tray files comprising nested or packed batches of 3D CAD Models optimized for production utilizing additive manufacturing hardware and production criteria for the tray file utilization of a production resource wherein; The packing plan solutions are applied to the geometry of the CAD models within the 3D CAD Model files; determine, by the production system controller, at least one respective solution for organizing each tray file based on at least one production criteria for each tray file and system indexed production capacity resources; schedule, by the production system controller, each tray file into the queue of available indexed production resources according to the at least one solution determined by the system based on at least one of; capacity constraints, delivery time or commercial user parameters and specifications; transfer or otherwise make available, by the production scheduling controller, the tray files for instructing, at least in part, an additive manufacturing production resource device to produce the geometry of the 3D CAD Model files within the tray file to do so; route, by the Additive Manufacturing production scheduling system controller, each tray file to an Additive Manufacturing device based on the production scheduling plan and AM printer device assignments; and cause, by the production scheduling system controller, an Additive Manufacturing device to fabricate, each batch of geometry described within each tray file, at least in part, utilizing the instruction provided within the tray file to do so.

In one embodiment, method additionally configured to enable access by a commercial user to utilize the system over a website or web interface or manufacturers interface.

The method of claim 1 additionally configured to enable a commercial user to input parameters and values defining operating conditions for the planning and scheduling operations of the system.

In another embodiment, the method and system is additionally arranged to cause to be displayed on a commercial user device, at least one interface for visualizing the production schedule of Additive Manufacturing Devices indexed in the system and representing production resources to the system wherein; the production schedule shows tray files which represent nested or packed arrangements of 3D CAD Model geometry and wherein the Length of timeline in interface is based on estimated production time for the tray file on the selected AM production resource as demonstrated in FIG. 26.

In another embodiment, the method and system is additionally configured for enabling a commercial user, using a user device, to alter the production schedule, displayed within the user interface by re-organizing or re-assigning tray files to different Additive Manufacturing production resources indexed within the system and wherein the re-allocation of resources causes the tray file to be assigned to the production queue of the selected device.

In another embodiment, the method and system is additionally configured to enable the commercial user to display the packed arrangement of 3D CAD models in each tray file on the commercial user device and to dynamically reallocate individual 3D CAD Models to different subset groups based on updated production criteria, demand criteria or capacity constraint changes.

In another embodiment, the method and system is additionally configured to perform the system functionality in conjunction with other modular controllers including at least one of; a 3D Web viewer system controller, an additive Manufacturing Workflow Management system controller, a nesting and stacking (packing) system controller, a part tracking and identification system controller (digital traveler), a 3D Kernel controller, a co-design system controller, a website and or ecommerce system controller, a material matching system controller, a remote manufacturing controller, a quality rating system controller, a constraint configurator controller and a scripting/API modular controller.

In another embodiment, the method and system is additionally configured to optimize production scheduling according to production requirements including at least one of; lead time, capacity constraints, delivery location, material requirements, Additive Manufacturing Machine production speed, Additive Manufacturing Device process type, forecast, current production volume, production forecasts, raw material availability, quantity of identical or similar indexed Additive Manufacturing devices available, capacity constraints, commercial user input variables/parameters, promised delivery dates (expedited orders), priority scheduling and first-come-first served scheduling.

In another embodiment, the method and system is additionally configured for optimizing Additive Manufacturing production resource utilization and enabling commercial opportunities thereof comprising; an Additive Manufacturing packing system comprised of software programming code arranged and configured to control general computing hardware and having at least one non-transitory computer-readable memory associated with the general computing hardware to dynamically: receive, by the packing system, a request to generate at least one tray file and data describing a batch of 3D CAD Model files, containing 3D Geometry, to be packed within the tray file; determine, by the Additive Manufacturing packing system, a packing plan solution for each 3D CAD Model file geometry received in the batch of 3D CAD Model files that optimizes utilization of a production resource according to the production criteria and bounding box or printable area of the production resource; re-orient, by the Additive Manufacturing packing system, each 3D CAD Model in the batch to form an optimized arrangement of the geometry described in each of the 3D CAD Model files based on the packing plan solution; compile, by the Additive Manufacturing packing system, the optimized arrangement into at least one tray file containing the data describing the geometry of the batch of 3D CAD Models received; and transfer or otherwise make available, by the nesting and stacking system, each compiled tray file for instructing, at least in part, an additive manufacturing production resource device to produce the geometry of the 3D CAD Model files within the tray file to do so; and wherein the packing system is comprised of a nesting system controller, a packing system controller and at least one 3D CAD Kernel and; wherein the production criteria is at least one of; the printable area, the bounding box, and the production material specified for each; nesting area or bounding box of an AM printer device based on capacity constraints, delivery time or commercial user parameters and specifications; and wherein the orientation of each 3D CAD Model is altered by the at least one 3D Kernel or more 3D CAD Kernels associated with the system and an analysis of the geometry of the 3D CAD Model by the 3D CAD Kernel; and wherein the packing solution ensures that the available print area or production volume is efficiently and completely utilized; and wherein the compiled tray files are written to a database or file system for tray file storage in the production queue.

In one embodiment, the method and system are additionally configured wherein; tray files generated by the system are assigned to production queues for an indexed production resource based on at least one production criteria including; printing materials, geospatial location, and quality; and wherein production criteria are comprised of at least one of; a 3D Printer printing material specified for each 3D CAD Model in the production criteria meta-data; and the analysis of the 3D CAD Models is performed by one or more 3D Kernels or engines and the metadata of each respective 3D CAD Model; and the plurality of 3D CAD Models for products in the group of orders into an aggregated tray file associated with the type of the 3D printer printing material; and the method is additionally configured to dynamically reallocate individual 3D CAD Models to different subset groups based on updated production criteria, demand criteria or capacity constraint changes; and wherein at least one of the aggregated 3D CAD model files processed by the system is represented by a respective 3D CAD Model corresponding to an order for a product; and configured to additionally utilize an API for performance of production system operations.

One of the key tenants of creating a workflow management system for AM such as the Digital MES described herein is that the system must treat the 3D CAD Models as the object being processed by the system. The data within the CAD Model files is used by Additive Manufacturing “printers” as an input for instructing the Additive Manufacturing device to generate the geometry described within the 3D CAD Model computer file. Since each competing AM technology has its own file processing software, which are often incompatible, a commercial organization requires a 3rd party agnostic solution for the management of industrial-scale or “enterprise-scale” additive manufacturing workflow management and as such, a computerized software system that adapts traditional manufacturing workflow management processing activities to be applied to 3D CAD model files using computerized processing steps provides substantial utility to the commercial user engaged in Additive Manufacturing.

In one embodiment, the AM workflow management solution must provide automated or semi-automated workflow management processing methods that include analyzing 3D CAD Model geometry and production criteria and as a result of the processing and analysis, dynamically causing the data contained in a plurality of discrete 3D CAD model files to be aggregated, analyzed, sorted, arranged, batched and nested into “tray” files for production scheduling. The invention, the methods used and resulting workflow applies the processing activities directly to the 3D CAD models and the geometry described within the 3D CAD Model files, treating each 3D CAD model file as the objection processed by the system and enables a commercial user to deploy a commercial Enterprise Additive Manufacturing operation in order to receive, process, and transform 3D CAD Models, in a high-mix/high volume production operation, into parts and products produced, at least in part by additive manufacturing. The invention automates and virtualizes most, if not all the back-end processing necessary for large-scale or “Enterprise” Additive Manufacturing workflow management.

In one embodiment, the AM workflow management method enables commercial opportunities for Additive Manufacturing workflow management and commercial use thereof comprising; a Digital MES Additive Manufacturing production management platform comprised of software programming code as demonstrated in FIG. 9 is arranged and configured to control general computing hardware as demonstrated in FIG. 11 and having at least one non-transitory computer-readable memory associated with the general computing hardware to; receive, aggregate, analyze, organize, sort, batch, re-orient, arrange and schedule, by the at least one computing device, a plurality of 3D CAD Model files and their respective geometry treating each 3D CAD Model file and 3D CAD Model geometry described in each 3D CAD Model file as the object being processed and routed by the workflow performed by the system at least one the plurality of 3D CAD Model files having meta data describing respective production criteria for the 3D CAD Model; transfer, route, stream or otherwise make available, by the at least one computing device, each compiled tray file for instructing, at least in part, an additive manufacturing production resource device to produce the geometry of the 3D CAD Model files described in each tray file to do so; instruct, at least in part, by the at least one computing device, indexed production resources to produce the 3D CAD Models in each aggregated tray files.

In one embodiment, the AM workflow management method is comprised of software controller modules each comprised of software programming code arranged and configured to control general computing hardware and having at least one non-transitory computer-readable memory associated with the general computing hardware to; determine, by the at least one computing device, a sorting plan for received and aggregated 3D CAD Model files based on at least one production criteria for each respective 3D CAD Model file; sort, by the at least one computing device, the plurality of 3D CAD Model files into subset groups of 3D CAD Model files based on at least one production criteria for each respective 3D CAD Model file; analyze, by the at least one computing device, the 3D CAD Model geometry in each 3D CAD Model file to determine at least one production resource meeting the production criteria of the 3D CAD Model geometry within the 3D CAD Model file; determine, by the at least one computing device, a packing capacity plan solution for batches of 3D CAD Model file geometry described in the 3D CAD Model files in each batch that optimizes utilization of a selected production resource according to the production criteria and bounding box or printable area of the production resource; re-orient, by the at least one computing device, the 3D CAD Model geometry in each 3D CAD Model file in each batch of 3D CAD Model files in order to create an arrangement of the geometry that optimizes utilization of a production resource based on the packing plan solution; compile, by the Additive Manufacturing packing system, the optimized arrangement of the batch of 3D CAD Model geometry into at least one tray file containing the data describing the geometry of the batch of 3D CAD Model files in the batch; and schedule, by the at least one computing device, each compiled tray file, to the production queue of at least one indexed production resource meeting the production criteria of each tray file.

In one embodiment, the AM workflow management method is arranged to enable the commercial user to define at least one of: 3D Printer Device profiles for a plurality of 3D Printer devices and parameters, values and specifications defining workflow criteria and wherein the 3D Printer device profiles include at least one of: printing materials, a bounding box or printable area, the build speed, device resolution for each defined 3D Printer device; and a production planning and scheduling interface displaying the production queue of each 3D Printer Device indexed within and used by the system for production.

In one embodiment, the AM workflow management method is additionally comprised of software programming modules comprised of software programming code arranged and configured to enable the system to operate in conjunction with an API or application Programming Interface.

In one embodiment, the AM workflow management solution is embodied in a platform system enabling commercial opportunities for Additive Manufacturing workflow management and commercial use thereof comprising; a Digital MES Additive Manufacturing production management platform comprised of software programming code arranged and configured to control general computing hardware and having at least one non-transitory computer-readable memory associated with the general computing hardware to; receive, aggregate, analyze, organize, sort, batch, re-orient, arrange and schedule, by the at least one computing device, a plurality of 3D CAD Model files and their respective geometry treating each 3D CAD Model file and 3D CAD Model geometry described in each 3D CAD Model file as the object being processed and routed by the workflow performed by the system at least one the plurality of 3D CAD Model files having meta data describing respective production criteria for the 3D CAD Model; transfer, route, stream or otherwise make available, by the at least one computing device, each compiled tray file for instructing, at least in part, an additive manufacturing production resource device to produce the geometry of the 3D CAD Model files described in each tray file to do so; instruct, by the at least one computing device, at least in part, indexed production resources to produce the 3D CAD Models in the aggregated tray files;

In one embodiment, the AM workflow management platform system is comprised of software controller modules each comprised of software programming code arranged and configured to control general computing hardware and having at least one non-transitory computer-readable memory associated with the general computing hardware to; determine, by the at least one computing device, a sorting plan for received and aggregated 3D CAD Model files based on at least one production criteria for each respective 3D CAD Model file; sort, by the at least one computing device, the plurality of 3D CAD Model files into subset groups of 3D CAD Model files based on at least one production criteria for each respective 3D CAD Model file; analyze, by the at least one computing device, the 3D CAD Model geometry in each 3D CAD Model file to determine at least one production resource meeting the production criteria of the 3D CAD Model geometry within the 3D CAD Model file; determine, by the at least one computing device, a packing capacity plan solution for batches of 3D CAD Model file geometry described in the 3D CAD Model files in each batch that optimizes utilization of a selected production resource according to the production criteria and bounding box or printable area of the production resource; re-orient, by the at least one computing device, the 3D CAD Model geometry in each 3D CAD Model file in each batch of 3D CAD Model files in order to create an arrangement of the geometry that optimizes utilization of a production resource based on the packing plan solution; compile, by the Additive Manufacturing packing system, the optimized arrangement of the batch of 3D CAD Model geometry into at least one tray file containing the data describing the geometry of the batch of 3D CAD Model files in the batch; and schedule, by the at least one computing device, each compiled tray file, to the production queue of at least one indexed production resource meeting the production criteria of each tray file.

In one embodiment, the AM workflow management platform system is additionally arranged for enabling the commercial user to define at least one of: 3D Printer Device profiles for a plurality of 3D Printer devices and parameters, values and specifications defining workflow criteria and wherein the 3D Printer device profiles include at least one of: printing materials, a bounding box or printable area, the build speed, device resolution for each defined 3D Printer device; and a production planning and scheduling interface displaying the production queue of each 3D Printer Device indexed within and used by the system for production.

In one embodiment, the AM workflow management platform system is additionally comprised of software programming modules comprised of software programming code arranged and configured to enable the system to operate in conjunction with an API or application Programming Interface.

In one embodiment, the AM workflow management platform system is arranged for enabling commercial opportunities for optimizing production resource utilization in a manner particularly useful for Additive Manufacturing and commercial use thereof comprising; a production scheduling system controller comprised of software programming code arranged and configured to control general computing hardware and having at least one non-transitory computer-readable memory associated with the general computing hardware to; receive, in an order aggregation device, associated with the Additive Manufacturing production scheduling controller, data describing an aggregation of a plurality of 3D CAD Model files and corresponding production criteria for at least one or each respective 3D CAD Model file received by the system; determine, by the production scheduling system controller at least solution for optimizing production resource utilization based on analyzing at least one of; production criteria for each 3D CAD Model file, 3D CAD Model geometry data in each 3D CAD Model file, capacity constraints, geospatial location, delivery time, and commercial user parameters and specifications; cause, by the production system scheduling controller, an Additive Manufacturing nesting system controller and stacking system controller, performing a packing function for 3D CAD Model geometry, in order to arrange and compile batches of the geometry described in the 3D CAD Model files into tray files based on the at least one solution for optimizing production resource utilization; schedule, by the production scheduling system controller, each system generated tray file into the production queue of available indexed production resources based on the at least one solution; transfer, route, stream or otherwise make available, by the production scheduling controller, the tray files for instructing, at least in part, an additive manufacturing device to produce the geometry of the 3D CAD Models described within the tray file to do so; and cause, at least in part, by the production scheduling system controller, an Additive Manufacturing device to fabricate the geometry described within each tray file, utilizing the instruction provided within each tray file to do so.

In one embodiment, the AM workflow management platform system is additionally comprised of software programming modules comprised of software programming code arranged and configured to enable the system to operate in conjunction with an API or application Programming Interface.

A system enabling commercial opportunities for optimizing production resource utilization in a manner particularly useful for Additive Manufacturing and commercial use thereof comprising; a production scheduling system controller comprised of software programming code arranged and configured to control general computing hardware and having at least one non-transitory computer-readable memory associated with the general computing hardware to; receive, in an order aggregation device, associated with the Additive Manufacturing production scheduling controller, data describing an aggregation of a plurality of 3D CAD Model files and corresponding production criteria for at least one or each respective 3D CAD Model file received by the system; analyze and determine, by the production scheduling system controller at least solution for optimizing production resource utilization based on at least one of; production criteria for each 3D CAD Model file, 3D CAD Model geometry data in each 3D CAD Model file, capacity constraints, geospatial location, delivery time, and commercial user parameters and specifications; cause, by the production system scheduling controller, an Additive Manufacturing nesting system controller and stacking system controller, performing a packing function for 3D CAD Model geometry, in order to arrange and compile batches of the geometry described in the 3D CAD Model files into tray files based on the at least one solution for optimizing production resource utilization; schedule, by the production scheduling system controller, each system generated tray file into the production queue of available indexed production resources based on the at least one solution; transfer, route, stream or otherwise make available, by the production scheduling controller, the tray files for instructing, at least in part, an additive manufacturing device to produce the geometry of the 3D CAD Models described within the tray file to do so; and cause, at least in part, by the production scheduling system controller, an Additive Manufacturing device to fabricate the geometry described within each tray file, utilizing the instruction provided within each tray file to do so.

In one embodiment, the AM workflow management platform system is additionally comprised of software programming modules comprised of software programming code arranged and configured to enable the system to operate in conjunction with an API or application Programming Interface [182].

In the foregoing specification, and exemplary embodiments of the invention, e.g. a Digital MES Additive Manufacturing Workflow Management System have been described as having an implementation providing utility for commercial Additive Manufacturing. Each portion of the invention comprising modular controllers arranged to control general computing hardware in the performance of the various embodiments described herein including by means of a distributed computing system where each subsystem and or controller may be operated independently of one another or in conjunction with one another in performance of the methods described herein. Furthermore, the preceding specification have described with reference to specific embodiments thereof. However, various modifications and changes may be made thereto without departing from the broader spirit and scope of the invention. The specifications and drawings are, accordingly, to be regarded in an illustrative sense rather than a restrictive sense.

1. A method enabling commercial opportunities for Additive Manufacturing workflow management and commercial use thereof;
a. a Digital MES Additive Manufacturing production management platform comprised of software programming code arranged and configured to control general computing hardware and having at least one non-transitory computer-readable memory associated with the general computing hardware to;
b. receive, aggregate, analyze, organize, sort, batch, re-orient, arrange and schedule, by the at least one computing device, a plurality of 3D CAD Model files and their respective geometry treating each 3D CAD Model file and 3D CAD Model geometry described in each 3D CAD Model file as the object being processed and routed by the workflow performed by the system at least one the plurality of 3D CAD Model files having meta data describing respective production criteria for the 3D CAD Model;
c. transfer, route, stream or otherwise make available, by the at least one computing device, each compiled tray file for instructing, at least in part, an additive manufacturing production resource device to produce the geometry of the 3D CAD Model files described in each tray file to do so;
d. cause, at least in part, indexed production resources to produce the 3D CAD Model geometry in each aggregated tray files.

2. The method of claim 1 comprised of software controller modules each comprised of software programming code arranged and configured to control general computing hardware and having at least one non-transitory computer-readable memory associated with the general computing hardware to;
a. determine, by the at least one computing device, a sorting plan for received and aggregated 3D CAD Model files based on at least one production criteria for each respective 3D CAD Model file;
b. sort, by the at least one computing device, the plurality of 3D CAD Model files into subset groups of 3D CAD Model files based on at least one production criteria for each respective 3D CAD Model file;
c. analyze, by the at least one computing device, the 3D CAD Model geometry in each 3D CAD Model file to determine at least one production resource meeting the production criteria of the 3D CAD Model geometry within the 3D CAD Model file;
d. determine, by the at least one computing device, a packing capacity plan solution for batches of 3D CAD Model file geometry described in the 3D CAD Model files in each batch that optimizes utilization of a selected production resource according to the production criteria and bounding box or printable area of the production resource;
e. re-orient, by the at least one computing device, the 3D CAD Model geometry in each 3D CAD Model file in each batch of 3D CAD Model files in order to create an arrangement of the geometry that optimizes utilization of a production resource based on the packing plan solution;
f. compile, by the Additive Manufacturing packing system, the optimized arrangement of the batch of 3D CAD Model geometry into at least one tray file containing the data describing the geometry of the batch of 3D CAD Model files in the batch; and
g. schedule, by the at least one computing device, each compiled tray file, to the production queue of at least one indexed production resource meeting the production criteria of each tray file.

3. The method of claim 1 enabling the commercial user to define at least one of: 3D Printer Device profiles for a plurality of 3D Printer devices and parameters, values and specifications defining workflow criteria and wherein the 3D Printer device profiles include at least one of: printing materials, a bounding box or printable area, the build speed, device resolution for each defined 3D Printer device; and
a. a production planning and scheduling interface displaying the production queue of each 3D Printer Device indexed within and used by the system for production.

4. The method of claim 1 additionally comprised of software programming modules comprised of software programming code arranged and configured to enable the system to operate in conjunction with an API or application Programming Interface.

5. The method of claim 1 additionally comprised of software programming modules comprised of software programming code arranged and configured to integrate with a PDM/PLM system in order to receive copies of 3D CAD Model files from the PDM/PLM system into an order aggregation device associated with the system and associated production criteria for each 3D CAD Model file.

6. The method of claim 1 additionally arranged to utilize a digital traveler modular controller for part marking and identification.

7. A system enabling commercial opportunities for Additive Manufacturing workflow management and commercial use thereof;
a. a Digital MES Additive Manufacturing production management platform comprised of software programming code arranged and configured to control general computing hardware and having at least one non-transitory computer-readable memory associated with the general computing hardware to;
b. receive, aggregate, analyze, organize, sort, batch, re-orient, arrange and schedule, by the at least one computing device, a plurality of 3D CAD Model files and their respective geometry treating each 3D CAD Model file and 3D CAD Model geometry described in each 3D CAD Model file as the object being processed and routed by the workflow performed by the system at least one the plurality of 3D CAD Model files having meta data describing respective production criteria for the 3D CAD Model;
c. transfer, route, stream or otherwise make available, by the at least one computing device, each compiled tray file for instructing, at least in part, an additive manufacturing production resource device to produce the geometry of the 3D CAD Model files described in each tray file to do so;
d. cause, at least in part, indexed production resources to produce the 3D CAD Model geometry in each aggregated tray files.

8. The system of claim 5 comprised of software controller modules each comprised of software programming code arranged and configured to control general computing hardware and having at least one non-transitory computer-readable memory associated with the general computing hardware to;
a. determine, by the at least one computing device, a sorting plan for received and aggregated 3D CAD Model files based on at least one production criteria for each respective 3D CAD Model file;
b. sort, by the at least one computing device, the plurality of 3D CAD Model files into subset groups of 3D CAD Model files based on at least one production criteria for each respective 3D CAD Model file;
c. analyze, by the at least one computing device, the 3D CAD Model geometry in each 3D CAD Model file to determine at least one production resource meeting the production criteria of the 3D CAD Model geometry within the 3D CAD Model file;
d. determine, by the at least one computing device, a packing capacity plan solution for batches of 3D CAD Model file geometry described in the 3D CAD Model files in each batch that optimizes utilization of a selected production resource according to the production criteria and bounding box or printable area of the production resource;
e. re-orient, by the at least one computing device, the 3D CAD Model geometry in each 3D CAD Model file in each batch of 3D CAD Model files in order to create an arrangement of the geometry that optimizes utilization of a production resource based on the packing plan solution;
f. compile, by the Additive Manufacturing packing system, the optimized arrangement of the batch of 3D CAD Model geometry into at least one tray file containing the data describing the geometry of the batch of 3D CAD Model files in the batch; and
g. schedule, by the at least one computing device, each compiled tray file, to the production queue of at least one indexed production resource meeting the production criteria of each tray file.

9. The system of claim 5 enabling the commercial user to define at least one of: 3D Printer Device profiles for a plurality of 3D Printer devices and parameters, values and specifications defining workflow criteria and wherein the 3D Printer device profiles include at least one of: printing materials, a bounding box or printable area, the build speed, device resolution for each defined 3D Printer device; and
a. a production planning and scheduling interface displaying the production queue of each 3D Printer Device indexed within and used by the system for production.

10. The system of claim 5 additionally comprised of software programming modules comprised of software programming code arranged and configured to enable the system to operate in conjunction with an API or application Programming Interface

11. The system of claim 5 additionally comprised of software programming modules comprised of software programming code arranged and configured to integrate with a PDM/PLM system in order to receive copies of 3D CAD Model files from the PDM/PLM system into an order aggregation device associated with the system and associated production criteria for each 3D CAD Model file.

12. The system of claim 5 additionally arranged to utilize a digital traveler modular controller for part marking and identification.

13. A method enabling commercial opportunities for optimizing production resource utilization in a manner particularly useful for Additive Manufacturing and commercial use thereof comprising;
a. a production scheduling system controller comprised of software programming code arranged and configured to control general computing hardware and having at least one non-transitory computer-readable memory associated with the general computing hardware to;
b. receive, in an order aggregation device, associated with the Additive Manufacturing production scheduling controller, data describing an aggregation of a plurality of 3D CAD Model files and corresponding production criteria for at least one or each respective 3D CAD Model file received by the system;
c. determine, by the production scheduling system controller at least solution for optimizing production resource utilization based on analyzing at least one of; production criteria for each 3D CAD Model file, 3D CAD Model geometry data in each 3D CAD Model file, capacity constraints, geospatial location, delivery time, and commercial user parameters and specifications;
d. cause, by the production system scheduling controller, an Additive Manufacturing nesting system controller and stacking system controller, performing a packing function for 3D CAD Model geometry, in order to arrange and compile batches of the geometry described in the 3D CAD Model files into tray files based on the at least one solution for optimizing production resource utilization;
e. schedule, by the production scheduling system controller, each system generated tray file into the production queue of available indexed production resources based on the at least one solution;
transfer, route, stream or otherwise make available, by the production scheduling controller, the tray files for instructing, at least in part, an additive manufacturing device to produce the geometry of the 3D CAD Models described within the tray file to do so; and
f. cause, at least in part, indexed production resources to produce the 3D CAD Model geometry in each aggregated tray files.

14. The method of claim 11 additionally comprised of software programming modules comprised of software programming code arranged and configured to enable the system to operate in conjunction with an API or application Programming Interface.

15. The method of claim 11 additionally comprised of software programming modules comprised of software programming code arranged and configured to integrate with a PDM/PLM system in order to receive copies of 3D CAD Model files from the PDM/PLM system into an order aggregation device associated with the system and associated production criteria for each 3D CAD Model file.

16. The method of claim 11 additionally arranged to utilize a digital traveler modular controller for part marking and identification.

17. A system enabling commercial opportunities for optimizing production resource utilization in a manner particularly useful for Additive Manufacturing and commercial use thereof comprising;
a. a production scheduling system controller comprised of software programming code arranged and configured to control general computing hardware and having at least one non-transitory computer-readable memory associated with the general computing hardware to;
b. receive, in an order aggregation device, associated with the Additive Manufacturing production scheduling controller, data describing an aggregation of a plurality of 3D CAD Model files and corresponding production criteria for at least one or each respective 3D CAD Model file received by the system;
c. analyze and determine, by the production scheduling system controller at least solution for optimizing production resource utilization based on at least one of; production criteria for each 3D CAD Model file, 3D CAD Model geometry data in each 3D CAD Model file, capacity constraints, geospatial location, delivery time, and commercial user parameters and specifications;
d. cause, by the production system scheduling controller, an Additive Manufacturing nesting system controller and stacking system controller, performing a packing function for 3D CAD Model geometry, in order to arrange and compile batches of the geometry described in the 3D CAD Model files into tray files based on the at least one solution for optimizing production resource utilization;
e. schedule, by the production scheduling system controller, each system generated tray file into the production queue of available indexed production resources based on the at least one solution;
f. transfer, route, stream or otherwise make available, by the production scheduling controller, the tray files for instructing, at least in part, an additive manufacturing device to produce the geometry of the 3D CAD Models described within the tray file to do so; and
g. cause, at least in part, indexed production resources to produce the 3D CAD Model geometry in each aggregated tray files.

18. The system of claim 14 additionally comprised of software programming modules comprised of software programming code arranged and configured to enable the system to operate in conjunction with an API or application Programming Interface.

19. The system of claim 14 additionally comprised of software programming modules comprised of software programming code arranged and configured to integrate with a PDM/PLM system in order to receive copies of 3D CAD Model files from the PDM/PLM system into an order aggregation device associated with the system and associated production criteria for each 3D CAD Model file.

20. The system of claim 14 additionally arranged to utilize a digital traveler modular controller for part marking and identification.
